(19) United States
(12) Patent Application Publication
(10) Pub. No.: US 2026/0268423 A1
(43) Pub. Date: Sep. 10, 2026

(54) INTENDED OCCUPANCY LOCATION STATUS NOTIFICATION, MANAGEMENT, DEVICES, SYSTEMS, AND METHODS

(71) Applicant: John Richard Taylor, Irving, TX (US)

(72) Inventor: John Richard Taylor, Irving, TX (US)

(21) Appl. No.: 19/557,097

(22) Filed: Mar. 4, 2026

Related U.S. Application Data
(60) Provisional application No. 63/767,449, filed on Mar. 5, 2025.
(60) Provisional application No. 63/784,788, filed on Apr. 7, 2025.

(51) Int. Cl. G06Q 50/12; G06Q 20/20

(52) U.S. Cl. CPC G06Q 50/12; G06Q 20/209

(57) ABSTRACT

Electronic devices, systems, and methods for indicating statuses of intended occupancy locations (e.g., seats) within accommodation premises (e.g., restaurants) are described. Associated with a seat may be: an occupancy-status-indicator (e.g., a different colored light for different statuses); a person-presence detection means (e.g., via a sensor and/or a tag); and/or a means for verifying payment for use of the seat (e.g., a code or a digital authorization). Payment for food, beverage, and/or seat usage may be done at a point-of-purchase device of the accommodation premises. Payment may trigger generation of the code or the digital authorization. The occupancy-status-indicator may be publicly viewable and/or may be displayable upon screen(s) of computing devices. Occupancy statuses for a given seat may be: vacant and ready for occupancy; currently properly occupied; currently properly occupied but expiring soon; currently improperly occupied; or seating in need of cleaning or maintenance.

### PRIORITY NOTICE

The present application claims priority under 35 U.S.C. § 119(e) to U.S. Provisional Patent Application Ser. No. 63/767,449 filed on Mar. 5, 2025, the disclosure of which is incorporated herein by reference in its entirety.

The present application claims priority under 35 U.S.C. § 119(e) to U.S. Provisional Patent Application Ser. No. 63/784,788 filed on Apr. 7, 2025, the disclosure of which is incorporated herein by reference in its entirety.

### TECHNICAL FIELD OF THE INVENTION

The present invention relates in general to accommodation premises (such as, but not limited to, restaurants and/or the like) and more specifically to electronic devices, computing devices, systems, and/or methods (processes) for indicating statuses of intended occupancy locations (such as, but not limited to, seats) within a given accommodation premises.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Modernly (circa 2026) a problem exists where people will sometimes occupy seating of a coffee shop to hangout, study, do work, have meetings, and/or the like, but the occupying people either do not purchase any food and/or beverage or do not purchase enough food and/or beverage to justify the amount of time they spend occupying their seating; i.e., the coffee shop may be losing revenue it has seats being occupied for too long without receiving sufficient compensation.

In an accommodation (such as, but not limited to, a restaurant or coffee shop or the like) that provides (sells) food and/or beverages to (optionally) be eaten and/or drunk on the premises of the given accommodation, there is a need to keep people from sitting, seating, standing, and/or staying at “intended occupancy locations” of the given accommodation premises, without timely paying for sufficient food, beverage, and/or for seating occupancy time—which may include people who have not ordered any food and/or beverage at all or may include people who have ordered food and/or beverage but have overstayed past some predetermined amount of time, taking up valuable intended occupancy locations (e.g., seating) of that given accommodation without providing sufficient compensation to that given accommodation.

This problem is often magnified when the given accommodation, like Starbucks and/or other coffee shops, offers free internet to the general public that may be on its premises. For example, it is common for people to come to a Starbucks, a Denny's, some other coffee shop, or some other restaurant, and to then use that accommodation's seating (and/or their internet) for studying, working, and/or meeting(s)—but without buying sufficient food and/or drink or buying some food and/or drink but staying too long or not buying any food and/or drink.

Note, “accommodation” (or an “accommodation premises”) is a general term used herein that may refer to any of the following: a restaurant, a cafe, a coffee shop, a tea house, a tea shop, a cafeteria, a bistro, an eatery, a bar, a pub, a tavern, a grill, a diner, a mess hall, a dining hall, a brewery, a concession stand, a full service restaurant, a fine dining restaurant, a self-seating restaurant, a self-serve restaurant, a library, a bookstore, combinations thereof, and/or the like, and including those with self-seating and/or with curated seating (e.g., seating controlled by a hostess and/or by staff).

Note, “intended occupancy locations” of a given accommodation premises is a general term used herein that may refer to any location of that specific accommodation premises that is intended for customers (patrons) to occupy and consume their purchased food and/or their purchased beverage(s), generally by sitting or standing in specific (designated) locations of that premises, such as, but not limited to, at: tables, booths, seats, chairs, stools, benches, bars, and/or the like of that specific premises.

There is a need in the art for electronic devices, computing devices, systems, and/or methods (processes) for indicating statuses of intended occupancy locations (such as, but not limited to, seats) within accommodation premises (such as, but not limited to, restaurants and/or the like). There is a need in the art to provide a means for a given accommodation premises to receive payment for mere usage of their seat(s) and without requiring the customer to purchase food, beverage, and/or some other product. There is a need in the art to provide a means for an interested party to see (and/or to hear) (in real-time or near real-time) a current status for an intended occupancy location (e.g., a seat) of a given accommodation premises, wherein the interested party may be selected from: the public, a customer of the accommodation premises, a patron of the accommodation premises, staff of the accommodation premises, a manager of the accommodation premises, an owner of the accommodation premises, an operator of a back-end computer-server, and/or the like.

It is to these ends that the present invention has been developed.

### BRIEF SUMMARY OF THE INVENTION

To minimize the limitations in the prior art, and to minimize other limitations that will be apparent upon reading and understanding the present specification, various embodiments of the present invention may describe electronic devices, computing devices, systems, and/or methods (processes) for indicating statuses of intended occupancy locations (such as, but not limited to, seats) within accommodation premises (such as, but not limited to, restaurants and/or the like). In some embodiments, associated with a given seat (of a given accommodation premises) may be: an occupancy-status-indicator (e.g., a different colored light for different statuses); a person-presence detection means (e.g., via a sensor and/or a tag); and/or a means for verifying payment for use of the seat (e.g., a code or a digital authorization). In some embodiments, payment for food, beverage, and/or seat usage may be done at a point-of-purchase-device (POP-device) of the given accommodation premises. In some embodiments, payment for food and/or beverage at the given accommodation premises—without explicitly paying for seat usage-may automatically provide generation of the code and/or of the digital authorization for permitting the purchaser to use seat(s) the given accommodation premises. In some embodiments, payment for only seat(s) usage at the given accommodation premises-without purchasing any food and/or beverage-may automatically provide generation of the code and/or of the digital authorization for permitting the purchaser to use seat(s) the given accommodation premises. In some embodiments, payment may trigger generation of the code or the digital authorization. In some embodiments, the occupancy-status-indicator (e.g., of associated seat(s)) may be publicly viewable and/or may be displayable upon screen(s) of computing devices (such as, but not limited to, mobile-computing-device[s]). In some embodiments, viewing of the occupancy-status-indicator (e.g., of associated seat(s)) on screen(s) of computing devices may be privately viewable and not publicly viewable if the screens are not publicly viewable. In some embodiments, (occupancy) statuses for a given seat (of a given accommodation premises) may be: vacant and ready for occupancy; currently properly occupied (e.g., currently paid for); currently properly occupied but expiring soon (timer almost complete); currently improperly occupied (e.g., occupied but not properly paid for); or seating in need of cleaning or maintenance.

It is an objective of the present invention to provide a means for a given accommodation premises to receive payment for mere usage of their seat(s) and without requiring the customer to purchase food, beverage, and/or some other product.

It is another objective of the present invention to provide electronic devices, computing devices, systems, and/or methods (processes) for indicating statuses of intended occupancy locations (such as, but not limited to, seats) within accommodation premises (such as, but not limited to, restaurants and/or the like).

It is another objective of the present invention to provide occupancy-status-indicator(s) for seat(s) or the like of a given accommodation premises, wherein a given occupancy-status-indicator may indicate a current status of a given seat of the given accommodation premises.

It is another objective of the present invention to provide occupancy-status-indicator(s) for seat(s) that may be configured to emit (shine) different colored lights to indicate a current different status of a given seat of the given accommodation premises.

It is another objective of the present invention to provide occupancy-status-indicator(s) for seat(s) that may be configured to be displayed upon a screen of an electronic device and/or of a computing device.

It is another objective of the present invention to provide a means for an interested party to see (and/or hear) (in real-time or near real-time) a current status for an intended occupancy location of a given premises, wherein the interested party may be selected from: the public, a customer of the accommodation premises, a patron of the accommodation premises, staff of the accommodation premises, a manager of the accommodation premises, an owner of the accommodation premises, an operator of a back-end computer-server, and/or the like.

It is another objective of the present invention to provide a person-presence detection means for seat(s) or the like of the given accommodation premises.

It is another objective of the present invention to provide a means for accepting, receiving, and/or verifying payment for food, beverage, product, and/or seat usage for a given accommodation premises.

It is another objective of the present invention to provide a means for generating and/or providing codes and/or digital authorizations, wherein the codes and/or the digital authorizations upon receipt and validation may authorize person(s) to use seat(s) of the given accommodation premises (for at least some finite amount of time).

It is another objective of the present invention that the provided electronic devices, computing devices, systems, and/or methods (processes) for indicating statuses of intended occupancy locations (such as, but not limited to, seats) within accommodation premises (such as, but not limited to, restaurants and/or the like) be relatively affordable to implement (deploy) and use by interested parties.

It is yet another objective of the present invention that the provided electronic devices, computing devices, systems, and/or methods (processes) for indicating statuses of intended occupancy locations (such as, but not limited to, seats) within accommodation premises (such as, but not limited to, restaurants and/or the like) be relatively easy to implement (deploy) and use by interested parties.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1A is a top-down (overhead) schematic block diagram view of a system for managing, notifying, providing, and/or indicating status of “intended occupancy locations” (such as, but not limited to, seating) of a given accommodation premises according to at least one embodiment.

FIG. 1B is a top-down (overhead) schematic block diagram view of at least a portion of a system for indicating occupancy status of locations within a given accommodation premises that may use a (visual) code.

FIG. 1C may be a detail (close-up) view of a portion of FIG. 1B, that focuses on a possible code reading (or the like) interaction between the code and an electronic-device (and/or reader/scanner).

FIG. 1D is a block diagram showing three possible functional elements (members and/or units) of a given electronic-device, namely, of a reader/scanner, of a status-indicator-device, and/or of a presence-detector-device; and FIG. 1D may show how these functional elements may be organized.

FIG. 1E is a block diagram showing at least some possible (intermittent) communications of at least some hardware, computing, and/or electronic elements of system for indicating occupancy status of locations within a given accommodation premises.

FIG. 2 is a top-down (overhead) schematic block diagram view of at least a portion of system for indicating occupancy status of locations within a given accommodation premises, wherein this system may use digital authorizations instead of visible codes.

FIG. 3 is a top-down (overhead) schematic block diagram view of at least a portion of system for indicating occupancy status of locations within a given accommodation premises, wherein this system may utilize NFC, RFID, UWB and/or the like tags.

FIG. 4A is a cross-sectional elevational view through a region of a given accommodation premises, wherein the cross-section runs through a tabletop of a given table of that given accommodation premises (and shows at least some possible locational relationships of electronic-device(s) with respect to that region and/or to that table).

FIG. 4B is a cross-sectional elevational view through a section of a given table (such as, but not limited to, a pedestal table) (of a given accommodation premises).

FIG. 4C is top-down perspective view of a given tabletop of a given table (with electronics and/or tags), wherein this given table may be located inside of a given accommodation premises.

FIG. 5 depicts a block diagram showing at least some electronics and/or electronic hardware elements (such as, but not limited to, processor(s), memory, storage, sensor(s), and/or the like) of a given computing-device (such as, but not limited, to an electronic-device associated with table(s) and/or seating).

FIG. 6A is a block diagram showing a same status-indicator-device (or a portion thereof) but shown at in at least five different moments in time and/or in at least five different statuses.

FIG. 6B is a block diagram showing at least some of a given status-indicator-device (or a portion thereof) that may comprise at least one status indicator.

FIG. 7 shows at least some steps of a method for indicating occupancy status of locations 111 within a given accommodation premises.

FIG. 8 shows at least some steps of a method for indicating occupancy status of locations 111 within a given accommodation premises.

FIG. 9 shows at least some steps of a method for indicating occupancy status of locations 111 within a given accommodation premises.

### REFERENCE NUMERAL SCHEDULE

100 system for managing, monitoring, notifying, and/or providing status of “intended occupancy locations” of accommodation premises 100
101 point-of-purchase-device (POP-device) 101
103 ticket/receipt 103
105 code 105
107 electronic-device 107
107a reader/scanner (code-reader[s]) 107a
107b occupancy-status-indicator-device(s) 107b
107c presence-detector-device(s) 107c
109 table 109
109a (first) table 109a
109b (second) table 109b
109c (third) table 109c
109d (fourth) table 109d
111 intended occupancy location (e.g., a chair, seat, stool, or designated standing area) 111
113 (premises/facility) boundary/perimeter 113
115 hub 115
117 person 117
119 scanning/reading code communication 119
121 presence-detected (presence-sensed) communication 121
123 tag 123
125 computer-server(s) 125
127 network/WAN/LAN/Internet 127
129 mobile-computing-device(s) 129
200 system for indicating occupancy status of locations of accommodation premises 200
201 wireless-communication(s) 201
300 system for indicating occupancy status of locations of accommodation premises 300
301 tag 301
303 wireless-communication(s) 303
401 wall 401
403 top/upper-surface 403
405 bottom/lower-surface 405
407 (vertical) post/pole 407
409 (horizontal/lateral) beam/ceiling 409
411 FOV (field-of-view) 411
413 leg/pedestal/base 413
415 outside/external edge/surface (perimeter surface) 415
500 computing-device 500
501 processor(s) 501
503 memory 503
505 storage 505
507 sensor(s) 507
509 I/O (input[s] and/or output[s]) 509
511 comms (communication-means) 511
513 status indicator(s) 513
515 power 515
517 housing/enclosure 517
519 bus/interconnection 519
601a first-color-light 601a
601b second-color-light 601b
601c third-color-light 601c
601d fourth-color-light 601d
601n nth-color-light 601n
700 method of managing, monitoring, notifying, and/or providing (occupancy) status information of table(s) and/or of seat(s) for a given accommodation premises 700
701 step of receiving payment 701
703 step of generating/providing code 703
705 step of receiving code 705
707 step of receiving presence (occupancy) data 707
709 step of checking code & checking presence (occupancy) data 709
711 outcome of step 709 when code correct and presence detected 711
713 step of indicating occupancy status paid & occupied 713
715 step of running a timer to track duration of time for paid occupancy 715
717 step of indicating vacant (& ready for occupancy) 717
719 step of indicating improper occupancy 719
721 step of issuing warning regarding improper occupancy 721
723 outcome of step 709 of correct code but no presence detected 723
725 step of issuing warning regarding correct code but no presence detected 725
727 step of indicating that the timer almost finished 727
729 outcome from step 709 of improper presence (no code, but presence detected) 729
800 method of managing, monitoring, notifying, and/or providing (occupancy) status information of table(s) and/or of seat(s) for a given accommodation premises 800
803 step of generating/providing digital authorization 803
805 step of receiving digital authorization 805
809 step of verifying digital authorization & verifying presence/occupancy 809
811 outcome from step 809 of digital authorization valid/verified & presence proper 811
823 outcome from step 809 if authorization correct but no presence detected 823
829 outcome from step 809, no authorization & presence detected 829
900 method of managing, monitoring, notifying, and/or providing (occupancy) status information of table(s) and/or of seat(s) for a given accommodation premises 900 step of interacting with tag 907

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

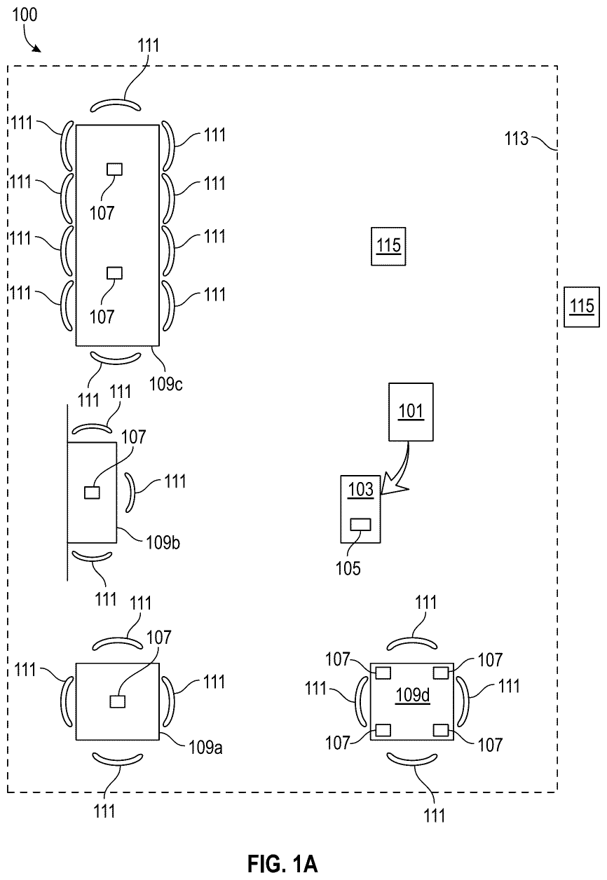

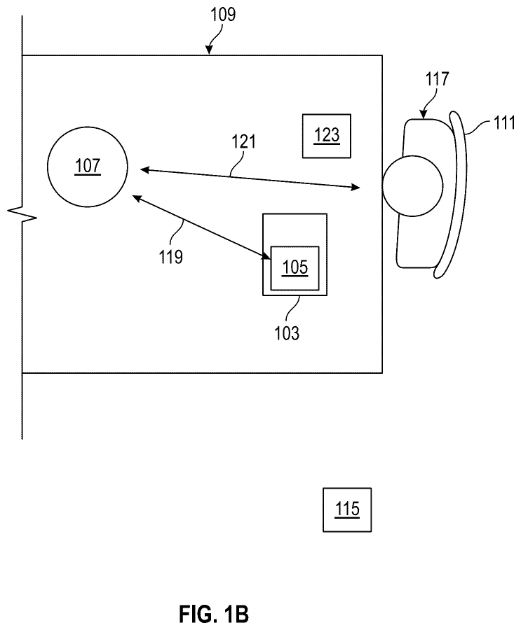

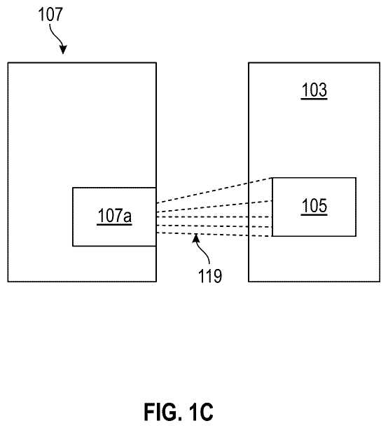

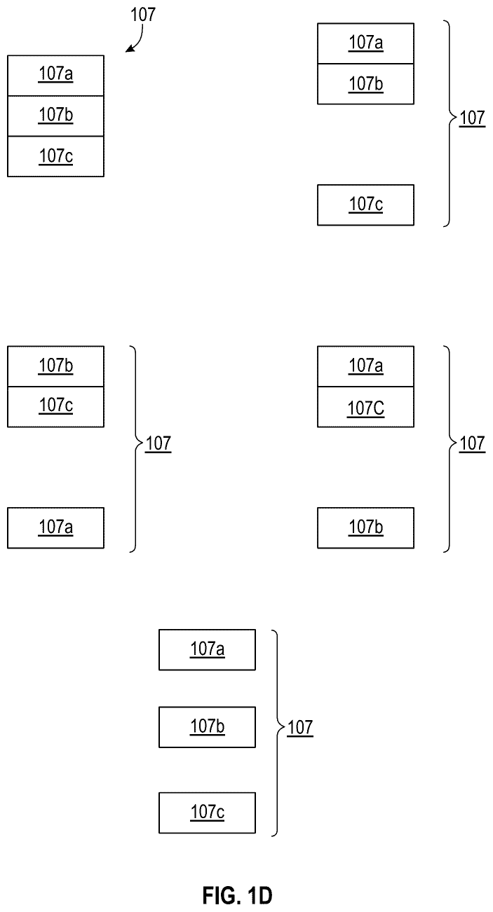

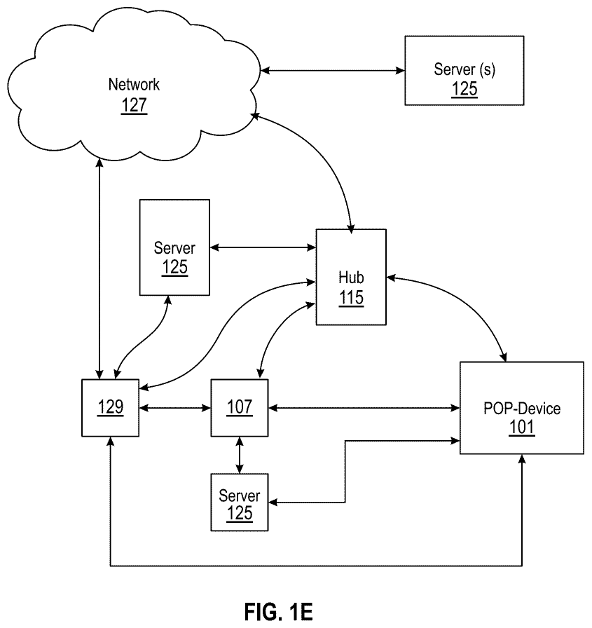

FIG. 1A is a top-down (overhead) schematic block diagram view of a system 100 for managing, notifying, and/or providing status of “intended occupancy locations” of a given accommodation premises according to at least one embodiment. FIG. 1A is a top-down (overhead) schematic block diagram view of at least a section (portion and/or region) of a given accommodation premises.

In some embodiments, the given “accommodation” (or an “accommodation premises”) may be selected from any one or more of the following: a restaurant, a cafe, a coffee shop, a tea house, a tea shop, a cafeteria, a bistro, an eatery, a bar, a pub, a tavern, a grill, a diner, a mess hall, a dining hall, a brewery, a concession stand, a full service restaurant, a fine dining restaurant, a self-seating restaurant, a self-serve restaurant, a library, a bookstore, combinations thereof, and/or the like, and including those with self-seating and/or with curated seating (e.g., seating controlled by a hostess and/or by staff).

In some embodiments, an “intended occupancy location 111” of a given accommodation premises may be selected from any location of a specific (given) accommodation premises that is intended for customers (patrons) to occupy and optionally where such customers (patrons) would consume their purchased food and/or their purchased beverage(s), generally by sitting or standing in specific locations of that premises, such as, but not limited to, at: tables, booths, seats, chairs, stools, couches, loveseats, benches, bars, and/or the like of that specific premises. For brevity, “seating 111” or “seat 111” may be used herein in some instances, instead of using the longer form of “intended occupancy location 111” to refer to intended occupancy location 111 and may include location(s) of the given accommodation premises that may be designated for customers (patrons) to stand and/or to sit. Use of “seating 111” or “seat 111” herein may be interpreted as “intended occupancy location 111” (e.g., of a given table 109 of a given accommodation premises).

FIG. 1A shows at least one point-of-purchase-device (POP-device) 101 that may be located inside of a boundary (perimeter) 113 of that given accommodation premises. In some embodiments, boundary 113 may be a physical (and/or legal) boundary and/or perimeter of a given (specific) accommodation premises. In some embodiments, boundary 113 may be comprised of at least one: wall, fence, and/or some other means (such as, but not limited to, cones, rope, tape, chalk, chain, planters, pavers, gate, door, and/or the like) for indicating a boundary (perimeter) of a given specific accommodation premises. In some embodiments, POP-device 101 may be selected from at one least one: cash register, device for accepting payment, a kiosk, combinations thereof, and/or the like. In some embodiments, POP-device 101 may be configured to accept and/or receive payment in a form of: a cash payment, a credit card payment, a debit card payment, an Apple Pay payment, a Google Wallet payment, a PayPal payment, a touch payment (e.g., using NFC or the like), a proximity payment (e.g., using UWB or the like), an EBT payment, a SNAP payment, combinations thereof, and/or the like. In some embodiments, POP-device 101 may be fixed (e.g., mounted) within boundary 113 or POP-device 101 may be mobile within boundary 113. In some embodiments, POP-device 101 may be part of a kiosk. In some embodiments, such a kiosk may be stationary and/or mobile. In some embodiments, POP-device 101 may be configured to be used directly by customer(s) (patron(s)) and/or by staff (employees) of the given accommodation. In some embodiments, POP-device 101 may be configured for accepting payments for food, beverages, and/or use of seating(s) 111 of that given accommodation premises.

FIG. 1A shows at least one ticket (receipt) 103 that may be issued by, generated by, and/or provided by a given POP-device 101 of that specific accommodation premises when a customer (patron) purchases food, beverage, and/or use of seating 111. In some embodiments, ticket 103 may be a receipt and/or a ticket. In some embodiments, after a given financial transaction at POP-device 101, a ticket 103 may be issued, generated, and/or provided. In some embodiments, ticket 103 may be physical (e.g., printed on paper or the like) and/or ticket 103 may be digital (electronic). In some embodiments, when ticket 103 may be physical, then ticket 103 may be printed at a printer that is either part of a given POP-device 101 and/or at a printer that is in operative communication with a given POP-device 101. In some embodiment, when ticket 103 may be digital (electronic), then ticket 103 may be configured to be displayed upon a screen of a given mobile-computing-device 129 (e.g., a smartphone and/or a smartwatch of the purchasing customer). In some embodiments, when ticket 103 may be digital (electronic), then ticket 103 may issued by, generated by, and/or provided by a given POP-device 101 and/or a hub 115 that is in operative communication with a given POP-device 101. In terms of written (and/or displayable) content, a given ticket 103 may comprise: a date of transaction, a time of transaction, amount(s) of transaction, and/or what was purchased at a given accommodation premises (e.g., food item(s), beverage item(s), and/or use of specific seating(s) 111).

FIG. 1A shows at least one code 105 that may be part of a given ticket 103. In some embodiments, ticket 103 may comprise at least one code 105. In some embodiments, code 105 may be selected from at least one of: a QR code (quick response code), a 2D code (two-dimensional code), a bar code, an optical readable code, a machine-readable code, a numeric code, an alphanumeric code, a one-time use code, an audible code (configured to be emitted by a speaker), combinations thereof, and/or the like. In some embodiments, code 105 may be configured to be read, scanned, and/or interrogated by at least one electronic-device 107 (reader/scanner 107a) located within boundary 113 of the given accommodation premises. In some embodiments, code 105 may be physical (e.g., printed on paper or the like) and/or code 105 may be digital (electronic). In some embodiments, when code 105 may be physical, then code 105 may be printed at a printer that is either part of a given POP-device 101 and/or at a printer that is in operative communication with a given POP-device 101. In some embodiment, when code 105 may be digital (electronic), then code 105 may be configured to be displayed upon a screen of a given mobile-computing-device 129 (e.g., a smartphone and/or a smartwatch of the purchasing customer) and/or code 105 may be configured to be played from a speaker of a given mobile-computing-device 129 (e.g., a smartphone and/or a smartwatch of the purchasing customer). In some embodiments, when code 105 may be digital (electronic), then code 105 may issued by, generated by, and/or provided by a given POP-device 101 and/or a hub 115 that is in operative communication with a given POP-device 101. In some embodiments, a given 105 (when properly issued and/or read) may be configured to provide access to and/or to denote authorized use of at least one seat 111, for at least some (predetermined) amount of time, in that given accommodation premises (e.g., within boundary 113). In some embodiments, a given code 105 may be generated based on a customer purchasing at least one of: food, beverage, and at least one seat 111 usage.

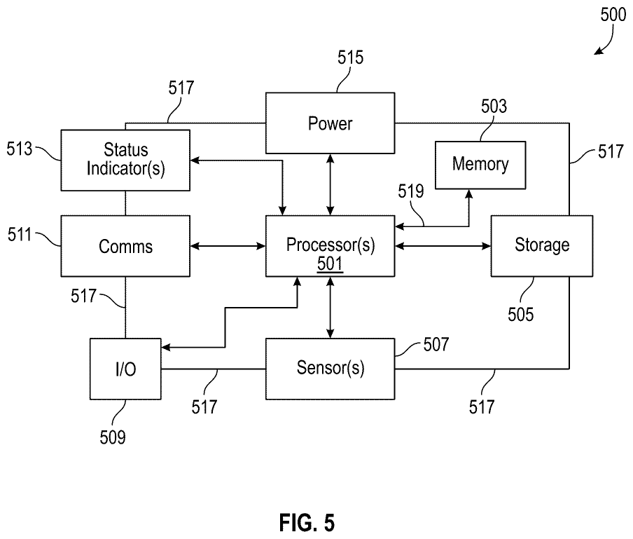

FIG. 1A shows at least one electronic-device 107. In some embodiments, electronic-device 107 may be at least one of: electrically powered; electrically operated; a computing-device; a computer, an electronic device, a reader/scanner 107a (shown in FIG. 1D); a status-indicator 107b (shown in FIG. 1D); a presence-detector-device(s) 107c (shown in FIG. 1D); a computer 500 (shown in FIG. 5); a computing-device 500 (shown in FIG. 5); a portion thereof; combinations thereof; and/or the like. In some embodiments, electronic-device 107 may comprise at least one of: a computing-device; a computer, an electronic device, a reader/scanner 107a (shown in FIG. 1D); a status-indicator 107b (shown in FIG. 1D); a presence-detector-device(s) 107c (shown in FIG. 1D); a computer 500 (shown in FIG. 5); a computing-device 500 (shown in FIG. 5); software (firmware) non-transitorily stored in its storage 505 (see FIG. 5 for storage 505); a portion thereof; combinations thereof; and/or the like. In some embodiments, a given electronic-device 107 may comprise at least one of the following functions: code 105 scanning, reading, and/or interrogation; indicating occupancy status of seat(s) 111 (of a given table 109); determining (sensing, finding, and/or monitoring for) presence (occupancy, sitting, and/or standing) of a person at a given seat 111; communicating with hub(s) 115 of the given accommodation premises; communicating with computer-server(s) 125 (onsite or offsite of the given accommodation premises); communicating with (user, customer, and/or patron) mobile-computing-device(s) 129 (such as, but not limited to, smartphones, tablet computers, laptop computers, smartwatches, and/or the like); combinations thereof; and/or the like. In some embodiments, a given electronic-device 107 may be associated with at least one table 109 and/or with at least one seat 111. In some embodiments, associated in this context may mean at least one of: a given electronic-device 107 is in direct communication with a given table 109; a given electronic-device 107 is in direct physical contact with a given table 109; a given electronic-device 107 is in direct physical contact with a given seat 111; a given electronic-device 107 may be positioned to monitor at least one table 109; a given electronic-device 107 may be positioned to monitor at least one seat 111; combinations thereof; and/or the like.

FIG. 1A shows at least one table 109. FIG. 1A may also show a first table 109a, a second table 109b, a third table 109c, and a fourth table 109d. Note, in some embodiments, when reference numeral “109” may be used herein without a letter suffix, then that “109” may be referring to at least one of the tables 109 shown in the drawings or the like substantially flat, planar, and/or horizontal surface. Whereas, in some embodiments, when reference numeral “109” may be used herein with a letter suffix, such as, in “109a” then a specific table may be referred to, such as, first table 109a in this example. In some embodiments, table 109 may be selected from at least one of: a table; a table top; a bar; a countertop; a bench; a workbench; a location where food and/or beverage is intended to rest on top of; a location where food and/or beverage is intended to be consumed from; a location from which at least one person is intended to sit or stand adjacent to (proximate to) (wherein adjacent to and/or proximate to in this context may mean within twelve inches); a substantially flat surface; a substantially planar surface; a substantially horizontal surface; a surface that may be substantially parallel with a ground (floor) surface; a substantially planar member; combinations thereof; and/or the like.

Continuing discussing FIG. 1A, in some embodiments, first table 109a may be configured to accommodate from one to four seat(s) 111 around at least some its perimeter. In some embodiments, first table 109a may comprise at least one electronic-device 107, wherein that electronic-device 107 may be configured to monitor from one to four seat(s) 111 of first table 109a. In some embodiments, a given electronic-device 107 may be configured to communication with first table 109a, wherein that electronic-device 107 may be configured to monitor from one to four seat(s) 111 of first table 109a. In some embodiments, a given electronic-device 107 may be in direct communication with first table 109a, wherein that electronic-device 107 may be configured to monitor from one to four seat(s) 111 of first table 109a. In some embodiments, in first table 109a, there may be a one-to-four (1:4) correspondence relationship (ratio) of electronic-device(s) 107 to seat(s) 111.

Continuing discussing FIG. 1A, in some embodiments, second table 109b may be configured to accommodate from one to three seat(s) 111 around at least some of its perimeter. In some embodiments, second table 109b may comprise at least one electronic-device 107, wherein that electronic-device 107 may be configured to monitor from one to three seat(s) 111 of second table 109b. In some embodiments, a given electronic-device 107 may be configured to communication with second table 109b, wherein that electronic-device 107 may be configured to monitor from one to three seat(s) 111 of second table 109b. In some embodiments, a given electronic-device 107 may be in direct communication with second table 109b, wherein that electronic-device 107 may be configured to monitor from one to three seat(s) 111 of second table 109b. In some embodiments, in second table 109b, there may be a one-to-three (1:3) correspondence relationship (ratio) of electronic-device(s) 107 to seat(s) 111.

Continuing discussing FIG. 1A, in some embodiments, third table 109c may be configured to accommodate from one to ten seat(s) 111 around at least some of its perimeter. In some embodiments, third table 109c may comprise at least two (separate and distinct) electronic-devices 107, wherein each of those electronic-devices 107 may be configured to monitor from one to five seat(s) 111 of third table 109c (and such that those electronic-devices 107 are not monitoring the same seats 111). In some embodiments, a given electronic-device 107 may be configured to communication with third table 109c, wherein that electronic-device 107 may be configured to monitor from one to five seat(s) 111 of third table 109c. In some embodiments, a given electronic-device 107 may be in direct communication with third table 109c, wherein that electronic-device 107 may be configured to monitor from one to five seat(s) 111 of third table 109c. In some embodiments, a given electronic-device 107 associated with third table 109c may not monitor seats 111 that another (different) electronic-device 107 may be monitoring. In some embodiments, in third table 109c, there may be a one-to-five (1:5) correspondence relationship (ratio) of electronic-device(s) 107 to seat(s) 111.

Continuing discussing FIG. 1A, in some embodiments, fourth table 109d may be configured to accommodate from one to four seat(s) 111 around at least some of its perimeter. In some embodiments, fourth table 109d may comprise at least one electronic-device 107, for each seat 111 of fourth table 109d, wherein each electronic-device 107 may be configured to monitor a specific and/or a single seat 111 of fourth table 109d. In some embodiments, a given electronic-device 107 may be configured to communication with fourth table 109d, wherein that electronic-device 107 may be configured to monitor a specific and/or a single seat 111 of fourth table 109d. In some embodiments, a given electronic-device 107 may be in direct communication with fourth table 109d, wherein that electronic-device 107 may be configured to monitor a specific and/or a single seat 111 of fourth table 109d. In some embodiments, a given electronic-device 107 associated with fourth table 109d may not monitor seats 111 that another (different) electronic-device 107 may be monitoring. In some embodiments, in fourth table 109d, there may be a one-to-one (1: 1) correspondence relationship (ratio) of electronic-device(s) 107 to seat(s) 111.

FIG. 1A shows at least one seat 111. In some embodiments, each table 109 of a given accommodation premises may have (may comprise) at least one associated seat 111. In some embodiments, seat 111 may be at least one of: a chair; a seat; a stool; a bench; a booth; a loveseat; a couch; a sofa; a divan; a settee; a chaise lounge; a daybed; a hammock; a recliner; a rocking chair; a gliding chair; a structure intended to be sat upon by a person; a location in a given accommodation premises that is intended to be sat at by a person; a location in a given accommodation premises that is intended for a person to stand at; combinations thereof; and/or the like. In some embodiments, a given seat 111 may be fixed (such as, but not limited to, a booth), movable, or mobile. In some embodiments, “seat 111,” “seating 111,” and/or “intended occupancy location 111” may be used interchangeably herein. In some embodiments, “seat 111” or “seating 111” may mean “intended occupancy location 111.” In some embodiments, “seat 111” or “seating 111” may refer to a specific location of a given accommodation premises where a person is intended to sit and/or where a person is intended to stand. In some embodiments, “seat 111” or “seating 111” may mean a “designated standing location 111” (designated standing area 111). In some embodiments, a given seat 111 of a given accommodation premises need not be associated with a given table 109.

FIG. 1A shows at least one hub 115. In some embodiments, hub 115 may be at least one of: electrically powered; electrically operated; a computing-device; a computer, an electronic device, a reader/scanner 107a (shown in FIG. 1D); a status-indicator 107b (shown in FIG. 1D); a presence-detector-device(s) 107c (shown in FIG. 1D); a computer 500 (shown in FIG. 5); a computing-device 500 (shown in FIG. 5); a portion thereof; combinations thereof; and/or the like. In some embodiments, hub 115 may comprise at least one of: a computing-device; a computer, an electronic device, a reader/scanner 107a (shown in FIG. 1D); a status-indicator 107b (shown in FIG. 1D); a presence-detector-device(s) 107c (shown in FIG. 1D); a computer 500 (shown in FIG. 5); a computing-device 500 (shown in FIG. 5); software (firmware) non-transitorily stored in its storage 505 (see FIG. 5 for storage 505); a portion thereof; combinations thereof; and/or the like. In some embodiments, a given hub 115 may comprise at least one of the following functions: a gateway (e.g., for accessing network 127, server(s) 125, and/or mobile-computing-device(s) 129); a network switch (e.g., for accessing network 127, server(s) 125, and/or mobile-computing-device(s) 129); code 105 scanning, reading, and/or interrogation; indicating occupancy status of seat(s) 111 (of a given table 109); determining (sensing, finding, and/or monitoring for) presence (occupancy, sitting, and/or standing) of a person at a given seat 111; issuing, generating, and/or providing code(s) 105 (upon confirmed payment at POP-device(s) 101); sending and/or transmitting code(s) 105 (to printer(s), POP-device(s) 101, and/or mobile-computing-device(s) 129); receiving code(s) 105 (from electronic-device(s) 107 and/or from mobile-computing-device(s) 129); verifying received code(s) 105; analyzing, determining, and/or calculating sensor(s) results/readings from electronic-device(s) 107 (to determine or verify a person's presence [or absence] at a given seat 111); controlling electronic-device(s) 107 of a given accommodation premises; monitoring electronic-device(s) 107 of a given accommodation premises; managing electronic-device(s) 107 of a given accommodation premises; updating electronic-device(s) 107 of a given accommodation premises; communicating with electronic-device(s) 107 of a given accommodation premises; communicating with computer-server(s) 125 (onsite or offsite of the given accommodation premises); communicating with (user, customer, and/or patron) mobile-computing-device(s) 129 (such as, but not limited to, smartphones, tablet computers, laptop computers, smartwatches, and/or the like); combinations thereof; and/or the like. In some embodiments, a given hub 115 may be in (intermittent) communication with at least one electronic-device(s) 107 of a given accommodation premises. In some embodiments, a given hub 115 may be in (intermittent) wireless communication with at least one electronic-device(s) 107 of a given accommodation premises. In some embodiments, a given hub 115 may be in (intermittent) communication with one or more electronic-device(s) 107 of a given accommodation premises. In some embodiments, a given hub 115 may be in (intermittent) wireless communication with one or more electronic-device(s) 107 of a given accommodation premises. In some embodiments, a given hub 115 may be in (intermittent) communication with a plurality of electronic-devices 107 of a given accommodation premises. In some embodiments, a given hub 115 may be in (intermittent) wireless communication with a plurality of electronic-devices 107 of a given accommodation premises. In some embodiments, a given hub 115 may be configured to operate and/or function as a computer-server of a given accommodation premises. In some embodiments, a given hub 115 for (of) a given accommodation premises, may receive its electrical power through a wired connection to that given accommodation premises (building) (e.g., by being plugged into the building's power source outlet and/or by being hard-wired to the building's power source). In some embodiments, for a given accommodation premises, there may be at least one hub 115 for a plurality of electronic-devices 107 (that may be in intermittent wireless communication with that at least one hub 115); wherein, this configuration may permit higher power usages and/or higher power computations to be performed by the hub 115 instead of by the plurality of electronic-devices 107, thereby minimizing power usage in the plurality of electronic-devices 107 and prolonging battery life of the plurality of electronic-devices 107. In some embodiments, hub 115 may be located within boundary 113. In some embodiments, hub 115 may be located outside of boundary 113, wherein if hub 115 may be located outside of boundary 113, then hub 115 may be located so that hub 115 may still be within wireless communication range with at least one electronic-device 107, wherein that at least one electronic-device 107 may be located inside of boundary 113. In some embodiments, a given hub 115 may be mounted to a ceiling (above or below), to a wall, to a post/pole, and/or the like of the given accommodation premises; or the given hub 115 may be resting on top of a substantially flat and horizontal surface of the given accommodation premises. In some embodiments, a given accommodation premises may comprise at least one hub 115; or one or more hubs 115; or a plurality of hubs 115 (depending upon a physical size of that given accommodation premises). In some embodiments, electronic-device(s) 107, hub(s) 115, and/or local (onsite) computer-server(s) 125—of a given accommodation premises-may be configured to form a mesh network for wireless communications amongst at least those devices that is at least partially located within boundary 113. In some embodiments, a given hub 115 may be in (intermittent) communication with at least one computer-server(s) 125. In some embodiments, a given hub 115 may be in (intermittent) wireless communication with at least one computer-server(s) 125. Note, computer-server(s) 125 are shown in FIG. 1E.

With respect to FIG. 1A, in some embodiments, customers should not use (e.g., sit at or stand at) a given intended occupancy location 111 (such as, but not limited to, a given table 109), unless that customer (or that party [group]) provides and/or presents an “occupancy-code” (code 105) to a device 107 (107a) associated with that given intended occupancy location 111. For example, and without limiting the scope of the represent invention, the occupancy-code 105 might be QR code (or the like) and the device 107/107a might be an electronic-device 107/107a with a QR code reader. The QR code 105 may be provided to customer 117 (or to the party) in a variety of different ways. For example, and without limiting the scope of the represent invention, the QR code 105 may be placed on a receipt 103 and/or pushed to a smartphone 129 of the customer 117. The QR code 105 may be obtained after the customer 117 purchases some goods or purchases some time for using a given seat(s) 111 at the accommodation. The customer 117 chooses their intended occupancy location 111 (such as, but not limited to, a table 109) with an indicator light 107/107a that is emitting visible colored light that indicates that its monitored intended occupancy location 111 is presently available for occupancy (and sits down); then the customer 117 provides and/or presents their obtained QR code 105 to the electronic-device 107/107a (with code reader) associated with that given intended occupancy location 111 and the indicator light 107/107a then turns another predetermined color indicating that the customer 117 is approved to sit there (for at least some amount of time). The time allotted to the customer 117 may be a set time from a date and time of purchase and/or based on the amount of purchase. In some embodiments, the higher the amount of purchase the more time that may be allowed. When a (predetermined) allotted time period may be about to run out, the indicator light 107b/513 may change to yet another predetermined color, warning the customer (and/or other observers) that that allotted time is about to expire—which in some embodiments, might be extended by new further purchase(s) and presenting of a new QR code 105. If the customer 117 elects not to make an additional purchase (e.g., to extend their duration for using that particular intended occupancy location 111), to generate a new QR code 105, to extend their allotted occupancy time, the indicator light 107b/513 may turn a different (predetermined) color to indicate that the customer 117 has overstayed their occupancy and thus time for that customer to leave (vacate) that particular intended occupancy location 111 and/or to indicate that that particular intended occupancy location 111 is ready for new occupancy.

Purchases and/or purchasing may be done at one or more of the following: at least one free standing kiosk 101 of that given accommodation, at least one mobile kiosk 101 of that given accommodation, via interaction with an employee of that given accommodation, a register 101 of that given accommodation (such as, but not limited to, a cash register), via a mobile app running on a customer's smartphone 129 (or smart device), via a web browser on a customer's smartphone 129 (or smart device), a “payment receiver 101” of the electronic-device 107 associated with the indicator light(s) 107b/513, a payment receiver 101 associated and/or a control electronic unit device 115, combinations thereof, and/or the like. In some embodiments, a payment receiver 101 may be a means for accepting payment, such as, but not limited to, a credit card payment reader, a debit card payment reader, a contactless payment receiver, a mobile payment system (such as, but not limited to, Apple Pay, Google Wallet, and/or the like), combinations thereof, and/or the like.

Indicator light(s) 107b/513 of a given intended occupancy location 111 may be one or more LEDs (light emitting diodes) or other light sources, including in singular form, string form, rope form, tape form, and/or the like. Indicator light(s) 107b/513 may also be configured to emit light of a predetermined color to indicate that its monitored intended occupancy location 111 may be in need of cleaning (busing) and/or other predetermined statutes.

Embodiments of the above noted invention are not limited to using only QR codes 105 for the occupancy-codes to gain approved occupancy for a given intended occupancy location 111 of the premises of a given accommodation. Other types of codes 105 may also be utilized and still be within the scope of the present invention. In some embodiments, other codes 105 may be selected from at least one of: machine readable codes, optical codes, bar codes, auditory codes, alphanumeric codes, passwords, combinations thereof, and/or the like.

In some embodiments, generated occupancy-codes 105 may expire after some of time has transpired from the occupancy-code's generation and/from when a generated occupancy-code has been used (read/scanned) by a given electric-device 107.

Also, in some embodiments and/or in some scenarios, a given customer 117 may not need to present an occupancy-code 105 to the electric-device 107 associated with a given intended occupancy location 111 (e.g., a particular table 109), because the customer 117 pays directly at that electric-device 107 of that particular intended occupancy location 111.

In some embodiments, it may be intended to place indicator lights 107b/513 of the premises of a given accommodation such that all and/or any people 117 of that given accommodation premises, including customers and employees, may clearly be able to see the indicator lights 107b/513 associated with each (all of the) given intended occupancy location(s) 111 of that given accommodation, including those sitting, standing, or otherwise occupying a given intended occupancy location 111 with a light color (such as, but not limited to, red, blue, purple, or other predetermined color) that indicates the customer 117 has overstayed their occupancy and/or that indicates some other status of the given intended occupancy location 111. Generally, an embarrassment factor alone may often be enough to encourage the over-staying customer 117 to leave and vacate that given intended occupancy location 111 because the indicator light 107b/513 of the intended occupancy location 111 is indicating to all that that particular intended occupancy location 111 has an overstayed customer. If the over-staying customer 117 elects to stay at the given intended occupancy location 111 when they should not, as indicated by the associated indicator light 107b/513 and its color, an employee may ask that customer to purchase additional goods or to release (leave and/or vacate) the given intended occupancy location 111 (e.g., to a paying customer).

These indicator lights 107b/513, associated with the intended occupancy locations 111, may be with or without a digital display 509 (screen 509). Or the display 509 may be the actual indicator light 107b/513. The display 509 (screen 509) may display a numerical countdown telling observers how much time is left remaining before expiring or the display 509 (screen 509) may not display a countdown. The display 509 (screen 509) may display words, graphics, animations, symbols, and/or the like, or none of these.

In some embodiments, the indicator light 107b/513 may be independent with the code reader 107a and electronics built-in to each unit with no wireless or Bluetooth connectivity to a mother unit 115, or the indicator light 107b/513 may be wirelessly or Bluetooth connected to a mother unit 115 (either directly [device-to-device] or indirectly [through a network, such as, but not limited to, network 127 or a portion thereof]). The indicator light 107b/513 may have a motion and/or heat detector 507 built-in, so if a customer 117 leaves when their light 107b/513 is still green (or other predetermined color indicating currently properly occupied), after a sufficient time-lapse occurs, then that indicator light 107b/513 may turn (change) into a predetermined different color to indicate that its monitored intended occupancy location 111 is now vacate, thereby making the most efficient use of the availability of intended occupancy locations 111 of that given accommodation. The indicator light 107b/513 and the code reader 107a may be the same device 107 or two different devices. The indicator light 107b/513 and/or the code reader 107a may be electronic devices. The indicator light 107b/513 and/or the code reader 107a may be computing devices (such as, but not limited to, device 500).

In some embodiments, an electronic-device 107 associated with each intended occupancy location 111, of that given accommodation, may have hardware and/or software, that configures that electronic-device 107 to operate and control its associated indicator light(s) 107b/513, its code reader 107a, its display (screen) 509, its payment receiver 101 (if any), and/or to run mobile location analytics. In some embodiments, the electronic-device 107 associated with each intended occupancy location 111, of that given accommodation, may comprise at least one of: an indicator light 107b/513, a sensor 507 (e.g., a motion sensor and/or a heat/thermal sensor), a code reader 107a (such as, but not limited to, a camera), a payment receiver 101, a processor 501, storage 505 and/or memory 503 for operating software/firmware and/or sensor's data, a power source 515 (and/or a means for accepting power), optionally a display (screen) 509, and optionally a wireless communication means 511 (e.g., radio, receiver, transceiver, and/or antenna). The electronic-device 107 may comprise custom designed hardware/software to implement infrared sensor(s) 507 and/or mobile location analytics. The infrared sensor 507 (and/or other sensor(s) 507) may be constantly on, calculating proximity, and/or calculating/determining occupancy of the associated intended occupancy location 111 that is assigned and/or associated with that particular electronic-device 107. The electronic-device 107 may be battery 515 powered and/or powered from a DC (direct current) and/or a AC (alternating current) power source of that premises. When battery powered, the battery may be: at least one battery and/or rechargeable, or non-rechargeable. When rechargeable, the battery (or batteries) may be charged without removing from the electronic device or when removed from the electronic device.

When someone occupies (sits down or stands) at a given intended occupancy location 111 that is being monitored by at least one electronic-device 107, the sensor(s) 507 may pick up the heat signature and/or the motion of the person 117 (including possibly motion associated with the person 117 breathing) and the electronic-device 107 onboard software (of that at least one electronic-device 107) may analyze received sensor(s) 507 reading(s) to determine proximity of that detected signature (e.g., heat, motion, imagery consistent with a person), if proximity strength and/or analysis signifies occupancy, the associated indicator light(s) 107b/513 (of that at least one electronic device) may change color (e.g., to amber or some other predetermined color), to indicate that the person 117 needs to timely present a QR code 105 to the associated code reader 107a (or pay at that at least one electronic-device 107 if it has a payment receive 101 means) or if a proper QR code 105 is not timely presented to the code reader 107a (or if payment is not timely received at that at least one electronic-device 107), then the indicator light(s) 107b/513 might change to a color to indicate that the given intended occupancy location 111 is currently improperly occupied. In some embodiments, the display (screen) 509, if present, may display a countdown of the allotted time being given to provide the QR code 105 (or to pay that at least one electronic-device 107).

In some embodiments, when the sensor(s) 507 and software (of a given electronic-device 107) determine occupancy at the given intended occupancy location 111, that given electronic-device 107 (via its antenna and/or radio) may scan and search for electronic signals (such as, but not limited to, WiFi, Bluetooth, and/or the like) emanating from a smart device 129 (such as, but not limited to, a smartphone, smart watch, or the like), associated with the person 117 now occupying that given intended occupancy location 111 (which may be done by analyzing signal strength). If the found signal strength is within a specified range, and if the smart device 129 is turned on, and if either WiFi or Bluetooth are turned on, the electronic-device 107 may then grab the MAC address (or the like identifier) of that smart device 129 (a unique identifier for a device) which may then in turn anonymously identify this specific customer/person 117 that is now occupying that given intended occupancy location 111. If more than one person 117 occupies that given intended occupancy location 111, then the associated electronic-device 107 of that given intended occupancy location 111, may track all such found smart device 129 of those persons 117.

Note in some embodiments, a person 117 who is not interested in purchasing goods (e.g., food and/or beverage) may still purchase time to occupy a given intended occupancy location 111.

In some embodiments, the externally and/or publicly visible indicator lights 107b/513 may be replaced with, or used in conjunction with, a mobile app running on customer smart devices 129 and/or with a website accessible from a web browser of customer smart devices 129, wherein the indicator lights 107b/513 get displayed upon a screen 509 of the smart device 129. Such a mobile app and/or a website may facilitate a more discrete status notification means as compared to the externally and/or publicly visible indicator lights 107b/513. Such a more discrete status notification system for intended occupancy locations 111 may be preferable in fine dining accommodations.

Note, there may be some situations where people are waiting for a vacant table 109 (or waiting for some other type of intended occupancy location 111 to be vacated), but they do not know when the people currently sitting (or standing) at the table 109 (or other intended occupancy location 111) are going to leave. The indicator light system, e.g., an amber light (or other predetermined color), would not only notify the people sitting at the table 109 their time is about up and they need to prepare to leave, that amber light would also notify the people waiting for tables 109 and the waitstaff of the tables 109 (intended occupancy locations 111) about to become available for new occupancy/use.

FIG. 1B is a top-down (overhead) schematic block diagram view of at least a portion of system 100. FIG. 1B is a top-down (overhead) schematic block diagram view showing a person 117 sitting (or standing) at a given seat 111, of a given table 109. In some embodiments, person 117 may have already paid for something (e.g., food, beverage, and/or usage of seating 111) at the given accommodation premises (such as, but not limited to, a coffee shop or a restaurant) (e.g., using a POP-device 101), such that person 117 may be in possession of a ticket 103 with a (valid) code 105.

FIG. 1B may show a communication 119 between code 105 and a given electronic-device 107 (and/or reader/scanner 107a) of a table 109 that person 117 is appropriately seated (or standing) at. In some embodiments, communication 119 may comprise the given electronic-device 107 (and/or reader/scanner 107a) receiving, reading, scanning, seeing, video capturing, and/or interrogating code 105. In some embodiments, upon the given electronic-device 107 (and/or reader/scanner 107a) receiving at least some informational content of code 105, then that given electronic-device 107 (and/or reader/scanner 107a) may seek to verify (validate) that the at least some information content of that code 105 is still valid for person 117 to appropriately occupy a seat 111 at that table 109 (for at least some amount of time). In FIG. 1B, code 105 may be displayed (printed) upon a paper ticket 103 and/or code 105 may be displayed upon a (touch) screen of a mobile-computing-device 129 (such as, but not limited to, a smartphone, smartwatch, tablet computer, and/or laptop computer) of person 117.

FIG. 1B may show a communication 121 between person 117 and a given electronic-device 107 (and/or presence-detector-device(s) 107c) of a table 109 that person 117 is appropriately seated (or standing) at. In some embodiments, communication 121 may comprise the given electronic-device 107 (and/or presence-detector-device(s) 107c) receiving, reading, scanning, seeing, sensing, finding, and/or determining an appropriate physical presence of person 117 at a given seat 111 of that table 109. In some embodiments, electronic-device 107 (and/or presence-detector-device(s) 107c) may use at least one of its sensor(s) 507 for accomplishing communication 121 (see e.g., FIG. 5 for sensor(s) 507). Continuing discussing FIG. 1B, in some embodiments, sensor(s) 507 data received at electronic-device 107 (and/or presence-detector-device(s) 107c) (from communication 121) may be analyzed for person 117 proper or improper presence or absence at/on that electronic-device 107 (and/or presence-detector-device(s) 107c) and/or at/on at least one hub 115 (that is in communication with that electronic-device 107 [and/or presence-detector-device(s) 107c]) and/or at/on at least one computer-server 125 (that is in communication with that electronic-device 107 [and/or presence-detector-device(s) 107c] and/or that is in communication with at least one hub 115 of that given accommodation premises). In some embodiments, communication 121 may occur independently of communication 119. In some embodiments, communication 121 and communication 119 may occur with at least partial overlap, concurrently, or with no overlap.

FIG. 1B may show at least one tag 123 of table 109. In some embodiments, a given table 109 (of a given accommodation premises) may have (comprise) at least one tag 123. In some embodiments, each proper (appropriate) seat 111 of that table 109 may have its own tag 123. In some embodiments, tag 123 may be in (direct) communication with table 109. In some embodiments, tag 123 may be directly physically touching table 109. In some embodiments, tag 123 may be (directly) attached (affixed and/or mounted) to table 109. In some embodiments, tag 123 may be located on a top (upper) surface of table 109. In some embodiments, tag 123 may be located on an outer (external) perimeter (boundary) edge/surface of table 109. In some embodiments, tag 123 may be a sticker and/or a label. In some embodiments, tag 123 may be at least partially embedded within table 109. In some embodiments, tag 123 may be configured to be human readable and/or to be machine readable. In some embodiments, tag 123 may comprise informational content that identifies a proper seat 111 of table 109. In some embodiments, person 117 may read tag 123 and may then (manually) enter that person's seat 111 identification information (as found in that tag 123) upon electronic-device 107 (and/or presence-detector-device(s) 107c) of their table 109; and/or that person 117 may (manually) enter that person's seat 111 identification information (as found in that tag 123) on their own mobile-computing-device 129 (which may be in wireless communication with electronic-device 107, hub 115, and/or server 125). In some embodiments, when tag 123 may comprise at least some machine readable content (such as, but not limited to, a QR code or the like), person 117 may use their mobile-computing-device 129 to read tag 123. In some embodiments, when seat 111 identification information content of a given tag 123 is received at mobile-computing-device 129, that information may be communicated to electronic-device 107, hub 115, and/or server 125. In such ways, a person 117 occupying a seat 111 of table 109 may be conveyed to system 100 (or to a portion of system 100). In some embodiments, table 109 may comprise at least one tag 123. In some embodiments, table 109 may comprise at least one tag 123 for each designated seating (and/or standing) area 111 of that table 109. In some embodiments, table 109 may comprise at least one tag 123 for a group of designated seating (and/or standing) area 111 of that table 109.

FIG. 1C may be a detail (close-up) view of a portion of FIG. 1B, that focuses on a possible code 105 reading (or the like) interaction 119 between code 105 and electronic-device 107 (and/or reader/scanner 107a). In some embodiments, electronic-device 107 (and/or reader/scanner 107a) may be configured to receive, read, scan, see, photo capture, video capture, and/or interrogate code 105 and/or at least some of its informational content, which may be indicated by communication 119.

FIG. 1D is a block diagram showing at least three functional elements of a given electronic-device 107, namely, of reader/scanner 107a, status-indicator 107b, and presence-detector-device(s) 107c. In some embodiments, at least some functional element of electronic-device 107, such as, but not limited to reader/scanner 107a, status-indicator 107b, and/or presence-detector-device(s) 107c, may be implemented via hardware and/or via software. In some embodiments, reader/scanner 107a may be configured to receive, read, scan, see, photo capture, video capture, and/or interrogate code 105 and/or at least some of its informational content. In some embodiments, status-indicator 107b may be configured to provide seat(s) 111 occupancy status information (via visual display[s] and/or via audible [auditory] means). In some embodiments, status-indicator 107b may be configured to indicate that a given seat 111 is: unoccupied; unoccupied and ready for occupancy; properly occupied; improperly occupied; out of service; combinations thereof; and/or the like. In some embodiments, presence-detector-device(s) 107c (via sensor(s) 507) may be configured to receive, read, scan, see, sense, find, and/or determine presence (or absence) of a person 117 within a field-of-view (FOV) 411 and to a predetermined range of that presence-detector-device(s) 107c.

FIG. 1D is a block diagram showing that the at least three functional elements of a given electronic-device 107 (in some embodiments), namely, of reader/scanner 107a, status-indicator 107b, and presence-detector-device(s) 107c may be manufactured such that: all three functional elements are part of a single integral device 107; each functional element is its own physically separate and distinct device (e.g., with three physically separate and distinct devices); or two of the three elements are a single device with the third element being its own physically separate and distinct device.

FIG. 1E is a block diagram showing at least some possible (intermittent) communications of at least some hardware, computing, and/or electronic elements of system 100 (and/or for system 200 and/or for system 300). In some embodiments, a given POP-device 101 may be in communication with: electronic-device(s) 107; hub(s) 115; computer-server(s) 125; and/or mobile-computing-device(s) 129. In some embodiments, mobile-computing-device 129 may be a user (electronic and/or computing) device, such as, but not limited to, a (electronic and/or computing) device used by person 117. In some embodiments, mobile-computing-device 129 may be selected from at least one of: a smartphone, a smartwatch, a tablet computer, a laptop computer, and/or the like. In some embodiments, a given electronic-device 107 may be in communication with: POP-device(s) 101; hub(s) 115; computer-server(s) 125; and/or mobile-computing-device(s) 129. In some embodiments, a given hub 115 may be in communication with: POP-device(s) 101; electronic-device(s) 107; computer-server(s) 125; network 127; and/or mobile-computing-device(s) 129. In some embodiments, network 127 may be selected from: a LAN (local area network), a WAN (wide area network), the Internet, the cloud, a portion thereof, combinations thereof, and/or the like. In some embodiments, network 127 may comprise network hardware and/or network equipment such as, but not limited to, at least one of: computer(s), server(s), router(s), switche(s), hub(s), gateway(s), access point(s), wiring, cabling, fiber, radio(s), antenna(s), relay(s), a portion thereof, combinations thereof, and/or the like. In some embodiments, a given computer-server(s) 125 may be in communication with: POP-device(s) 101; electronic-device(s) 107; hub(s) 115; network 127; and/or mobile-computing-device(s) 129. In some embodiments, network 127 may be in communication with: hub(s) 115; computer-server(s) 125; and/or mobile-computing-device(s) 129. In some embodiments, a given mobile-computing-device 129 may be in communication with: POP-device(s) 101; electronic-device(s) 107; hub(s) 115; computer-server(s) 125; and/or network 127. In FIG. 1E any of the shown communications may be: entirely wireless; entirely wired; partially wireless and partially wired; combinations thereof; and/or the like. In FIG. 1E any of the shown communications may be: electronic, electrical, optical, via radio wave(s), via microwave(s), via infrared, combinations thereof, and/or the like. In some embodiments, with respect to a given accommodation premises, POP-device(s) 101, electronic-device(s) 107, and hub(s) 115 may all be local (onsite), such as, but not limited to, being located within boundary 113 of that given accommodation premises. In some embodiments, with respect to a given accommodation premises, hub(s) 115 may be local (onsite), such as, but not limited to, being located within boundary 113 of that given accommodation premises; and/or hub(s) 115 may be located offsite (remote) from that given accommodation premises (but still within wireless communications range of at least one electronic-device 107 within boundary 113). In some embodiments, with respect to a given accommodation premises, computer-server(s) 125 may be local (onsite), such as, but not limited to, being located within boundary 113 of that given accommodation premises; and/or computer-server(s) 125 may be located offsite (remote) from that given accommodation premises.

In some embodiments, FIG. 1A to FIG. 1E may pertain to system 100 and/or to a portion of system 100. In some embodiments, system 100 may comprise at least one of: POP-device(s) 101; ticket(s)/receipt(s) 103; code(s) 105; electronic-device(s) 107; reader(s)/scanner(s) 107a; status-indicator(s) 107b; presence-detector-device(s) 107c; software on electronic-device(s) 107; table(s) 109; intended occupancy location(s) 111; volume and/or area within boundary/perimeter 113; hub(s) 115; software on hub(s) 115; scanning/reading code communication 119; presence-detected (presence-sensed) communication 121; tag(s) 123; computer-server(s) 125; software on computer-server(s) 125; software (mobile app) saved on mobile-computing-device(s) 129 (but not mobile-computing-device 129 itself); combinations thereof; and/or the like. In some embodiments, system 100 may comprise one or more of: POP-device(s) 101; ticket(s)/receipt(s) 103; code(s) 105; electronic-device(s) 107; reader(s)/scanner(s) 107a; status-indicator(s) 107b; presence-detector-device(s) 107c; software on electronic-device(s) 107; table(s) 109; intended occupancy location(s) 111; volume and/or area within boundary/perimeter 113; hub(s) 115; software on hub(s) 115; scanning/reading code communication 119; presence-detected (presence-sensed) communication 121; tag(s) 123; computer-server(s) 125; software on computer-server(s) 125; software (mobile app) saved on mobile-computing-device(s) 129 (but not mobile-computing-device 129 itself); combinations thereof; and/or the like.

Note, in some embodiments, in some implementation and/or in some instances use of mobile-computing-device(s) 129 may not be necessary for system 100.

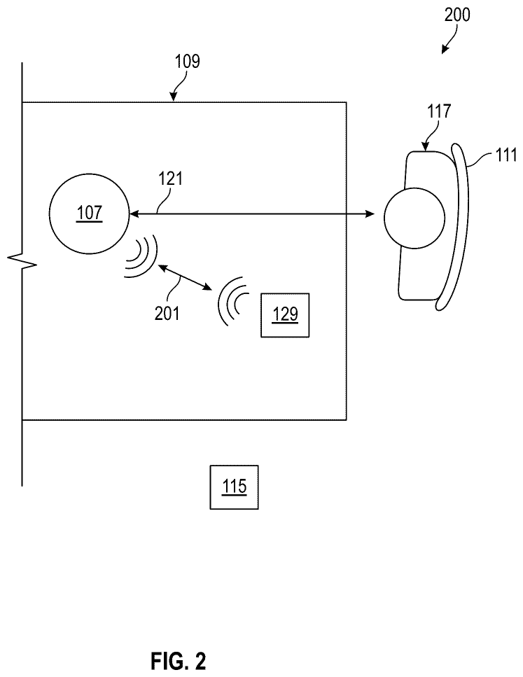

Note, FIG. 2 is similar to FIG. 1B (and/or to FIG. 1C), except in FIG. 2 a given mobile-computing-device 129 may be replacing use of ticket 103 and/or the given mobile-computing-device 129 may be replacing use of code 105. FIG. 2 is a top-down (overhead) schematic block diagram view of at least a portion of system 200. FIG. 2 is a top-down (overhead) schematic block diagram view showing a person 117 sitting (or standing) at a given seat 111, of a given table 109. In some embodiments, person 117 may have already paid for something (e.g., food, beverage, and/or usage of seating 111) at the given accommodation premises (such as, but not limited to, a coffee shop or a restaurant) using a POP-device 101 of that given accommodation premises or by person 117 using a mobile-computing-device 129 of person 117 (such as, but not limited to, a smartphone, a smartwatch, a tablet computer, or a laptop computer of person 117), such that the mobile-computing-device 129 may be in possession of a digital/electronic authorization (and/or credential, token, and/or certificate) that may authorize usage of a given seat 111 (e.g., for some amount of [predetermined] time) when received and validated (verified) by system 200 (or a portion of system 200, such as, but not limited to an electronic-device 107, a hub 115, and/or a computer-server 125). In some embodiments, in FIG. 2, software (e.g., a mobile-app) may be (non-transitorily) saved on that mobile-computing-device 129 (of person 117), wherein that software (when at least partially executed on that mobile-computing-device 129) is configured to facilitate various wireless communications and/or wireless transactions as between that mobile-computing-device 129 and at least one element of system 200, such as, but not limited to, an electronic-device 107, a hub 115, and/or a computer-server 125. In some embodiments, when person 117 users their mobile-computing-device 129 with the executing software (mobile-app) to make a purchase from the given accommodation premises (which may be food, beverage, product, and/or seat 111 usage), the digital/electronic authorization (and/or credential, token, and/or certificate) may be generated (and at least temporarily) (non-transitorily) stored (or accessible) from that given mobile-computing-device 129. In some embodiments, the generated the digital/electronic authorization (and/or credential, token, and/or certificate) may have (comprise) a finite (and predetermined) temporal expiration.

FIG. 2 may show a communication 201 between a given mobile-computing-device 129 (of person 117) (that is at least partially executing software [mobile-app]) and a given electronic-device 107 (e.g., via its radio/antenna 511) of a given table 109 that person 117 is appropriately seated (or standing) at, at seat 111. In some embodiments, communication 201 may comprise the given electronic-device 107 (via its radio/antenna 511) receiving the digital/electronic authorization (and/or credential, token, and/or certificate) on/at the given mobile-computing-device 129 that was previously generated when person 117 using their given mobile-computing-device 129 made a financial transaction with the given accommodation premises. In some embodiments, upon the given electronic-device 107 (and/or reader/scanner 107a) receiving the digital/electronic authorization (and/or credential, token, and/or certificate), then that given electronic-device 107 may seek to verify (validate) that the digital/electronic authorization (and/or credential, token, and/or certificate) is still valid for person 117 to appropriately occupy a seat 111 at that table 109 (for at least some amount of time). In FIG. 2, wireless communication 201 may occur merely by that given mobile-computing-device 129 (with the executing software [mobile-app]) being sufficiently close to the given electronic-device 107 via a wireless communication protocol, such as, but not limited to, Bluetooth, NFC (near field communication), UWB (ultra wide band), Apple Pay, Google Wallet, ZigBee, and/or the like. In some embodiments, when the given mobile-computing-device 129 and the given electronic-device 107 may be sufficiently close to each other, then may undergo a digital handshake with each other (via a wireless communication protocol). In some embodiments, sufficiently close in this context may be: four feet or less, three feet or less, two feet or less, one foot or less, six inches or less, one inch or less, and/or the like (e.g., depending upon the wireless communications hardware and protocol(s) being utilized).

In FIG. 2 automatic presence detection of person 117 at an appropriate seat 111 of table 109 may occur in one of two ways. In some embodiments, only one of those two ways may be executed; or in other embodiments, both ways may be utilized together. In some embodiments, a first way may be by the given mobile-computing-device 129 being sufficiently close to the given electronic-device 107 to serve as a proxy for indicating that the person 117 is at a proper seat 111 of table 109. In some embodiments, when the wireless communication 201 may utilize UWB, then this proxy way for determining person 117 presence at a given seat 111 of table 109 may be sufficiently accurate for reliability due to UWB's ability to detect in real-time location, distance, and direction of the given mobile-computing-device 129 with respect to the given electronic-device 107. In some embodiments, the second way that automatic presence detection of person 117 at an appropriate seat 111 of table 109 may occur is by use of sensor(s) 507 of the given electronic-device 107 (see e.g., FIG. 5 for sensor[s] 507).

FIG. 2 may show a communication 121 between person 117 and a given electronic-device 107 (and/or presence-detector-device(s) 107c) of a table 109 that person 117 is appropriately seated (or standing) at. In some embodiments, communication 121 may comprise the given electronic-device 107 (and/or presence-detector-device(s) 107c) receiving, reading, scanning, seeing, sensing, finding, and/or determining an appropriate physical presence of person 117 at a given seat 111 of that table 109. In some embodiments, electronic-device 107 (and/or presence-detector-device(s) 107c) may use at least one of its sensor(s) 507 for accomplishing communication 121. In some embodiments, sensor(s) 507 data received at electronic-device 107 (and/or presence-detector-device(s) 107c) (from communication 121) may be analyzed for person 117 proper or improper presence or absence at/on that electronic-device 107 (and/or presence-detector-device(s) 107c) and/or at/on at least one hub 115 (that is in communication with that electronic-device 107 [and/or presence-detector-device(s) 107c]) and/or at/on at least one computer-server 125 (that is in communication with that electronic-device 107 [and/or presence-detector-device(s) 107c] and/or that is in communication with at least one hub 115 of that given accommodation premises). In some embodiments, communication 121 may occur independently of communication 201. In some embodiments, communication 121 and communication 201 may occur with at least partial overlap, concurrently, or with no overlap.

In some embodiments, system 200 may comprise at least one of: POP-device(s) 101; ticket(s)/receipt(s) 103; code(s) 105; electronic-device(s) 107; reader(s)/scanner(s) 107a; status-indicator(s) 107b; presence-detector-device(s) 107c; software on electronic-device(s) 107; table(s) 109; intended occupancy location(s) 111; volume and/or area within boundary/perimeter 113; hub(s) 115; software on hub(s) 115; scanning/reading code communication 119; presence-detected (presence-sensed) communication 121; tag(s) 123; computer-server(s) 125; software on computer-server(s) 125; software (mobile-app) saved on mobile-computing-device(s) 129 (but not mobile-computing-device 129 itself); the digital/electronic authorization (and/or credential, token, and/or certificate) (generated as a result from a financial transaction between a given mobile-computing-device 129 and a given accommodation premises); combinations thereof; and/or the like. In some embodiments, system 200 may comprise one or more of: POP-device(s) 101; ticket(s)/receipt(s) 103; code(s) 105; electronic-device(s) 107; reader(s)/scanner(s) 107a; status-indicator(s) 107b; presence-detector-device(s) 107c; software on electronic-device(s) 107; table(s) 109; intended occupancy location(s) 111; volume and/or area within boundary/perimeter 113; hub(s) 115; software on hub(s) 115; scanning/reading code communication 119; presence-detected (presence-sensed) communication 121; tag(s) 123; computer-server(s) 125; software on computer-server(s) 125; software (mobile-app) saved on mobile-computing-device(s) 129 (but not mobile-computing-device 129 itself); the digital/electronic authorization (and/or credential, token, and/or certificate) (generated as a result from a financial transaction between a given mobile-computing-device 129 and a given accommodation premises); combinations thereof; and/or the like. In some embodiments, system 200 may omit at least one of: POP-device(s) 101 (as a standalone device); ticket(s)/receipt(s) 103; code(s) 105; and/or tag(s) 123. In some embodiments, at least some of FIG. 1A and/or of FIG. 1B may pertain to system 200 and/or to a portion of system 200. In some embodiments, FIG. 1D to FIG. 2 may pertain to system 200 and/or to a portion of system 200.

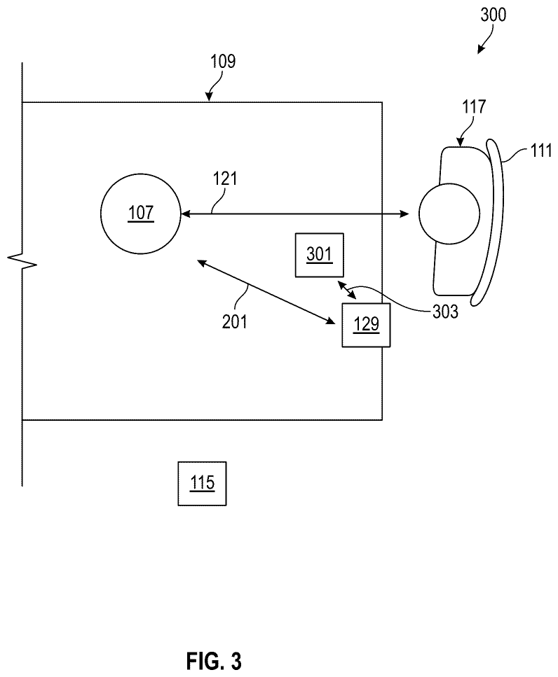

Note, FIG. 3 is similar to FIG. 1B and tag 123, except in FIG. 3 a given mobile-computing-device 129 may be replacing use of ticket 103 and/or the given mobile-computing-device 129 may be replacing use of code 105; and tag(s) 301 may be replacing tag(s) 123 in FIG. 3. Further, note, FIG. 3 may be similar to FIG. 2, except FIG. 3 may include tag(s) 301 (tag(s) 301 may be absent in FIG. 2). FIG. 3 is a top-down (overhead) schematic block diagram view of at least a portion of system 300. FIG. 3 is a top-down (overhead) schematic block diagram view showing a person 117 sitting (or standing) at a given seat 111, of a given table 109. FIG. 3 introduces a third way to automatically determine person 117 presence at an appropriate seat 111 of table 109 or just at that table 109. FIG. 3 may show at least one tag 301 of table 109. In some embodiments, a given table 109 (of a given accommodation premises) may have (comprise) at least one tag 301. In some embodiments, each proper (appropriate) seat 111 of that table 109 may have its own tag 301. In some embodiments, tag 301 may be in (direct) communication with table 109. In some embodiments, tag 301 may be directly physically touching table 109. In some embodiments, tag 301 may be (directly) attached (affixed and/or mounted) to table 109. In some embodiments, tag 301 may be located on a top (upper) surface of table 109. In some embodiments, tag 301 may be located on an outer (external) perimeter (boundary) edge/surface of table 109. In some embodiments, tag 301 may be a sticker and/or a label. In some embodiments, tag 301 may be at least partially embedded within table 109. In some embodiments, tag 301 may be configured to be human readable and/or to be machine readable. In some embodiments, tag 301 may be at least one of: a NFC tag (near field communication tag); a RFID tag (radio frequency identification tag); a UWB tag (ultra wide band tag); a Bluetooth tag; combinations thereof; and/or the like. In some embodiments, tag 301 may be a passive NFC tag and/or a passive RFID tag (that receives sufficient wireless energy for wireless communications from a sufficiently close and broadcasting mobile-computing-device 129). In some embodiments, tag 301 may be passive or actively powered (e.g., with a battery). In some embodiments, tag 301 may be fixedly located on a given table 109 to indicate at least one proper place 111 to sit or stand for a person 117 using that table 109. In some embodiments, tag 301 may comprise informational content that identifies a given table 109. In some embodiments, tag 301 may comprise informational content that identifies at least one proper seat 111 of table 109. In some embodiments, by person 117 placing their mobile-computing-device 129 sufficiently close to a given tag 301 of a given table 109 (wherein sufficiently close is close enough to enable NFC and/or RFID communications); the executing software (mobile-app) on that given mobile-computing-device 129 may energize that tag 301 causing that tag 301 to wirelessly broadcast its informational content back to that given mobile-computing-device 129; and that given mobile-computing-device 129 may receive that informational content; and then via communication 201, that mobile-computing-device 129 may pass that informational content to electronic-device 107 (electronic-device 107 may receive that informational-content of a given tag 301 of table 109); and this manner system 300 (or a portion thereof) may learn (determine and/or log) a location of that given mobile-computing-device 129 which may serve as a proxy for person 117 presence detection at a seat 111 of that table 109. In some embodiments, table 109 may comprise at least one tag 301. In some embodiments, table 109 may comprise at least one tag 301 for each designated seating (and/or standing) area 111 of that table 109. In some embodiments, table 109 may comprise at least one tag 301 for a group of designated seating (and/or standing) area 111 of that table 109.

Note, FIG. 1A, FIG. 1B, FIG. 1C, FIG. 2, and FIG. 3 may be at least partial plan views of a region of a given accommodation premises.

In some embodiments, system 300 may comprise at least one of: POP-device(s) 101; ticket(s)/receipt(s) 103; code(s) 105; electronic-device(s) 107; reader(s)/scanner(s) 107a; status-indicator(s) 107b; presence-detector-device(s) 107c; software on electronic-device(s) 107; table(s) 109; intended occupancy location(s) 111; volume and/or area within boundary/perimeter 113; hub(s) 115; software on hub(s) 115; scanning/reading code communication 119; presence-detected (presence-sensed) communication 121; tag(s) 123; computer-server(s) 125; software on computer-server(s) 125; software (mobile-app) saved on mobile-computing-device(s) 129 (but not mobile-computing-device 129 itself); tag(s) 301; the digital/electronic authorization (and/or credential, token, and/or certificate) (generated as a result from a financial transaction between a given mobile-computing-device 129 and a given accommodation premises); combinations thereof; and/or the like. In some embodiments, system 300 may comprise one or more of: POP-device(s) 101; ticket(s)/receipt(s) 103; code(s) 105; electronic-device(s) 107; reader(s)/scanner(s) 107a; status-indicator(s) 107b; presence-detector-device(s) 107c; software on electronic-device(s) 107; table(s) 109; intended occupancy location(s) 111; volume and/or area within boundary/perimeter 113; hub(s) 115; software on hub(s) 115; scanning/reading code communication 119; presence-detected (presence-sensed) communication 121; tag(s) 123; computer-server(s) 125; software on computer-server(s) 125; software (mobile-app) saved on mobile-computing-device(s) 129 (but not mobile-computing-device 129 itself); tag(s) 301; the digital/electronic authorization (and/or credential, token, and/or certificate) (generated as a result from a financial transaction between a given mobile-computing-device 129 and a given accommodation premises); combinations thereof; and/or the like. In some embodiments, system 300 may omit at least one of: POP-device(s) 101 (as a standalone device); ticket(s)/receipt(s) 103; code(s) 105; and/or tag(s) 123. In some embodiments, at least some of FIG. 1A and/or of FIG. 1B may pertain to system 300 and/or to a portion of system 300. In some embodiments, FIG. 1D to FIG. 3 may pertain to system 300 and/or to a portion of system 300.

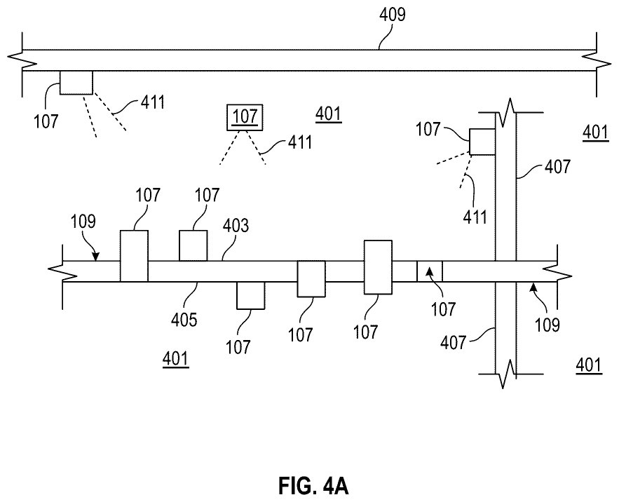

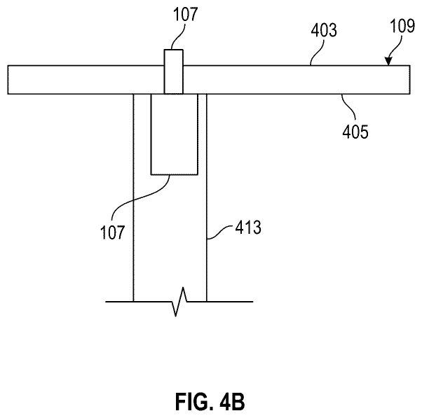

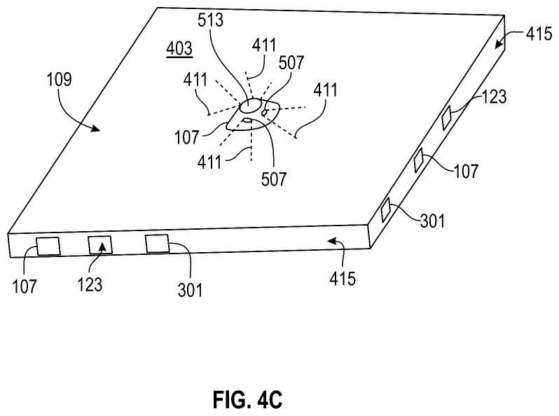

FIG. 4A is a cross-sectional elevational view through a region of a given accommodation premises, wherein the cross-section runs through a tabletop of a given table 109 of that given accommodation premises. FIG. 4A shows (vertical) wall 401 located behind the given table 109. FIG. 4A also shows a portion of a ceiling 409 or a ceiling-beam 409 located above wall 401 and above the given table 401. At least one purpose of FIG. 4A is to show possible locations for electronic-device(s) 107 within/at the given accommodation premises. In some embodiments, a given electronic-device 107 may be located in at least one of the following locations: at least partially embedded within table 109; at least partially embedded within a tabletop table 109; protruding from a top 403 of table 109; on top of top 403 of table 109; on a bottom 405 of the tabletop of table 109; protruding from bottom 405 of the tabletop of table 109; passing entirely through the tabletop of table 109; located within table 109; located within the tabletop of table 109; attached to a (vertical) post/pole 407; attached to wall 401; attached to ceiling/beam 409; combinations thereof; and/or the like. In some embodiments, when a given electronic-device 107 may not be in direct physical contact with at least a portion of table electronic-device 107, then such an electronic-device 107 may be located (positioned, mounted, and/or attached) in such a way that its FOV (field-of-view) 411 is directed at a given (specific) table 109, so that that electronic-device 107 may be associated with that table 109 (in system(s) 100, 200, and/or 300 and/or in method(s) 700, 800, and/or 900). In some embodiments, when a given electronic-device 107 may be in direct physical contact with at least a portion of table 109, then FOV 411 of that electronic-device 107 may be directed at a given seat 111 and/or at some region of that table 109. In some embodiments, wall 401 may be a wall of the given accommodation premises. In some embodiments, top/upper-surface 403 may be a top/upper-surface of a given table 109. In some embodiments, top/upper-surface 403 may be a top/upper-surface of a tabletop of a given table 109. In some embodiments, bottom/lower-surface 405 may be a bottom/lower-surface of a given table 109. In some embodiments, bottom/lower-surface 405 may be a bottom/lower-surface of a tabletop of a given table 109. In some embodiments, table 109 may comprise at least one tabletop. In some embodiments, the tabletop of table 109 may be an at least substantially (mostly) flat planar surface. In some embodiments, the tabletop of table 109 may comprise an at least substantially (mostly) flat planar surface. In some embodiments, the tabletop of table 109 may comprise an at least substantially (mostly) flat planar member. In some embodiments, table 109 may comprise a top/upper-surface 403. In some embodiments, the tabletop of table 109 may comprise a top/upper-surface 403. In some embodiments, table 109 may comprise a bottom/lower-surface 405. In some embodiments, the tabletop of table 109 may comprise a bottom/lower-surface 405. In some embodiments, post/pole 407 may be a post and/or a pole of the given accommodation premises. In some embodiments, post/pole 407 may be a vertical post and/or a vertical pole of the given accommodation premises. In some embodiments, beam/ceiling 409 may be a beam and/or a ceiling of the given accommodation premises. In some embodiments, beam/ceiling 409 may be a horizontal/lateral beam and/or a horizontal/lateral ceiling of the given accommodation premises. In some embodiments, FOV 411 may be a FOV (field-of-view) of a given electronic-device 107. In some embodiments, each electronic-device 107 may comprise at least one FOV 411. In some embodiments, FOV 411 may be a FOV of at least one sensor 507 of a given electronic-device 107. In some embodiments, FOV 411 may be a FOV of at least one camera 507/509 of a given electronic-device 107. In some embodiments, FOV 411 of a given electronic-device 107 may be fixed, finite, non-variable, and/or predetermined. In some embodiments, FOV 411 of a given electronic-device 107 may be variable, adjustable, and/or predetermined.

FIG. 4B is a cross-sectional elevational view through a section of a given table 109 (of a given accommodation premises). FIG. 4B may show a leg 413, or a pedestal 413, or a base 413 that (directly) physically and/or structurally supports a tabletop of table 109. In some embodiments, table 109 of FIG. 4B may be a pedestal table. In some embodiments, leg 413 may be a leg of table 109. In some embodiments, pedestal 413 may be a pedestal of table 109. In some embodiments, base 413 may be a base of table 109. In some embodiments, table 109 may comprise at least one leg 413. In some embodiments, table 109 may comprise at least one pedestal 413. In some embodiments, table 109 may comprise at least one base 413. In some embodiments, member 413 may be an at least substantially (mostly) vertically descending member of table 109. In some embodiments, table 109 may comprise at least one electronic-device 107. In some embodiments, electronic-device 107 may be located at least partially inside of leg/pedestal/base 413. In some embodiments, electronic-device 107 may be at least partially housed inside of leg/pedestal/base 413. In some embodiments, at least a portion of electronic-device 107 may protrude through a top-side 403 of the tabletop of table 109. In some embodiments, at least a portion of electronic-device 107 may pass through a hole in the tabletop of table 109. In some embodiments, at least a portion of electronic-device 107 may pass through a hole in the tabletop of table 109 to protrude through the top-side 403 of the tabletop of table 109. In some embodiments, the tabletop of table 109 may comprise a hole that is configured to have a portion of electronic-device 107 pass therethrough. In some embodiments, the at least a portion of electronic-device 107 that may protrude through the top-side 403 of the tabletop of table 109.may be selected from one or more of: reader/scanner 107a, status-indicator 107b, and/or presence-detector-device(s) 107c.

With respect to FIG. 4B, in some embodiments, a hole may be cut into and/or through a horizontal planar surface member, of a given intended occupancy location 111, such as, but not limited to, a tabletop 109, a countertop, a bar top, and/or the like, and a given indicator light 107b/513 for providing the status of that given intended occupancy location 111, may be externally visible from that hole. See e.g., FIG. 4B. Other electronics of a given electronic-device 107 (besides the indicator light), of the indicator light 107b/513 visible from that hole, may be located below that indicator light 107b/513, within that horizontal planar surface member, below that horizontal planar surface member, combinations thereof, and/or the like. In some embodiments, those other electronics may include the battery (batteries) 515 and/or power source 515 for that given electronic-device 107. In some embodiments, a payment receiver 101 of that given electronic-device 107, may be visible, accessible, and/or usable by a user (e.g., a customer) from that hole for the indicator light 107b/513 or from another (proximate) hole in that same horizontal planar surface. In some embodiments, at least one sensor(s) 507 of that given electronic-device 107, may be visible from that hole for the indicator light 107b/513 or from another (proximate) hole in that same horizontal planar surface member. In some embodiments, top(s) of hole(s) within a given horizontal planar surface member may be covered over by a cover. In some embodiments, that cover may be waterproof and/or water resistant (e.g., to protect the at least mostly below located electronics of that electronic-device 107, including, but not limited to, the indicator light 107b/513, battery 515, power source 515, payment receiver 101, code reader 107a, sensor(s) 507, and/or the like). In some embodiments, that cover may be (substantially) transparent (translucent) with respect to at least some wavelengths of the visible light spectrum of humans. In some embodiments, the cover may be associated with, connected with/to, and/or physically touching a trim member. In some embodiments, at least a portion of the trim member may go around at least some of an outer (outside) perimeter (circumference) of the cover (such as, but not limited to, acting as a bezel). In some embodiments, the trim member may be a holder, because that trim member may hold the electronic device and/or may hold at least some electronics of the electronic device. In some embodiments, the trim member, as a holder, may be configured for securing and/or attaching the electronic device and/or electronics of the electronic device to the given horizontal planar surface member. In some embodiments, tops of objects within the hole(s) of a given horizontal planar surface may be flush, below, or extending above a top surface of that given horizontal planar surface. In some embodiments, those objects may be selected from one or more of: the cover, its trim, an indicator light 107b/513, a payment receiver 101, a sensor 507, combinations thereof, and/or the like, of a given electronic-device 107 associated with that particular horizontal planar surface. In some embodiments, a given indicator light 107b/513 for providing the status of a given intended occupancy location 111, such as, but not limited to, a horizontal planar surface member (such as, but not limited to, a table 109, a section of bar, and/or a section of countertop), may be located on one or more of: on top of, below, beneath, inside of, on a side of, on an exterior side of, on an exterior surface of, a combination thereof, a portion thereof, and/or the like-of that particular horizontal planar surface member. In some embodiments, with respect to a table 109 that is supported by at least one leg 413, including, but not limited to, a pedestal table (wherein the pedestal of the pedestal table may be considered a table leg herein), at least some of the electronic-device 107 and/or at least some electronics of the electronic-device 107 may be located: inside of the at least one leg 413, on an exterior of the at least one leg 413, at least partially within that at least one leg 413, a combination thereof, a portion thereof, and/or the like. In some embodiments, such a table 109 may an example of an intended occupancy location 111 of a given premises of a given accommodation. In some embodiments, such electronics of the electronic-device 107 may include a vertical power pack 515. See e.g., FIG. 4B (and/or FIG. 2 from U.S. Provisional Patent Application Ser. No. 63/784,788). In some embodiments, a vertical power pack 515, of the electronic-device 107, may be power pack (e.g., at least one battery and/or power source) that when installed is generally in a mostly vertical orientation (e.g., at least mostly parallel with at least one leg of a given table). For example, and without limiting the scope of the present invention, a vertical power pack 515, of the electronic-device 107, may be installed inside or outside (or a combination thereof) of the table's 109 pedestal and/or of the table's 109 at least one leg 413. For example, and without limiting the scope of the present invention, a vertical power pack 515, of the electronic-device 107, may be installed on any at least mostly vertical leg 413 of a given table 109. In some embodiments, a given at least one indicator light 107b/513 of a given electronic-device 107 may be integral or non-integral to that electronic-device 107. In some embodiments, a given at least one indicator light 107b/513 of a given electronic-device 107 may be installed on/to an overall and/or a singular housing for that electronic-device 107. In some embodiments, in a non-integral configuration for the at least one indicator light 107b/513, that at least one indicator light 107b/513 may be wired to at least some other electronics of that electronic-device 107. In some embodiments, in a non-integral configuration for the at least one indicator light 107b/513, that at least one indicator light 107b/513 may not be located within a housing 517 of at least some other electronics of that electronic-device 107. In some embodiments, a battery pack 515 (at least one battery and/or power), of a given electronic-device 107 may be charged (and/or recharged) within the given unit (electronic device), like a cell phone; and/or the battery pack 515 (or a portion thereof) may be removed and charged (and/or recharged). In some embodiments, the electronic-device 107 (and/or its electronics) may be configured to receive and use externally provided electrical power, such as, but not limited, to a building's or a grid's electrical power source. In some embodiments, the electronic-device 107 (and/or its electronics) may be configured to receive and use externally provided electrical power, such as, but not limited to, being connected to a continuous AC or DC power source. Note, the electronic-device 107 may be configured to use both a battery (power) pack and an external power source (e.g., as a laptop or smartphone can). In some embodiments, at and/or within the premises of a given accommodation may be located at least one mother unit 115 (or master unit 115 or master control unit 115) (e.g., referred to as a main control tower in FIG. 2 of U.S. Provisional Patent Application Ser. No. 63/784,788). In some embodiments, the at least one master unit 115 may be a computing device 500 and/or a device with various hardware and/or electronics. In some embodiments, at least one indicator light 107b/513 and/or at least one electronic-device 107 (with at least one indicator light 107b/513) may be in communication with the at least one master unit 115. In some embodiments, this communication may be wireless (or wired). In some embodiments, the at least one master unit 115 may comprise at least one of: a payment receiver 101; a processor 501; storage 505 and/or memory 503 for storing operating software/firmware and/or sensor's data (from electronic device's sensor(s)); a power source 515 (and/or a means for accepting power); a display (screen) 509; and a wireless communication means 511 (e.g., radio, receiver, transceiver, and/or antenna). In some embodiments, the at least one master unit 115 may act as hot spot, a network hub, a network switch, a network gateway, and/or the like; at least with respect to electronic-devices 107 with indicator lights 107b/513 of that specific premises. In some embodiments, the at least one master unit 115 may receive communications from the electronic-devices 107 and/or from the indicator lights 107b/513. In some embodiments, the at least one master unit 115 may send (transmit) communications from the electronic-devices 107 and/or from the indicator lights 107b/513. In some embodiments, the at least one master unit 115 may control the electronic-devices 107 and/or the indicator lights 107b/513. In some embodiments, the at least one master unit 115 may control what light color(s) are displayed by the indicator lights 107b/513. In some embodiments, the at least one master unit 115 may receive and/or analyze sensor's reading(s) (data) from the sensor(s) 507 of the electronic-device 107. In some embodiments, the at least one master unit 115 may determine status of a given intended occupancy location 111 being monitored (by sensor(s) 507 of the electronic-devices 107). In some embodiments, the at least one master unit 115 may determine proximity of person(s), occupancy, and/or vacancy status of a given intended occupancy location 111 being monitored (by sensor(s) of the electronic-devices 107). In some embodiments, the at least one master unit 115 may determine, generate, manage, cancel, delete, and/or control occupancy-codes. In some embodiments, the at least one master unit 115 may process payments from customers of the given accommodation. In some embodiments, the at least one master unit 115 may in communication with a computer-server 125. In some embodiments, the computer-server 125 may be onsite or offsite with respect to the premises of the given accommodation.

FIG. 4C is top-down perspective view of a given tabletop of a given table 109. FIG. 4C may show at least a portion of at least one electronic-device 107 being located on top-surface 403 of that tabletop. FIG. 4C may further show that electronic-device 107 having four separate and distinct FOVs 411, with each such FOV 411 being directed towards (at) a different portion of table 109 and/or in a direction of a different seat 111 of that table 109. In some embodiments, each such FOV 411 may be emanating from a separate sensor 507 of that electronic-device 107. In some embodiments, electronic-device 107 may comprise one or more sensors 507. In some embodiments, a sensor 507 of electronic-device 107 may have an associated FOV 411. FIG. 4C also shows at least one status indicator light 509 may located on electronic-device 107. In some embodiments, electronic-device 107 may comprise at least one status indicator light 509.

FIG. 4C may also show at least some of an outside external edge/surface 415 of the tabletop of table 109. In some embodiments, the outside external edge/surface 415 may be an outside external edge/surface of the tabletop of table 109 that runs around an external/outside perimeter of the tabletop. In some embodiments, the outside external edge/surface 415 may also be referred to as perimeter surface 415. In some embodiments, table 109 may comprise at least one perimeter surface 415. In some embodiments, the tabletop of table 109 comprise at least one perimeter surface 415. In some embodiments, table 109 may comprise at least one: electronic-device 107; tag 123; and/or tag 301. In some embodiments, the tabletop of table 109 may comprise at least one: electronic-device 107; tag 123; and/or tag 301. In some embodiments, the perimeter surface 415 of the tabletop of table 109 may comprise at least one: electronic-device 107; tag 123; and/or tag 301. In some embodiments, at least one electronic-device 107 may be at least partially located on perimeter surface 415. In some embodiments, at least one electronic-device 107 may be at least directly partially accessible from perimeter surface 415. In some embodiments, at least one tag 123 may be at least partially located on perimeter surface 415. In some embodiments, at least one tag 123 may be at least directly partially accessible from perimeter surface 415. In some embodiments, at least one tag 301 may be at least partially located on perimeter surface 415. In some embodiments, at least one tag 301 may be at least directly partially accessible from perimeter surface 415.

FIG. 4A, FIG. 4B, and/or FIG. 4C may be applicable to system 100, a portion of system 100, system 200, a portion of system 200, system 300, and/or a portion of system 300.

FIG. 5 may depict a block diagram showing at least some electronics and/or electronic hardware elements of a given computing-device 500. In some embodiments, computing-device 500 may be a computer. In some embodiments, computing-device 500 may be a computing device. In some embodiments, one or more computing-devices 500 may be used to (configured for) operate, monitor, control, manage, and/or the like the electronic components of at least one of: electronic-device 107, hub 115, and/or computer-server 125. In some embodiments, computing-device 500 may be selected from at least one: electronic-device 107, code-reader/scanner 107a, occupancy-status-indicator-device 107b, presence-detector-device(s) 107c, hub 115, and/or computer-server 125, and/or mobile-computing-device 129. In some embodiments, electronic-device 107 may be a computing-device 500. In some embodiments, at least some of the electronics of electronic-device 107 may be described by computing-device 500. In some embodiments, hub 115 may be a computing-device 500. In some embodiments, at least some of the electronics of hub 115 may be described by computing-device 500. In some embodiments, computer-server 125 may be a computing-device 500. In some embodiments, at least some of the electronics of computer-server 125 may be described by computing-device 500.

Continuing discussing FIG. 5, in some embodiments, computing-device 500 may comprise one or more circuits. In some embodiments, computing-device 500 may comprise a printed circuit board (PCB) or may comprise one or more such PCBs. In some embodiments, the electronics and/or electronic hardware of computing-device 500 may be implemented via one or more PCBs. In some embodiments, computing-device 500 may comprise at least one of the following sub-hardware elements (components): one or more processors 501, one or more memory 503, one or more storage 505, one or more sensor(s) 507, I/O means 509, one or more communications 511 (for external communications), one or more status indicator(s) 513, power source 515, combinations thereof, and/or the like. “I/O” herein may refer to “inputs and/or outputs” as is commonly known in the computing and/or electronics industries. In some embodiments, the one or more processors 501 may be electrically and/or optically coupled (e.g., via wiring, cabling, bus, and/or the like) with at least one of: one or more memory 503, one or more storage 505, one or more sensors 507, I/O means 509, one or more communications 511 (for external communications), one or more status indicator(s) 513, power source 515, combinations thereof, and/or the like. In some embodiments, at least some of one or more processors 501 may be electrically and/or optically coupled (e.g., via wiring, cabling, bus, and/or the like) with at least one of: one or more memory 503, one or more storage 505, one or more sensors 507, I/O means 509, one or more communications 511 (for external communications), one or more status indicator(s) 513, power source 515, combinations thereof, and/or the like may be operationally linked with one another, such as via electrical (and/or optical) wired connections. In some embodiments, processor(s) 501, memory 503, storage 505, sensor(s) 507, I/O means 509, communications 511, status indicator(s) 513, power source 515, daughter board(s) (if any), a portion thereof, combinations thereof, and/or the like of computing-device 500 may be implemented via one or more PCBs, circuits, discrete electronic hardware device(s), and/or the like.

In FIG. 5, processor 501 may be one or more processors, including one or more central processors (CPU) and/or one or more processors for graphics (GPU) and/or one or more processors used in an AI (artificial intelligence) (and/or ML [machine learning]) device. In some embodiments, processor 501 may be in operative communication with one or more memory 503 and/or with one or more storage 505. In some embodiments, processor 501 may be in operative communication with one or more sensors 507. In some embodiments, processor 501 may be in operative communication with I/O Means 509. In some embodiments, processor 501 may be in operative communication with communications 511. In some embodiments, processor 501 may be in operative communication with status indicator(s) 513. In some embodiments, processor 501 may be in operative communication with power source(s) 515. In some embodiments, such communications may be facilitated via wired connections for electrical (and/or optical) communications. In some embodiments, processor 501 may receive electrical power necessary for operations from power source(s) 515.

Continuing discussing FIG. 5, in some embodiments, processor(s) 501 may execute a computer program known as an operating system (such as, but not limited to, device firmware, a Linux operating system, a UNIX operating system, an Android operating system, a Microsoft Windows operating system, an Apple and/or Macintosh operating system, a mobile computing device operating system, an internet of things (IOT) operating system, any other suitable operating system, a portion thereof, combinations thereof, and/or the like) which may control the execution of other computer programs (e.g., application programs,); and may provide for scheduling, input/output (I/O) and other hardware device control, accounting, compilation, storage assignment, data management, memory management, communication, data analysis, photo analysis, video analysis, and/or dataflow control. Collectively, processor(s) 501 and its operating system (firmware) may define a computer platform for which the application programs and other computer program languages may be written in and/or programmed to operate in. In some embodiments, processor(s) 501 may also execute one or more computer programs to implement various functions and/or methods of the present invention, such as, but not limited to, method(s) 700, 800, and/or 900 and/or any of their steps. These computer programs may be written in any type of computer program language, including, but not limited to, a procedural programming language, object-oriented programming language, macro language, script language, combinations thereof, and/or the like.

These computer programs, including the operating system (firmware) and/or application programs, may be stored (e.g., non-transitorily stored) in storage(s) 505 and/or called up for active use in memory 503. Memory 503 and/or storage 505 (memory 503/storage 505) may store (hold) information on a volatile or non-volatile medium, and may be fixed and/or removable. Memory 503/storage 505 may include (comprise) a tangible computer readable and computer writable non-volatile recording medium, on which signals are (non-transitorily) stored that define a computer program or information to be used by the computer program. The recording medium (memory 503/storage 505) may, for example, be disk memory, flash memory, flash memory card, micro-SD card, SD card storage, and/or any other article(s) of manufacture usable to record and/or store information (and in a non-transitory fashion for at least some embodiments). In some embodiments, in operation, processor(s) 501 may cause(s) data to be read from the nonvolatile recording medium (e.g., storage(s) 505) into a volatile memory (e.g., a random access memory, or RAM) (e.g., memory 503) that may allow for more efficient (i.e., faster) access to the information by the processor(S) 501 as compared against the nonvolatile recording medium. Such RAM memory may be located in/on the memory 503 and/or in/on processor(s) 501 themselves. See e.g., FIG. 5. The processor(s) 501 may manipulate(s) the data within integrated circuit memory 503 and may then copy the data to the nonvolatile recording medium 505 after processing may be completed. A variety of mechanisms are well known for managing data movement between the nonvolatile recording medium 505 and the integrated circuit memory element(s) 503, and embodiments of the present invention are not necessarily limited to any one mechanism, whether now known or later developed. The invention is also not limited to a particular processing unit (e.g., processor(s) 501) or storage unit 505.

Note, each and every method (such as, but not limited to, method 700, 800, and/or 800) and/or step discussed herein (or a portion thereof) and/or as depicted in the accompanying figures may be implemented as non-transitory computer-readable medium including software code executable by a processor, such as processor(s) 501. That is, such non-transitory computer-readable medium may be the one or more memory 503/storage 505 storage units. That is, such a processor may be processor(s) 501; or alternatively, processor(s) 501 may comprise such a processor.

In some embodiments, computing-device 500 may be mobile-computing-device 129. In some embodiments, mobile-computing-device 129 may be a computing-device 500. In some embodiments, at least some of the electronics of mobile-computing-device 129 may be described by computing-device 500. In some embodiments, software (mobile-app) non-transitorily stored in storage of mobile-computing-device 129 and executable on processor(s) of mobile-computing-device 129, may implement a method 700, 800, and/or 800 and/or a step of such method. In some embodiments, the software (mobile-app) may be implemented as non-transitory computer-readable medium including software code executable by a processor, such as processor(s) 501 of mobile-computing-device 129.

The program application software (such as, but not limited to, method 700, 800, and/or 800 and/or any of their steps) of computing-device 500 may be non-transitorily stored in storage 505. In some embodiments, the software may be distributed across several and different storages 505's of a single computing-device 500. In some embodiments, at least some portions of this software may be non-transitorily stored in storage(s) 505 of computing-device 500.

In some embodiments, new and/or updates to codes, programs, software applications, operating system, program application software, firmware, scripts, and/or the like may be saved non-transitorily onto storage 505 using I/O means 509 and/or using communications 511.

Continuing discussing FIG. 5, in some embodiments, processor(s) 501 may also be in operative communication with communications means 511 (communications 511). In some embodiments, processor(s) 501 may control communications 511, depending upon the instructions that processor(s) 501 may be processing/executing. In some embodiments, communications 511 may permit external communications between a given computing-device 500 and other computing devices that may be external and/or separate from the given computing-device 500, such as, but not limited to, a person's smartphone, laptop, and/or the like; or a (remote or onsite located) server; or a hub. In some embodiments, communications 511 may permit communication between a given computing-device 500 and other computing devices that are not part of that given computing-device 500; and/or that may not be under the control of a given computing-device 500. In some embodiments, communications 511 may permit communication between a given computing-device 500 and another different computing-device 500.

Continuing discussing FIG. 5, in some embodiments, the one or more sensors 507 (of a given computing-device 500) may be used to monitor, detect, and/or sense at least one of the following: for person 117 presence (at a given table and/or at a given seat 111); for wireless NFC, RFID, and/or UWB communications from mobile-computing-device(s) 129; for (wireless) communications from hub(s) 115; for (wireless) communications from computer-server(s) 125; the immediate environment in which computing-device 500 may be located; and/or various conditions of computing-device 500. In some embodiments, the one or more sensors 507 may be one or more of: a person 117 presence sensor; a person 117 presence detector; a person presence sensor; a person presence detector; mmWave radar (millimeter-wave radar); mmWave emitter; mmWave receiver; a motion detector; a motion sensor; a motion detection sensor; a PIR (passive infrared) sensor; an ultrasonic sensor; an ultrasound sensor; an ultrasonic transducer; an ultrasound transducer; an ultrasound horn; a camera; a thermal sensor; a heat sensor; a body heat sensor; LiDAR (light detection and ranging); a microphone; a pressure sensor; a weight sensor; an acceleration sensor (e.g., accelerometer); an inertial sensor; a positional sensor; an orientation sensor; a gyroscope; a vibration sensor; a touch sensor; a voltage sensor; a current sensor; a change in resistance sensor; a change in capacitance sensor; a change in magnetic field sensor; a temperature sensor; a humidity sensor; a sound sensor (e.g., one or more microphones); a chemical sensor (e.g., to detect odors and/or chemicals); a particulate sensor; a light sensor (darkness sensor); a light level sensor; a location sensor (e.g., a GPS module and/or chip); a camera coupled to at least one sensor; combinations thereof; and/or the like. In some embodiments, at least one sensor 507 (of a given computing-device 500) may generate (output) sensor reading(s) and/or sensor data. In some embodiments, such generated sensor reading(s) and/or sensor data may be non-transitorily stored in storage 505 and called up into memory 503 for interaction and/or processing by processor(s) 501 per software (that may also be non-transitorily stored in storage 505 and called up into memory 503 for interaction and/or processing by processor(s) 501). In some embodiments, the software running (executing) on computing-device 500, electronic-device 107, hub 115, and/or computer-server 125 (and/or mobile-computing-device 129) may be configured to perform analytics and/or data analysis of the sensor(s) 507 reading(s)/data. In some embodiments, that analytics and/or data analysis of the sensor(s) 507 reading(s)/data may be run through at least one AI (artificial intelligence) algorithm and/or AI platform. In some embodiments, that analytics and/or data analysis of the sensor(s) 507 reading(s)/data may be run through at least one ML (machine learning) algorithm and/or ML platform. In some embodiments, the AI algorithm, AI platform, ML algorithm, and/or ML platform may be running (executing) on computing-device 500, electronic-device 107, hub 115, and/or computer-server 125 (and/or mobile-computing-device 129). In some embodiments, the AI algorithm, AI platform, ML algorithm, and/or ML platform may be non-transitorily stored in storage 505 on computing-device 500, electronic-device 107, hub 115, and/or computer-server 125 (and/or mobile-computing-device 129). In some embodiments, the AI algorithm, AI platform, ML algorithm, ML platform, analytics, and/or data analysis of the of the sensor(s) 507 reading(s)/data may be configured for at least one of: photo analytics; image analytics; video analytics; time of flight (ToF) analysis; sound recognition; body heat recognition; person 117 detection; person 117 presence detection; person 117 identification; awareness of person 117 presence; distinguishing between person 117 presence and non-presence; combinations thereof; and/or the like. In some embodiments, sensor 507 reading(s)/data may include time and date information (i.e., a timestamp) of when each given sensor 507 reading(s) was taken/generated. In some embodiments, this timestamp data may be communicated along with the sensor 507 readings data itself.

Continuing discussing FIG. 5, in some embodiments, the inputs of I/O means 509 of a given computing-device 500 may be selected from at least one of the following inputs: inputs from a keypad; inputs from a touchscreen of computing-device 500; inputs from buttons of computing-device 500; inputs from switches of computing-device 500; inputs from keyboard of computing-device 500; inputs from stylus of computing-device 500; inputs from mouse of computing-device 500; inputs from trackball of computing-device 500; inputs from touchpad of computing-device 500; inputs from lever of computing-device 500; inputs from slide of computing-device 500; inputs from dials of computing-device 500; inputs from camera(s) of computing-device 500; inputs from sensor(s) of computing-device 500; inputs from presence detectors of computing-device 500; inputs from proximity detectors of computing-device 500 (e.g., RFID/NFC/BT reader/receiver/scanner); inputs from hardwired electrical power ports (e.g., a USB port or the like) of computing-device 500; NFC and/or RFID and/or UBW reader(s); NFC and/or RFID and/or UBW scanner(s); NFC and/or RFID and/or UBW interrogator(s); inputs from hardwired data ports (e.g., a USB port or the like) of computing-device 500; incoming communications received via communications 511 of computing-device 500; inputs from microphones of computing-device 500; inputs from a fingerprint-scanner or detector; combinations thereof; and/or the like. In some embodiments, I/O means 509 may comprise a GPS chip set or a GPS-module and/or the like for determining a position (or a location) of computing-device 500. In some embodiments, a camera of device 500, as an example of a given I/O means 509, may have its own microphone(s).

Continuing discussing FIG. 5, in some embodiments, the outputs of I/O means 509 may be selected from at least one of the following outputs: computing-device 500 external facing light(s); status indicator(s) 513 (which may or may not be in light form); light(s) 513; information/content displayed on a monitor, screen, a touchscreen, and/or a display of computing-device 500; a monitor, screen, a touchscreen, and/or a display of computing-device 500; a monitor, screen, a touchscreen, and/or a display in communication with computing-device 500; readouts of computing-device 500; speakers of computing-device 500; buzzers, sirens, and/or horns of computing-device 500; bells of computing-device 500; whistles of computing-device 500; lights (LEDs [light emitting diodes]) of computing-device 500 (such as, but not limited to, indicator lighting, status indicator lighting, occupancy status indicator lighting, alarm lighting, strobe lighting); alarms of computing-device 500; scanners of and/or in communication with computing-device 500; printers of and/or in communication with computing-device 500; outgoing information transmitted via the hardwired port (e.g., a USB port or the like) of computing-device 500; outgoing information transmitted via communications 511; port(s); jack(s); combinations thereof; and/or the like.

Continuing discussing FIG. 5, in some embodiments, communications 511 may comprise one or more radios and/or one or more antennas to facilitate wireless communications, such as, but not limited to, short range wireless communications, LP WAN, LoRa, SigFox, WiFi (Wi-Fi), Bluethooth (BT), 802.15, BLE Mesh, ISM radio, ZigBee, cellular, RFID (radio frequency identification), NFC (near field communication), UWB (ultra wide band), a predetermined wireless communication protocol, a low power wireless communications, a higher power wireless communication protocol, a longer range wireless communication protocol, combinations thereof, and/or the like. In some embodiments, communications 511 may comprise at least one Bluetooth chipset and/or the like. In some embodiments, communications 511 may comprise a network card and/or a network adapter. In some embodiments, communications 511 may be a network card and/or a network adapter. In some embodiments, communications 511 may be in wired and/or wireless communications with the Internet, WAN (wide area network), LAN (local area network), a computing network, a cellular network, a network, network 127, a portion thereof, combinations thereof, and/or the like. In some embodiments, communications between a given computing-device 500 that may use communications 511 and one or more of: another different computing-device 500 and/or some other computing device-may be routed, at least partially, through such a network. In some embodiments, communications between a given computing-device 500 that may use communications 511 and one or more of: another different computing-device 500 and/or some other computing device may be direct communications (device-to-device) and not utilize such a network. In some embodiments, communications 511 may provide for wired, non-wired, and/or wireless communications to and from a given computing-device 500.

Continuing discussing FIG. 5, in some embodiments, communications 511 may comprise one or more radios and/or antennas. In some embodiments, one or more radios and/or antennas, of communications 511, may be used for (may be configured for) communications between computing-device 500 and at least one of: another different computing-device 500; another different electronic-device 107; some other computing device; hub(s) 115; computer-server(s) 125; network 127; mobile-computing-device(s) 129; combinations thereof; and/or the like.

Continuing discussing FIG. 5, in some embodiments, status indicator(s) 513 of a given computing-device 500 may be selected from at least one of: a light; external facing light(s); a light configured to emit light of at least one color in the visible spectrum; a light configured to emit light of a plurality of different colors in the visible spectrum; a plurality of lights; a speaker (configured for emitting sound); content configured to be displayed upon a screen (monitor or display) of a given computing-device 500; content configured to be displayed upon a screen (monitor or display) of a given electronic-device 107; content configured to be displayed upon a screen (monitor or display) of a given hub 115; content configured to be displayed upon a screen (monitor or display) of a given computer-server 125; content configured to be displayed upon a screen (monitor or display) of a given mobile-computing-device 129; combinations thereof; and/or the like. In some embodiments, the status indicator(s) 513 may be configured to convey a particular status (at any given moment in time) of computing-device 500 and/or of a given electronic-device 107. In some embodiments, the status indicator(s) 513 may be configured to convey a particular status (at any given moment in time) of computing-device 500 and/or of a given electronic-device 107; wherein that particular status may be with respect to current person 117 occupancy of a given table 109 and/or of a given seat 111. In some embodiments, the status indicator(s) 513 may be configured to convey a particular status (at any given moment in time) of computing-device 500 and/or of a given electronic-device 107; wherein that particular status may be with respect to current payment status for occupancy of a given table 109 and/or of a given seat 111. In some embodiments, the status indicator(s) 513 may be configured to convey a particular status (at any given moment in time) of computing-device 500 and/or of a given electronic-device 107; wherein that particular status may be with respect to current person 117 occupancy of a given table 109 and/or of a given seat 111 and with respect to payment status for occupancy of a given table 109 and/or of a given seat 111. In some embodiments, the status indicator(s) 513 may be a type of output from I/O means 509. In some embodiments, I/O means 509 may comprise status indicator(s) 513. In some embodiments, in particular accommodation premises that do not want to publicly visually display status indicator(s) 513 as publicly visible lights and/or publicly audible sounds (such as, but not limited to, in a fine dining establishment that may not wish to publicly display status indicator(s) 513 for aesthetic and/or reputational purposes), then the informational content of status indicator(s) 513 may be pushed (sent) to mobile-computing-device(s) 129 for display upon their screens for private viewing of the status indicator(s) 513 on those screens.

Continuing discussing FIG. 5, in some embodiments, power source(s) 515 may provide and/or distribute electrical power to the main sub-hardware elements and/or electronics of computing-device 500. In some embodiments, power source(s) 515 may provide and/or distribute electrical power to the main sub-hardware elements and/or electronics of computing-device 500 such as, but not limited to, at least one of: processor(s) 501, memory 503, storage(s) 505, sensor(s) 507, I/O means 509, communications 511, status indicator(s) 513, a portion thereof, combinations thereof, and/or the like. In some embodiments, power source 515 may be one or more batteries, capacitors, fuel cells, combinations thereof, and/or the like. In some embodiments, power source 515 may be one or more rechargeable batteries. In some embodiments, power source 515 may be one or more backup batteries. In some embodiments, power source 515 may be in electrical communication with one more renewable or energy harvesting sources, such as, but not limited to solar power generators, wind power generator, and/or the like. In some embodiments, power source 515 may provide sufficient electrical power to a given computing-device 500 for normal operations. In some embodiments, power source 515 may be one or more AC/DC adapters or electrical power conditioners allowing computing-device 500 to receive standardized AC (alternating current) electrical power from a wired power source, such as, but not limited to an electrical wall outlet/receptacle of a building (e.g., that may have grid source provided power or the like).

The main sub-hardware elements of a given computing-device 500, such as, but not limited to, processor(s) 501, memory 503, storage(s) 505, sensor(s) 507, I/O means 509, communication(s) means 511, status indicator(s) 513, and/or power source(s) 515, including their workings and configurations, are well known in the relevant computing and/or electronics industries and such information is incorporated herein by reference.

Continuing discussing FIG. 5, in some embodiments, a given computing-device 500 may comprise at least one housing/enclosure 517. In some embodiments, housing/enclosure 517 may be configured to function and/or operate as a housing and/or as an enclosure. In some embodiments, housing/enclosure 517 may be configured to house and/or enclose at least some of the main sub-hardware elements of a given computing-device 500, such as, but not limited to, at least one of: processor(s) 501, memory 503, storage(s) 505, sensor(s) 507, I/O means 509, communication(s) means 511, status indicator(s) 513, and/or power source(s) 515, a portion thereof, combinations thereof, and/or the like. In some embodiments, housing/enclosure 517 may be configured to at least partially house and/or enclose at least some of the main sub-hardware elements of a given computing-device 500, such as, but not limited to, at least one of: processor(s) 501, memory 503, storage(s) 505, sensor(s) 507, I/O means 509, communication(s) means 511, status indicator(s) 513, and/or power source(s) 515, a portion thereof, combinations thereof, and/or the like. In some embodiments, housing/enclosure 517 may be configured to fully house and/or enclose at least some of the main sub-hardware elements of a given computing-device 500, such as, but not limited to, at least one of: processor(s) 501, memory 503, storage(s) 505, sensor(s) 507, I/O means 509, communication(s) means 511, status indicator(s) 513, and/or power source(s) 515, a portion thereof, combinations thereof, and/or the like. In some embodiments, at least some of the main sub-hardware elements of a given computing-device 500 may be protrude from an exterior of housing/enclosure 517 such as, but not limited to, at least one of: storage(s) 505, sensor(s) 507, I/O means 509, communication(s) means 511, status indicator(s) 513, and/or power source(s) 515, a portion thereof, combinations thereof, and/or the like. In some embodiments, at least some of the main sub-hardware elements of a given computing-device 500 may be accessible from an exterior of housing/enclosure 517 such as, but not limited to, at least one of: storage(s) 505, sensor(s) 507, I/O means 509, communication(s) means 511, status indicator(s) 513, and/or power source(s) 515, a portion thereof, combinations thereof, and/or the like. In some embodiments, housing/enclosure 517 may be NEMA, UL, and NEC rated and/or in compliance therewith.

Continuing discussing FIG. 5, in some embodiments, at least two of the main sub-hardware elements of a given computing-device 500, such as, but not limited to: processor(s) 501, memory 503, storage(s) 505, sensor(s) 507, I/O means 509, communication(s) means 511, status indicator(s) 513, and/or power source(s) 515, a portion thereof, combinations thereof, and/or the like, may be operatively linked to each other via pathway(s) 519 to permit flow, sending, receiving, and/or exchange of: electricity, power, data, information, and/or the like. In some embodiments, pathway(s) 519 may be electrical wire(s) and/or optical fiber(s). In some embodiments, pathway(s) 519 may be organized as a bus or the like. In some embodiments, pathway(s) 519 may be configured as a bus or the like.

FIG. 5 may be applicable to system 100, a portion of system 100, system 200, a portion of system 200, system 300, and/or a portion of system 300.

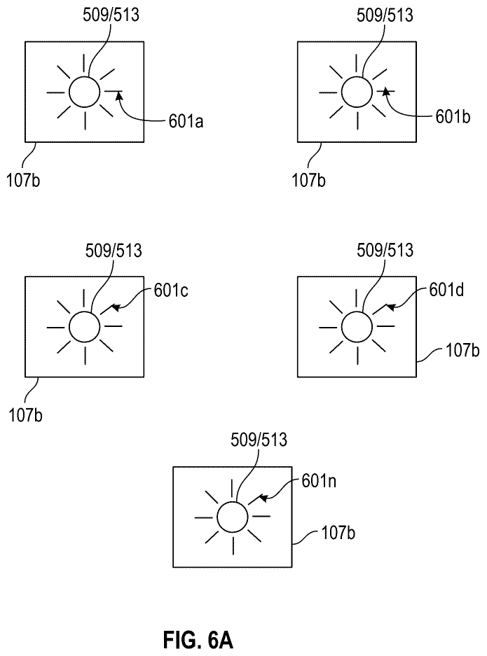

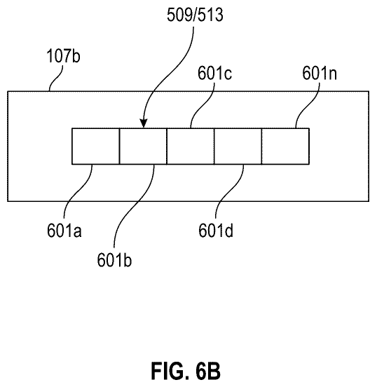

FIG. 6A is a block diagram showing a same status-indicator-device 107b (or a portion thereof) but at in at least five different moments in time and/or in at least five different statuses. In some embodiments, in/at a first moment in time (or in a first status), a status indicator 513 of the given status-indicator 107b may emit light of a first-color 601a to indicate a first status of at least one of: at least one seat 111 or at least one table 109. In some embodiments, in/at a second moment in time (or in a second status), a status indicator 513 of the given status-indicator 107b may emit light of a second-color 601b to indicate a second status of at least one of: at least one seat 111 or at least one table 109. In some embodiments, in/at a third moment in time (or in a third status), a status indicator 513 of the given status-indicator 107b may emit light of a third-color 601c to indicate a third status of at least one of: at least one seat 111 or at least one table 109. In some embodiments, in/at a fourth moment in time (or in a fourth status), a status indicator 513 of the given status-indicator 107b may emit light of a fourth-color 601d to indicate a fourth status of at least one of: at least one seat 111 or at least one table 109. In some embodiments, in/at a fifth or n^{th} moment in time (or in a fifth or n^{th} status), a status indicator 513 of the given status-indicator 107b may emit light of a n^{th}-color 601n to indicate an n^{th} status of at least one of: at least one seat 111 or at least one table 109. In some embodiments, there may be a finite whole number quantity of statuses between the fourth status and the n^{th} status. In some embodiments, there may be a finite whole number quantity of (different) light colors between the fourth-color 601d and the n^{th}-light 601n color. These statuses of the at least one of: at least one seat 111 or at least one table 109, may be with respect to person 117 occupancy and/or whether or not such occupancy has been paid for. In some embodiments, the first status and/or the first-light 601a may indicate that a given table 109 and/or a given seat 111 is vacant and ready for occupancy. In some embodiments, the second status and/or the second-light 601b may indicate that a given table 109 and/or a given seat 111 is properly occupied and with occupancy presently (currently) paid for. In some embodiments, the third status and/or the third-light 601c may indicate that a given table 109 and/or a given seat 111 is improperly occupied because that current occupancy has not been appropriately paid for. In some embodiments, the fourth status and/or the fourth-light 601c may indicate that a given table 109 and/or a given seat 111 is properly occupied and paid for, but that its duration of paid for occupancy is nearing its termination (end). In some embodiments, another status and/or an n^{th}-light 601n may indicate that a given table 109 and/or a given seat 111 and/or its electronics is in need of maintenance and/or cleaning and should not be occupied. In some embodiments, other statuses may be assigned to other light-colors 601 of a given status indicator 513. Note, the above noted assignments of specific status to a given colored light 601 of status indicator 513 was arbitrary and merely for example; i.e., those assignments may be changed and still be well within the scope of the present invention.

In some embodiments, when the light(s) 601 of status indicator(s) 513 are publicly visible within a given accommodation premises (such as, but not limited to, a coffee shop) (e.g., when the status-indicator(s) 107b are mounted/located in a non-hidden manner), anyone (whether staff, customer, patron, the public, etc.) in that given accommodation premises may look at any such publicly visible status indicator 513 and immediately know the status of an associated table 109 and/or seat 111 (if that person knows what the colors 601 mean).

Whereas, in some embodiments, when the light(s) 601 of status indicator(s) 513 are not publicly visible within a given accommodation premises (such as, but not limited to, a fine dining restaurant) (e.g., when there may be no status-indicator(s) 107b mounted/located in public areas), then only certain person(s) may be able access the light(s) 601 of status indicator(s) 513 because the light(s) 601 of status indicator(s) 513 may be configured for display on a person's mobile-computing-device 129, such that only staff (via their mobile-computing-devices 129) have full access to all of the status indicator(s) 513 of that given accommodation premises (by looking at their screens of their mobile-computing-devices 129); and/or public users with mobile apps (on their mobile-computing-devices 129) may have access to at least some of the status indicator(s) 513 of that given accommodation premises (by looking at their screens of their mobile-computing-devices 129).

Continuing discussing FIG. 6A, in some embodiments, first-color-light 601a, second-color-light 601b, third-color-light 601c, fourth-color-light 601d, and n^{th}-color-light 601n may all be different colors from each other. In some embodiments, first-color-light 601a, second-color-light 601b, third-color-light 601c, fourth-color-light 601d, and n^{th}-color-light 601n may all be different colors from each other in the visible light spectrum. In some embodiments, a given status indicator 513 may be configured to emit light of a plurality of different colors. In some embodiments, a given status indicator 513 may be configured to emit light of a plurality of different colors, all in the visible light spectrum. In some embodiments, a given status indicator 513 may be one or more LEDs (light emitting diodes) that may be configured to emit light of a plurality of different colors. In some embodiments, a given status indicator 513 may be one or more LEDs (light emitting diodes) that may be configured to emit light of a plurality of different colors, all in the visible light spectrum. In some embodiments, a given status-indicator 107b may comprise at least one status indicator 513. In some embodiments, at least one of the light-colors 601 may be in a color that is not within the visible light spectrum (for humans). In some embodiments, at least one of the light-colors 601 may be in a color that is visible to a machine, apparatus, device, electronic-device, and/or the like. In some embodiments, at least one of the light-colors 601 may be in a color that is not within the visible light spectrum (for humans), such as, but not limited to, infrared and/or ultraviolet.

FIG. 6B is a block diagram showing a same status-indicator-device 107b (or a portion thereof) that may comprise at least one status indicator 513. In some embodiments, status indicator 513 may comprise a plurality of separate and distinct lights (light sources) (such as, but not limited to, LEDs), wherein each such separate and distinct light (light source) may be configured to emit light of a different color, such as, but not limited to: first-color-light 601a, second-color-light 601b, third-color-light 601c, fourth-color-light 601d, and nth-color-light 601n. In some embodiments, the emitted colored light may be within and/or of the visible spectrum (for humans) and/or from outside of that visible spectrum.

FIG. 6A, and/or FIG. 6B may be applicable to system 100, a portion of system 100, system 200, a portion of system 200, system 300, and/or a portion of system 300.

In some embodiments, an indicator light 107b/513 (or lights 107b/513) may be attached to and/or associated with each particular intended occupancy location 111 of the given accommodation (e.g., such as, but not limited to, at least one indicator light 107b/513 associated with each table 109, of that premises, of that given accommodation). In some embodiments, this indicator light 107b/513 may be configured to emit light of different colors to signal (communicate) to observers, of that indicator light 107b/513, of different occupancy statuses of its particular intended occupancy location 111. For example, and without limiting the scope of the represent invention, a green light could indicate that the associated intended occupancy location 111 is currently appropriately (properly) occupied (and paid for); an amber (yellow and/or orange) light could indicate that the current occupants allotted time at that intended occupancy location 111 is almost over (ending); a red light could indicate that intended occupancy location 111 should be vacant but is not vacant (e.g., is improperly occupied) (e.g., allotted time has been overstayed); and a blue (or purple light) could indicate that intended occupancy location is now (appropriately) vacant and/or ready to be appropriately occupied. With respect to the immediately preceding sentence, obviously, the invention (and/or at least some embodiments) is not limited to these particular light colors and/or these noted light colors could be changed to other light colors and/or the colored lights could be associated with a different set of intended occupancy location statuses.

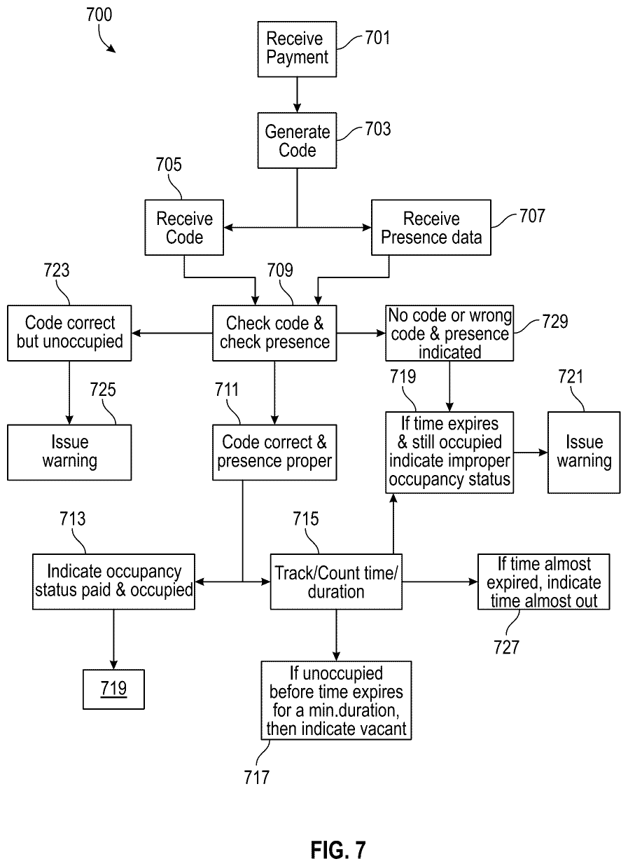

FIG. 7 may be a flow (process) diagram. FIG. 7 may show a method 700. FIG. 7 may show at least one step of method 700. FIG. 7 may show at least some steps of method 700. In some embodiments, method 700 may be a method of managing, monitoring, notifying, and/or providing (occupancy) status information of table(s) 109 and/or of seat(s) 111 (intended occupancy zone[s] 111) for a given accommodation premises (such as, but not limited to, a given coffee shop or restaurant). In some embodiments, method 700 may be a method of executing system 100 and/or of executing at least a portion of system 100. In some embodiments, method 700 may comprise at least one of the following steps: step 701, step 703, step 705, step 707, step 709, step 711, step 713, step 715, step 717, step 719, step 721, step 723, step 725, step 727, and/or step 729. In some embodiments, method 700 may comprise one or more of the following steps: step 701, step 703, step 705, step 707, step 709, step 711, step 713, step 715, step 717, step 719, step 721, step 723, step 725, step 727, and/or step 729. In some embodiments, method 700 may comprise at least some of the following steps: step 701, step 703, step 705, step 707, step 709, step 711, step 713, step 715, step 717, step 719, step 721, step 723, step 725, step 727, and/or step 729. In some embodiments, method 700 may comprise: step 701, step 703, step 705, step 707, step 709, step 711, step 713, step 715, step 717, step 719, step 721, step 723, step 725, step 727, and/or step 729. In some embodiments, with respect to method 700, at least of one of its steps may be execute out of numerical order with respect to the step reference numerals. In some embodiments, with respect to method 700, at least of one its steps may be optional and/or omitted. In some embodiments, method 700 may be applicable to system 100 (or a portion of system 100) and/or to FIG. 1A to FIG. 1E.

Continuing discussing FIG. 7, in some embodiments, step 701 (of method 700) may be a step of at least one of the following receiving payment (for using at least one table 109 and/or for using at least one seat 111) from/at: system 100; a portion of system 100; POP-device 101; electronic-device 107; hub 115; computer-server 125; mobile-app (software) running on mobile-computing-device 129, wherein that mobile-app and/or that mobile-computing-device 129 may be in (wireless) communication with at least one of POP-device 101, electronic-device 107, hub 115, and/or computer-server 125; a portion thereof; combinations thereof; and/or the like. In some embodiments, the step 701 payment may have been for food and/or beverage, which may then permit system 100 to authorize use of at least one table 109 and/or at least one seat 111 of a given accommodation premises for consuming that food and/or the beverage or a portion thereof. In some embodiments, the step 701 payment may utilize any generally and/or readily accepted payment method (such as, but not limited to, cash, credit card, debit card, EBT card, Apple Pay, Google Wallet, PayPal, Zelle, Venmo, a contactless payment method, a touch payment method, a proximity payment method, and/or the like). In some embodiments, the step 701 payment may have been for (occupancy) using at least one table 109 and/or at least one seat 111 of a given accommodation premises, even if no food and/or no beverage may have been purchased. In some embodiments, step 701 may be a step of receiving a coupon (or the like) or gift card (wherein the coupon and/or the gift card may have been previously paid for). In some embodiments, the duration of time purchased in step 701 may be for person(s) 117 occupying (using) at least one: table 109 and/or seat 111. In some embodiments, if no explicit duration of time (for using a given table 109 and/or seat 111) was purchased in step 701, but only food and/or beverage were purchased, that purchased food and/or beverage may be associated with (assigned to) a total duration of time (e.g., in a database accessible by system 100 or a portion of system 100) that person(s) 117 may occupy a given table 109 and/or may occupy at least one seat 111; wherein that total duration of time (from the purchased food and/or beverage) may vary depending upon how much and/or how expensive the purchased food and/or beverage was. In some embodiments, before method 700 may execute step 701, a given table 109 and/or a given seat 111, of the given accommodation premises, may be associated with step 717 and/or in the status associated with step 717. In some embodiment, the status of step 717 may be associated with the first status and/or emission of the first-light 601a that may indicate that the given table 109 and/or the given seat 111 is vacant and ready for (paid) occupancy. In some embodiments, at least partial execution of step 701 may cause method 700 to transition to executing step 703.

Continuing discussing FIG. 7, in some embodiments, step 703 may be a step of at least one of the following generating (and/or providing) at least one code 105 from/by: system 100; a portion of system 100; POP-device 101; electronic-device 107; hub 115; computer-server 125; mobile-app (software) running on mobile-computing-device 129, wherein that mobile-app and/or that mobile-computing-device 129 may be in (wireless) communication with at least one of POP-device 101, electronic-device 107, hub 115, and/or computer-server 125; a portion thereof; combinations thereof; and/or the like. In some embodiments, a given code 105 may be generated (and/or provided) by at least one of: system 100; a portion of system 100; POP-device 101; electronic-device 107; hub 115; computer-server 125; mobile-app (software) running on mobile-computing-device 129, wherein that mobile-app and/or that mobile-computing-device 129 may be in (wireless) communication with at least one of POP-device 101, electronic-device 107, hub 115, and/or computer-server 125; a portion thereof; combinations thereof; and/or the like. In some embodiments, a given code 105 may be sent (and/or transmitted) by at least one of: system 100; a portion of system 100; POP-device 101; electronic-device 107; hub 115; computer-server 125; mobile-app (software) running on mobile-computing-device 129, wherein that mobile-app and/or that mobile-computing-device 129 may be in (wireless) communication with at least one of POP-device 101, electronic-device 107, hub 115, and/or computer-server 125; a portion thereof; combinations thereof; and/or the like. In some embodiments, execution of step 703 may cause method 700 to transition to executing step 705 and/or execution of step 703 may cause method 700 to transition to executing step 707.

Continuing discussing FIG. 7, in some embodiments, step 705 may be a step of receiving at least one code 105 (e.g., generated in step 703) (see e.g., communication 119 from FIG. 1B and/or FIG. 1C). In some embodiments, the step 705 code 105 receival may be received at least one of the following: system 100; a portion of system 100; POP-device 101; electronic-device 107; hub 115; computer-server 125; mobile-app (software) running on mobile-computing-device 129, wherein that mobile-app and/or that mobile-computing-device 129 may be in (wireless) communication with at least one of POP-device 101, electronic-device 107, hub 115, and/or computer-server 125; a portion thereof; combinations thereof; and/or the like. In some embodiments, the step 705 code 105 receival may initially be at/on a device that did not generate code 105; e.g., receival may be at a given electronic-device 107 (see e.g., FIG. 1B and/or FIG. 1C) and generation may have been at a given POP-device 101 of the given accommodation premises. In some embodiments, at least partial execution of step 705 may cause method 700 to transition to executing step 709.

Continuing discussing FIG. 7, in some embodiments, step 707 may be a step of receiving (and/or checking) person 117 presence/occupancy data (if present) from at least one sensor(s) 507 of at least one 107 (presence-detector-device 107c) that may be monitoring a given table 109 and/or a given seat 111 for the presence (occupancy) of a person 117 at such location(s) (see e.g., communication 121 of FIG. 1B); and/or step 707 may be a step of receiving person 117 presence/occupancy data (if present) from at least one mobile-computing-device 129 that has obtained (received) presence (occupancy data) from a given tag 123 (e.g., by person 117 entering informational content of the given tag 123 into their mobile-computing-device 129 and then that mobile-computing-device 129 communicating that tag 123 informational content to electronic-device 107 associated with that given table 109 and/or that given seat 111). In some embodiments, at least partial execution of step 707 may cause method 700 to transition to executing step 709.

Continuing discussing FIG. 7, in some embodiments, step 709 may be a step of checking, verifying and/or validating that the received at least one code 105 is correct, valid, appropriately issued, and/or not timed out (expired). In some embodiments, this step 709 checking, verifying and/or validating may entail the device (e.g., electronic-device 107 [associated with a given table 109 and/or with a given seat 111]) that had received the code 105 in step 705 (wirelessly) communicating with another (different) device that has record(s) of the code's 105 generation and/or providing, which may be the device that had generated that code 105 or it may be device in communication with the generating device (wherein these other/different device(s) may be POP-device(s) 101, hub(s) 115, and/or computer-server(s) 125). In some embodiments, step 709 may be a step of checking, determining, analyzing, verifying and/or validating person 117 presence (occupancy) data at the given table 109 and/or at the given seat 111 associated with where code 105 was received. In some embodiments, step 709 may be a step of checking, determining, analyzing, verifying and/or validating person 117 presence (occupancy) data at the given table 109 and/or at the given seat 111. In some embodiments, step 709 may be a step of checking, determining, analyzing, verifying and/or validating person 117 presence (occupancy) data may be done by analyzing the presence (occupancy) data received from sensor(s) 507 of a given electronic-device 107 (presence-detector-device 107c). In some embodiments, this analysis may be performed by software running on at least one of: electronic-device 107 (presence-detector-device 107c); hub(s) 115; computer-server(s) 125. In some embodiments, this analysis may be performed by software running on at least one of: electronic-device 107 (presence-detector-device 107c); hub(s) 115; computer-server(s) 125; wherein that software may comprise at least one AI algorithm (artificial intelligence algorithm) and/or at least one ML algorithm (machine learning algorithm). In some embodiments, this analysis may be performed by software running on at least one of: electronic-device 107 (presence-detector-device 107c); hub(s) 115; computer-server(s) 125; wherein that software may access and/or may at least one AI algorithm and/or at least one ML algorithm. In some embodiments, step 709 may be a step of checking, determining, analyzing, verifying and/or validating person 117 presence (occupancy) data may be done by comparing received informational content of a given tag 123 against a database of tags 123 information for that given accommodation premises; wherein this database may be accessible by hub(s) 115 and/or computer-server(s) 125. In some embodiments, this database may be non-transitorily stored in storage 505 of hub(s) 115 and/or computer-server(s) 125. In some embodiments, step 709 may be a step of checking, verifying and/or validating that the received at least one code 105 is correct, valid, appropriately issued, and/or not timed out (expired); and/or in some embodiments, step 709 may be a step of checking, determining, analyzing, verifying and/or validating person 117 presence (occupancy) data. In some embodiments, at least partial execution of step 709 may cause method 700 to transition to executing: step 711, or step 723, or step 729.

Continuing discussing FIG. 7, in some embodiments, step 711 may be an outcome from step 709 of the code 105 being correct, valid, appropriately issued, and/or not timed out (expired); and/or in some embodiments, step 711 may be an outcome from step 709 of the person 117 presence (occupancy) data being proper (appropriate) for that given table 109 and/or that given seat 111 of the given accommodation premises. That is, in step 711, a person 117 may have properly provided a correct, valid, appropriately issued, and/or not timed out (expired) code 105 for using a given table 109 and/or for using a given seat 111; and that person 117 may be detected and/or determined present (occupying) an appropriate table 109 and/or seat 111 (of the given accommodation premises). In some embodiments, at least partial execution of step 711 may cause method 700 to transition to executing step 713 and/or to step 715.

Continuing discussing FIG. 7, in some embodiments, step 713 may be a step of indicating, notifying, displaying, broadcasting, and/or sending that a presence (occupancy) status for a given table 109 and/or for a given seat 111, of a given accommodation premises, is properly occupied (i.e., code 105 properly received and presence properly detected/verified). In some embodiments, the second status and/or the second-light 601b may indicate that a given table 109 and/or a given seat 111 is properly occupied and with occupancy presently (currently) paid for. In some embodiments, execution of step 713 may cause the second-light 601b to be on, active, energized, and/or illuminated; wherein second-light 601b may emit light (of a particular color) on status-indicator(s) 513 of a given electronic-device 107 (status-indicator 107b) of (on) the table 109 and/or of the given seat 111. In some embodiments, execution of step 713 may cause the second-light 601b to be on, active, energized, and/or illuminated; wherein second-light 601b may emit light (of a particular color) on status-indicator(s) 513 of a given electronic-device 107 (status-indicator 107b) that may be associated with (monitoring) the given table 109 and/or of the given seat 111. In some embodiments, execution of step 713 may cause the second-light 601b to be displayed on a screen of a mobile-computing-device 129 that may have software (mobile-app) running for monitoring the occupancy status of at least one table 109 and/or of at least one seat 111. In some embodiments, while execution of step 713 may be occurring, then method 700 may also concurrently be executing step 715.

Continuing discussing FIG. 7, in some embodiments, step 715 may execute as a result of step/outcome 711 and/or step 715 may execute concurrently while step 713 may be executing. In some embodiments, step 715 may be execution of a timer. In some embodiments, step 715 may be a step of tracking time (duration), as in counting up, or as in counting down, as the payment received in the step 701 may have associated an amount of time (duration) that the given table 109 and/or the given seat 111 may be properly occupied. In some embodiments, duration of time purchased in the step 701 may have been purchased in increments of: one (1) minute, two (2) minutes, five (5) minutes, ten (10) minutes, fifteen (15) minutes, thirty (30) minutes, one (1) hour, combinations thereof, and/or the like; or some other increment of time. In some embodiments, duration of time purchased in the step 701 may have been manually and/or custom determined (entered) by purchasing person(s) 117 (e.g., as part of step 701). In some embodiments, the payment received in the step 701 may have associated a total amount of time (duration), such as, but not limited to, at least one of: five (5) minutes, ten (10) minutes, fifteen (15) minutes, twenty (20) minutes, twenty-five (25) minutes, thirty (30) minutes, forty-five (45) minutes, one (1) hour, or combinations thereof (e.g., two (2) hours and forty-five (45) (45) minutes as the total duration purchased for a given table 109 or a given seat 111). For example, and without limiting the scope of the present invention, if the total duration purchased in step 701 was one (1) hour and fifteen (15) minutes, then during step 715, step 715 may be counting down from one (1) hour and fifteen (15) minutes until reaching zero; or during step 715, step 715 may be counting up from zero until reaching one (1) hour and fifteen (15) minutes. In some embodiments, the counting of the timer of step 715 may occur in increments of: one (1) second. In some embodiments, execution of step 715 may cause method 700 to transition to: executing step 717, executing step 719, or executing step 727.

Continuing discussing FIG. 7, in some embodiments, step 717 may be a step of determining that a given table 109 and/or a given seat 111 may have become unoccupied, and without becoming re-occupied for at least some minimum amount of time (so as to make a determination of being unoccupied). In some embodiments, execution of step 717 may utilize sensor(s) 507 of the associated electronic-device 107 (that may be monitoring the given table 109 and/or the given seat 111). In some embodiments, step 717 may be a step of indicating, notifying, displaying, broadcasting, and/or sending that a presence (occupancy) status for a given table 109 and/or for a given seat 111, of a given accommodation premises, is properly unoccupied (i.e., no code 105 properly received and no presence properly detected/verified). In some embodiments, step 717 may execute (occur) when the given table 109 and/or the given seat 111 becomes unoccupied (e.g., as determined by sensor(s) 507 of the associated electronic-device 107) (for at least some minimum amount of time without becoming re-occupied [such as, but not limited to, for at least five (5) minutes or some other amount of time]). In some embodiments, step 717 may execute (occur) before the step 715 timer finishes, when/as the step 715 timer finishes, or after the step 715 timer has finished, as long as, the given table 109 and/or the given seat 111 becomes unoccupied (e.g., as determined by sensor(s) 507 of the associated electronic-device 107) (for at least some minimum amount of time without becoming re-occupied). In some embodiments, the first status and/or the first-light 601a may indicate that a given table 109 and/or a given seat 111 is vacant and ready for occupancy. In some embodiments, execution and/or completion of step 717 may cause the first-light 601a to be on, active, energized, and/or illuminated; wherein first-light 601a may emit light (of a particular color) on status-indicator(s) 513 of a given electronic-device 107 (status-indicator 107b) of (on) the table 109 and/or of the given seat 111. In some embodiments, execution and/or completion of step 717 may cause the first-light 601a to be on, active, energized, and/or illuminated; wherein first-light 601a may emit light (of a particular color) on status-indicator(s) 513 of a given electronic-device 107 (status-indicator 107b) that may be associated with (monitoring) the given table 109 and/or of the given seat 111. In some embodiments, execution and/or completion of step 717 may cause the first-light 601a to be displayed on a screen of a mobile-computing-device 129 that may have software (mobile-app) running for monitoring the occupancy status of at least one table 109 and/or of at least one seat 111. In some embodiments, when the given table 109 and/or given seat 111 may have an associated first-light 601a being shown, indicated, notified, displayed, broadcast, and/or sent, then that given table 109 and/or given seat 111 may be ready for method 700 to execute again from its beginning, i.e., from its step 701.

Continuing discussing FIG. 7, in some embodiments, step 719 may be a step of if the step 715 timer has completed (finished), but person(s) 117 presence (occupancy) is still being detected (and/or determined) (e.g., by sensor(s) 507 of the electronic-device 107 monitoring the given table 109 and/or the given seat 111), to then indicate, notify, display, broadcast, and/or send a presence (occupancy) status for the given table 109 and/or for the given seat 111, of a given accommodation premises, is improperly occupied (i.e., occupancy without payment verification). In some embodiments, step 719 may be a step of indicating, notifying, displaying, broadcasting, and/or sending a presence (occupancy) status for the given table 109 and/or for the given seat 111, of a given accommodation premises, is currently being improperly occupied (i.e., occupancy without payment verification). In some embodiments, step 719 may execute if the step 715 timer has completed (finished) and there was no further (additional) payment received that would either re-start a new timer or that might add on additional time to the existing timer. In some embodiments, the third status and/or the third-light 601c may indicate that a given table 109 and/or a given seat 111 is improperly occupied because that current occupancy has not been appropriately paid for. In some embodiments, execution and/or completion of step 719 may cause the third-light 601c to be on, active, energized, and/or illuminated; wherein third-light 601c may emit light (of a particular color) on status-indicator(s) 513 of a given electronic-device 107 (status-indicator 107b) of (on) the table 109 and/or of the given seat 111. In some embodiments, execution and/or completion of step 719 may cause the third-light 601c to be on, active, energized, and/or illuminated; wherein third-light 601c may emit light (of a particular color) on status-indicator(s) 513 of a given electronic-device 107 (status-indicator 107b) that may be associated with (monitoring) the given table 109 and/or of the given seat 111. In some embodiments, execution and/or completion of step 719 may cause the third-light 601c to be displayed on a screen of a mobile-computing-device 129 that may have software (mobile-app) running for monitoring the occupancy status of at least one table 109 and/or of at least one seat 111. In some embodiments, at least partial execution of step 719 may cause method 700 to transition to executing step 721. In some embodiments, if step 719 gets executed and then the given table 109 and/or a given seat 111 becomes unoccupied without being re-occupied for at least some minimum amount of time, then method 700 may progress to step 717.

Continuing discussing FIG. 7, in some embodiments, step 721 may be a step of generating, issuing, sending, and/or broadcasting at least one warning. In some embodiments, informational content of the at least one warning may comprise a message/notice that the person(s) 117 currently occupying the given table 109 and/or the given seat 111: needs to vacate (leave) that the given table 109 and/or the given seat 111; must vacate (leave) that the given table 109 and/or the given seat 111; or pay (more and/or again) (e.g., via POP-device 101, electronic-device 107, and/or mobile-computing-device 129) to be able to validly occupy that the given table 109 and/or the given seat 111. In some embodiments, the at least one warning may take a form of: a message or a notice. In some embodiments, the at least one warning may take a form of: a written message, a written notice, a video message, a video notice, an animated message, an animated notice, a portion thereof, combinations thereof, and/or the like. In some embodiments, the at least one warning may be configured to be: broadcast upon at least one speaker of the given accommodation premises; broadcast upon at least one speaker of electronic-device(s) 107, POP-device(s) 101, hub(s) 115, and/or computer-server(s) 125; broadcast upon at least one speaker of mobile-computing-device(s) 129; displayed upon a screen of electronic-device(s) 107, POP-device(s) 101, hub(s) 115, and/or computer-server(s) 125; displayed upon a screen of mobile-computing-device(s) 129; combinations thereof; and/or the like. In some embodiments, execution of step 721 may be optional or omitted. In some embodiments, if step 719 and/or if step 721 gets executed and then the given table 109 and/or a given seat 111 becomes unoccupied without being re-occupied for at least some minimum amount of time, then method 700 may progress to step 717.

Continuing discussing FIG. 7, in some embodiments, step 723 may be an outcome from executing step 709 when the received code 105 was determined to be correct (valid, verified, and/or timely), but no presence is detected (determined) at the given table 109 and/or the given seat 111. In some embodiments, in executing step 723 the sensor(s) 507 of the given electronic-device 107, that may be monitoring the given table 109 and/or the given seat 111, may sense and/or may determine that no person 117 is currently present (occupying) that given table 109 and/or that given seat 111. In some embodiments, execution and/or completion of step 723 may cause an indicator light 601 to be on, active, energized, and/or illuminated; wherein that indicator light 601 may emit light (of a particular color) on status-indicator(s) 513 of a given electronic-device 107 (status-indicator 107b) that may be associated with (monitoring) the given table 109 and/or of the given seat 111. In some embodiments, execution and/or completion of step 723 coupled with an unoccupied determination for at least some minimum amount of time may cause method 700 to transition to method 717. In some embodiments, at least partial execution of step 723 may cause method 700 to transition to executing step 725.

Continuing discussing FIG. 7, in some embodiments, step 725 may be a step of generating, issuing, sending, and/or broadcasting at least one warning. In some embodiments, informational content of the at least one warning may comprise a message/notice that: a valid (correct, verified) code 105 has been received; presence (occupancy) needs to be detected at a presently vacant table 109 and/or a presently vacant seat 111 (that are ready for occupancy, e.g., as indicated by the first status and/or by first-light 601a); presence (occupancy) needs to be detected at a presently vacant table 109 and/or a presently vacant seat 111 (that are ready for occupancy, e.g., as indicated by the first status and/or by first-light 601a) within (by) a certain (date and) time frame; if presence (occupancy) is not detected at a presently vacant table 109 and/or a presently vacant seat 111 (that are ready for occupancy, e.g., as indicated by the first status and/or by first-light 601a) within (by) a certain (date and) time frame, the at least one warning may comprise informational content that the code 105 needs to be re-entered (re-read) (e.g., at presently vacant but ready for occupancy table 109 via its electronic-device 107); and/or the like. In some embodiments, the at least one warning may take a form of: a message or a notice. In some embodiments, the at least one warning may take a form of: a written message, a written notice, a video message, a video notice, an animated message, an animated notice, a portion thereof, combinations thereof, and/or the like. In some embodiments, the at least one warning may be configured to be: broadcast upon at least one speaker of the given accommodation premises; broadcast upon at least one speaker of electronic-device(s) 107, POP-device(s) 101, hub(s) 115, and/or computer-server(s) 125; broadcast upon at least one speaker of mobile-computing-device(s) 129; displayed upon a screen of electronic-device(s) 107, POP-device(s) 101, hub(s) 115, and/or computer-server(s) 125; displayed upon a screen of mobile-computing-device(s) 129; combinations thereof; and/or the like. In some embodiments, execution of step 725 may be optional or omitted. In some embodiments, if step 723 and/or if step 725 gets executed and then the given table 109 and/or a given seat 111 remains unoccupied without being re-occupied for at least some minimum amount of time, then method 700 may progress to step 717.

Continuing discussing FIG. 7, in some embodiments, step 727 may follow from step 715 when the step 715 timer is almost finished (completed). In some embodiments, step 727 may be a step of indicating, notifying, displaying, broadcasting, and/or sending that a presence (occupancy) status for a given table 109 and/or for a given seat 111, of a given accommodation premises, that the current timer (from step 715) is almost completed (finished). In some embodiments, when the step 715 timer is almost done (finished or completed), then step 727 may execute. In some embodiments, when a majority of the step 715 timer has run, then step 727 may execute. In some embodiments, when seventy (70) percent (%), eighty (80) percent (%), ninety (90) percent (%), ninety-five (95) percent (%), or more of the step 715 timer has run, then step 727 may execute (e.g., at least one of these may be programmed into the software). In some embodiments, when only ten (10) minutes, five (5) minutes, one (1) minute, or some other remaining amount of time that the timer of step 715 has left occurs, then step 727 may execute (e.g., at least one of these may be programmed into the software). In some embodiments, the fourth status and/or the fourth-light 601c may indicate that a given table 109 and/or a given seat 111 is properly occupied and paid for, but that its duration of paid for occupancy is nearing its termination (end) (e.g., the timer of step 715 may be nearing is completion). In some embodiments, execution of step 727 may cause the fourth-light 601c to be on, active, energized, and/or illuminated; wherein fourth-light 601c may emit light (of a particular color) on status-indicator(s) 513 of a given electronic-device 107 (status-indicator 107b) of (on) the table 109 and/or of the given seat 111. In some embodiments, execution of step 727 may cause the fourth-light 601c to be on, active, energized, and/or illuminated; wherein fourth-light 601c may emit light (of a particular color) on status-indicator(s) 513 of a given electronic-device 107 (status-indicator 107b) that may be associated with (monitoring) the given table 109 and/or of the given seat 111. In some embodiments, execution of step 727 may cause the fourth-light 601c to be displayed on a screen of a mobile-computing-device 129 that may have software (mobile-app) running for monitoring the occupancy status of at least one table 109 and/or of at least one seat 111. In some embodiments, execution or completion of step 727 may cause method 700 to transition to step 719 if the given table 109 and/or if the given seat 111 remains (improperly) occupied after the timer of the step 715 has completed and there was no repayment. In some embodiments, execution or completion of step 727 may cause method 700 to transition to step 717 if the given table 109 and/or if the given seat 111 becomes unoccupied after the timer of the step 715 has completed.

Continuing discussing FIG. 7, in some embodiments, step 729 may be an outcome from step 709 of the code 105 not being correct, the code 105 not being validated, the code 105 not being verified, the code 105 having expired, or no code 105 is timely detected (received) by the given electronic-device 107; and wherein at least one these code 105 problems may be coupled with person(s) 117 presence (occupancy) being detected (determined) at the given table 109 and/or at the given seat 111 (e.g., via operation of the sensor(s) 507 of that electronic-device 107 that is monitoring that given table 109 and/or at the given seat 111). In some embodiments, step 729 may correspond to a situation of improper presence (occupancy) at the given table 109 and/or at the given seat 111 (improper because no corresponding payment receipt for authorizing that presence [occupancy]). In some embodiments, at least partial execution of step 729 may cause method 700 to transition to executing step 719.

In some embodiments, another outcome from step 709 may be no code 105 received and no presence (occupancy) detected, wherein then the occupancy status of a given table 109 and/or of a given seat 111 may remain in its default status, such as, but not limited to, the status of step 717 (e.g., of the first status and/or of emission of the first-light 601a).

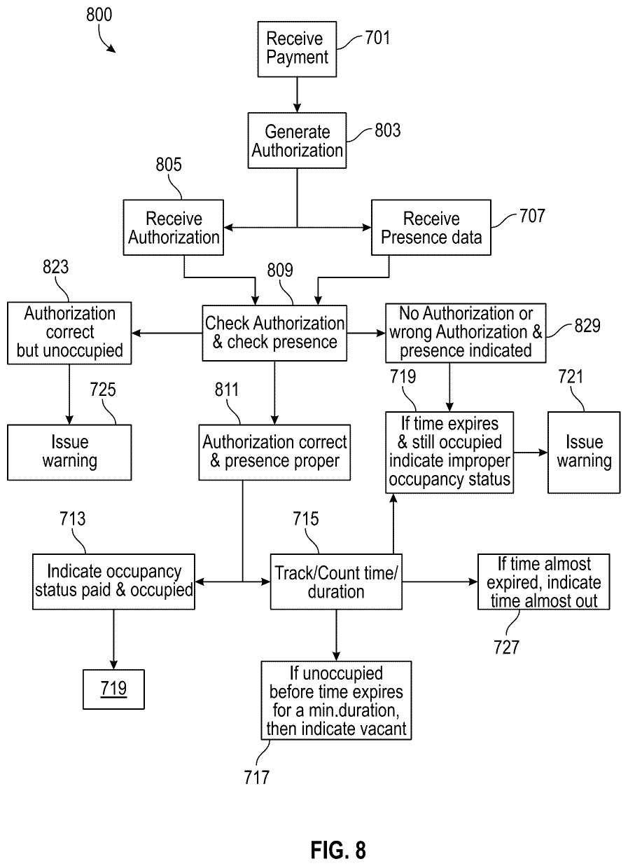

FIG. 8 may be a flow (process) diagram. FIG. 8 may show a method 800. FIG. 8 may show at least one step of method 800. FIG. 8 may show at least some steps of method 800. In some embodiments, method 800 may be a method of managing, monitoring, notifying, and/or providing (occupancy) status information of table(s) 109 and/or of seat(s) 111 (intended occupancy zone[s] 111) for a given accommodation premises (such as, but not limited to, a given coffee shop or restaurant). In some embodiments, method 800 may be a method of executing system 200 and/or of executing at least a portion of system 200. In some embodiments, method 800 may be substantially similar to method 700, except code 105 may not be utilized in method 800. In some embodiments, method 800 may comprise at least one of the following steps: step 701, step 803, step 805, step 707, step 809, step 811, step 713, step 715, step 717, step 719, step 721, step 823, step 725, step 727, and/or step 829. In some embodiments, method 800 may comprise one or more of the following steps: step 701, step 803, step 805, step 707, step 809, step 811, step 713, step 715, step 717, step 719, step 721, step 823, step 725, step 727, and/or step 829. In some embodiments, method 800 may comprise at least some of the following steps: step 701, step 803, step 805, step 707, step 809, step 811, step 713, step 715, step 717, step 719, step 721, step 823, step 725, step 727, and/or step 829. In some embodiments, method 800 may comprise: step 701, step 803, step 805, step 707, step 809, step 811, step 713, step 715, step 717, step 719, step 721, step 823, step 725, step 727, and/or step 829. In some embodiments, with respect to method 800, at least of one of its steps may be execute out of numerical order with respect to the step reference numerals. In some embodiments, with respect to method 800, at least of one its steps may be optional and/or omitted. In some embodiments, method 800 may be applicable to system 200 (or a portion of system 200) and/or to portions of FIG. 1A and/or FIG. 1B. In some embodiments, method 800 may be applicable to FIG. 1D to FIG. 2.

Continuing discussing FIG. 8, in some embodiments, step 701 (of method 800) may be a step of at least one of the following receiving payment (for using at least one table 109 and/or for using at least one seat 111) from (at): system 200; a portion of system 200; POP-device 101; electronic-device 107; hub 115; computer-server 125; mobile-app (software) running on mobile-computing-device 129, wherein that mobile-app and/or that mobile-computing-device 129 may be in (wireless) communication with at least one of POP-device 101, electronic-device 107, hub 115, and/or computer-server 125; a portion thereof; combinations thereof; and/or the like. In some embodiments, the step 701 payment may have been for food and/or beverage, which may then permit system 200 to authorize (occupancy) use of at least one table 109 and/or at least one seat 111 of a given accommodation premises for consuming that food and/or the beverage or a portion thereof. In some embodiments, the step 701 payment may utilize any generally and/or readily accepted payment method (such as, but not limited to, cash, credit card, debit card, EBT card, Apple Pay, Google Wallet, PayPal, Zelle, Venmo, a contactless payment method, a touch payment method, a proximity payment method, and/or the like). In some embodiments, the step 701 payment may have been for using at least one table 109 and/or at least one seat 111 of a given accommodation premises, even if no food and/or no beverage may have been purchased. In some embodiments, step 701 may be a step of receiving a coupon (or the like) or gift card (wherein the coupon and/or the gift card may have been previously paid for). In some embodiments, the duration of time purchased in step 701 may be for person(s) 117 occupying (using) at least one: table 109 and/or seat 111. In some embodiments, if no explicit duration of time (for using a given table 109 and/or seat 111) was purchased in step 701, but only food and/or beverage were purchased, that purchased food and/or beverage may be associated with (assigned to) a total duration of time (e.g., in a database accessible by system 200 or a portion of system 200) that person(s) 117 may occupy a given table 109 and/or may occupy at least one seat 111; wherein that total duration of time (from the purchased food and/or beverage) may vary depending upon how much and/or how expensive the purchased food and/or beverage was. In some embodiments, before method 800 may execute step 701, a given table 109 and/or a given seat 111, of the given accommodation premises, may be associated with step 717 and/or in the status associated with step 717. In some embodiment, the status of step 717 may be associated with the first status and/or emission of the first-light 601a that may indicate that the given table 109 and/or the given seat 111 is vacant and ready for (paid) occupancy. In some embodiments, at least partial execution of step 701 may cause method 800 to transition to executing step 803.

Continuing discussing FIG. 8, in some embodiments, step 803 may be a step of at least one of the following generating (and/or providing) at least one digital authorization (digital credential, token, and/or certificate) from/at: system 200; a portion of system 200; POP-device 101; electronic-device 107; hub 115; computer-server 125; mobile-app (software) running on mobile-computing-device 129, wherein that mobile-app and/or that mobile-computing-device 129 may be in (wireless) communication with at least one of POP-device 101, electronic-device 107, hub 115, and/or computer-server 125; a portion thereof; combinations thereof; and/or the like. In some embodiments, authorization, credential, token, and/or certificate may be used interchangeably herein. In some embodiments, the authorization, credential, token, and/or certificate may be in digital and/or electronic form (format). In some embodiments, the authorization, credential, token, and/or certificate may be encrypted and/or in cryptographic form (format). In some embodiments, a given digital authorization may be generated (and/or provided) by at least one of: system 200; a portion of system 200; POP-device 101; electronic-device 107; hub 115; computer-server 125; mobile-app (software) running on mobile-computing-device 129, wherein that mobile-app and/or that mobile-computing-device 129 may be in (wireless) communication with at least one of POP-device 101, electronic-device 107, hub 115, and/or computer-server 125; a portion thereof; combinations thereof; and/or the like. In some embodiments, a given digital authorization may be sent (and/or transmitted) by at least one of: system 200; a portion of system 200; POP-device 101; electronic-device 107; hub 115; computer-server 125; that mobile-app and/or that mobile-computing-device 129; and/or the like. In some embodiments, execution of step 803 may cause method 800 to transition to executing step 805 and/or execution of step 803 may cause method 800 to transition to executing step 707.

Continuing discussing FIG. 8, in some embodiments, step 805 may be a step of receiving at least one digital authorization (e.g., generated in step 803) (see e.g., communication 201 from FIG. 2). In some embodiments, the step 805 digital authorization receival may be received at least one of the following: system 200; a portion of system 200; POP-device 101; electronic-device 107; hub 115; computer-server 125; a portion thereof; combinations thereof; and/or the like. In some embodiments, the step 805 digital authorization receival may initially be at/on a device that did not generate the digital authorization; e.g., receival may be at a given electronic-device 107 (see e.g., FIG. 2) and generation may have been at a given POP-device 101, hub 115, and/or computer-servicer 125 of the given accommodation premises. (Or in some embodiments, generation of the digital authorization may have been generated by software [mobile-app] running on mobile-computing-device 129.) In some embodiments, at least partial execution of step 805 may cause method 800 to transition to executing step 809.

Continuing discussing FIG. 8, in some embodiments, step 707 (of method 800) may be a step of receiving (and/or checking) person 117 presence/occupancy data (if present) from at least one sensor(s) 507 of at least one 107 (presence-detector-device 107c) that may be monitoring a given table 109 and/or a given seat 111 for the presence (occupancy) of a person 117 at such location(s) (see e.g., communication 121 of FIG. 2). In some embodiments, at least partial execution of step 707 may cause method 800 to transition to executing step 809.

Continuing discussing FIG. 8, in some embodiments, step 809 may be a step of checking, verifying and/or validating that the received at least one digital authorization is correct, valid, appropriately issued, and/or not timed out (expired). In some embodiments, this step 809 checking, verifying and/or validating may entail the device (e.g., electronic-device 107 [associated with a given table 109 and/or with a given seat 111]) that had received the digital authorization in step 805 (wirelessly) communicating with another (different) device that has record(s) of the digital authorization's generation and/or providing, which may be the device that had generated that given digital authorization or it may be device in communication with the generating device (wherein these other/different device(s) may be POP-device(s) 101, hub(s) 115, and/or computer-server(s) 125). In some embodiments, step 809 may be a step of checking, determining, analyzing, verifying and/or validating person 117 presence (occupancy) data at the given table 109 and/or at the given seat 111. In some embodiments, step 809 may be a step of checking, determining, analyzing, verifying and/or validating person 117 presence (occupancy) data at the given table 109 and/or at the given seat 111 associated with where the given digital authorization was received. In some embodiments, step 809 may be a step of checking, determining, analyzing, verifying and/or validating person 117 presence (occupancy) data may be done by analyzing the presence (occupancy) data received from sensor(s) 507 of a given electronic-device 107 (presence-detector-device 107c). In some embodiments, this analysis may be performed by software running on at least one of: electronic-device 107 (presence-detector-device 107c); hub(s) 115; computer-server(s) 125. In some embodiments, this analysis may be performed by software running on at least one of: electronic-device 107 (presence-detector-device 107c); hub(s) 115; computer-server(s) 125; wherein that software may comprise at least one AI algorithm (artificial intelligence algorithm) and/or at least one ML algorithm (machine learning algorithm). In some embodiments, this analysis may be performed by software running on at least one of: electronic-device 107 (presence-detector-device 107c); hub(s) 115; computer-server(s) 125; wherein that software may access and/or may at least one AI algorithm and/or at least one ML algorithm. In some embodiments, step 809 may be a step of checking, verifying and/or validating that the received at least one digital authorization is correct, valid, appropriately issued, and/or not timed out (expired); and/or in some embodiments, step 809 may be a step of checking, determining, analyzing, verifying and/or validating person 117 presence (occupancy) data. In some embodiments, at least partial execution of step 809 may cause method 800 to transition to executing: step 811, or step 823, or step 829.

Continuing discussing FIG. 8, in some embodiments, step 811 may be an outcome from step 809 of the received digital authorization being correct, valid, appropriately issued, and/or not timed out (expired); and/or in some embodiments, step 811 may be an outcome from step 809 of the person 117 presence (occupancy) data being proper (appropriate) for that given table 109 and/or that given seat 111 of the given accommodation premises. That is, in step 811, a given mobile-computing-device 129 may have properly provided a correct, valid, appropriately issued, and/or not timed out (expired) digital authorization (to the given electronic-device 107 via communication 201) for using a given table 109 and/or for using a given seat 111; and that person 117 may be detected and/or determined present (occupying) an appropriate table 109 and/or seat 111 (of the given accommodation premises) (detected via sensor(s) 507 of that given electronic-device 107). In some embodiments, at least partial execution of step 811 may cause method 800 to transition to executing step 713 and/or to step 715.

Continuing discussing FIG. 8, in some embodiments, step 713 (of method 800) may be a step of indicating, notifying, displaying, broadcasting, and/or sending that a presence (occupancy) status for a given table 109 and/or for a given seat 111, of a given accommodation premises, is properly occupied (i.e., the digital authorization properly received and presence properly detected/verified). In some embodiments, the second status and/or the second-light 601b may indicate that a given table 109 and/or a given seat 111 is properly occupied and with occupancy presently (currently) paid for. In some embodiments, execution of step 713 may cause the second-light 601b to be on, active, energized, and/or illuminated; wherein second-light 601b may emit light (of a particular color) on status-indicator(s) 513 of a given electronic-device 107 (status-indicator 107b) of (on) the table 109 and/or of the given seat 111. In some embodiments, execution of step 713 may cause the second-light 601b to be on, active, energized, and/or illuminated; wherein second-light 601b may emit light (of a particular color) on status-indicator(s) 513 of a given electronic-device 107 (status-indicator 107b) that may be associated with (monitoring) the given table 109 and/or of the given seat 111. In some embodiments, execution of step 713 may cause the second-light 601b to be displayed on a screen of a mobile-computing-device 129 that may have software (mobile-app) running for monitoring the occupancy status of at least one table 109 and/or of at least one seat 111. In some embodiments, while execution of step 713 may be occurring, then method 800 may also concurrently be executing step 715.

Continuing discussing FIG. 8, in some embodiments, step 715 (of method 800) may execute as a result of step/outcome 811 and/or step 715 may execute concurrently while step 713 may be executing. In some embodiments, step 715 may be execution of a timer. In some embodiments, step 715 may be a step of tracking time (duration), as in counting up, or as in counting down, as the payment received in the step 701 may have associated an amount of time (duration) that the given table 109 and/or the given seat 111 may be properly occupied. In some embodiments, duration of time purchased in the step 701 may have been purchased in increments of: one (1) minute, two (2) minutes, five (5) minutes, ten (10) minutes, fifteen (15) minutes, thirty (30) minutes, one (1) hour, combinations thereof, and/or the like; or some other increment of time. In some embodiments, duration of time purchased in the step 701 may have been manually and/or custom determined (entered) by purchasing person(s) 117 (e.g., as part of step 701). In some embodiments, the payment received in the step 701 may have associated a total amount of time (duration), such as, but not limited to, at least one of: five (5) minutes, ten (10) minutes, fifteen (15) minutes, twenty (20) minutes, twenty-five (25) minutes, thirty (30) minutes, forty-five (45) minutes, one (1) hour, or combinations thereof (e.g., two (2) hours and forty-five (45) (45) minutes as the total duration purchased for a given table 109 or a given seat 111). For example, and without limiting the scope of the present invention, if the total duration purchased in step 701 was one (1) hour and fifteen (15) minutes, then during step 715, step 715 may be counting down from one (1) hour and fifteen (15) minutes until reaching zero; or during step 715, step 715 may be counting up from zero until reaching one (1) hour and fifteen (15) minutes. In some embodiments, the counting of the timer of step 715 may occur in increments of: one (1) second. In some embodiments, execution of step 715 may cause method 800 to transition to: executing step 717, executing step 719, or executing step 727.

Continuing discussing FIG. 8, in some embodiments, step 717 (of method 800) may be a step of determining that a given table 109 and/or a given seat 111 may have become unoccupied, and without becoming re-occupied for at least some minimum amount of time (so as to make a determination of being unoccupied). In some embodiments, execution of step 717 may utilize sensor(s) 507 of the associated electronic-device 107 (that may be monitoring the given table 109 and/or the given seat 111). In some embodiments, step 717 may be a step of indicating, notifying, displaying, broadcasting, and/or sending that a presence (occupancy) status for a given table 109 and/or for a given seat 111, of a given accommodation premises, is properly unoccupied (i.e., no digital authorization properly received and no presence properly detected/verified). In some embodiments, step 717 may execute (occur) when the given table 109 and/or the given seat 111 becomes unoccupied (e.g., as determined by sensor(s) 507 of the associated electronic-device 107) (for at least some minimum amount of time without becoming re-occupied [such as, but not limited to, for at least five (5) minutes or some other amount of time]). In some embodiments, step 717 may execute (occur) before the step 715 timer finishes, when/as the step 715 timer finishes, or after the step 715 timer has finished, as long as, the given table 109 and/or the given seat 111 becomes unoccupied (e.g., as determined by sensor(s) 507 of the associated electronic-device 107) (for at least some minimum amount of time without becoming re-occupied). In some embodiments, the first status and/or the first-light 601a may indicate that a given table 109 and/or a given seat 111 is vacant and ready for occupancy. In some embodiments, execution and/or completion of step 717 may cause the first-light 601a to be on, active, energized, and/or illuminated; wherein first-light 601a may emit light (of a particular color) on status-indicator(s) 513 of a given electronic-device 107 (status-indicator 107b) of (on) the table 109 and/or of the given seat 111. In some embodiments, execution and/or completion of step 717 may cause the first-light 601a to be on, active, energized, and/or illuminated; wherein first-light 601a may emit light (of a particular color) on status-indicator(s) 513 of a given electronic-device 107 (status-indicator 107b) that may be associated with (monitoring) the given table 109 and/or of the given seat 111. In some embodiments, execution and/or completion of step 717 may cause the first-light 601a to be displayed on a screen of a mobile-computing-device 129 that may have software (mobile-app) running for monitoring the occupancy status of at least one table 109 and/or of at least one seat 111. In some embodiments, when the given table 109 and/or given seat 111 may have an associated first-light 601a being shown, indicated, notified, displayed, broadcast, and/or sent, then that given table 109 and/or given seat 111 may be ready for method 800 to execute again from its beginning, i.e., from its step 701.

Continuing discussing FIG. 8, in some embodiments, step 719 (of method 800) may be a step of if the step 715 timer has completed (finished), but person(s) 117 presence (occupancy) is still being detected (and/or determined) (e.g., by sensor(s) 507 of the electronic-device 107 monitoring the given table 109 and/or the given seat 111), to then indicate, notify, display, broadcast, and/or send a presence (occupancy) status for the given table 109 and/or for the given seat 111, of a given accommodation premises, is improperly occupied (i.e., occupancy without payment verification). In some embodiments, step 719 may be a step of indicating, notifying, displaying, broadcasting, and/or sending a presence (occupancy) status for the given table 109 and/or for the given seat 111, of a given accommodation premises, is currently being improperly occupied (i.e., occupancy without payment verification). In some embodiments, step 719 may execute if the step 715 timer has completed (finished) and there was no further (additional) payment received that would either re-start a new timer or that might add on additional time to the existing timer. In some embodiments, the third status and/or the third-light 601c may indicate that a given table 109 and/or a given seat 111 is improperly occupied because that current occupancy has not been appropriately paid for. In some embodiments, execution and/or completion of step 719 may cause the third-light 601c to be on, active, energized, and/or illuminated; wherein third-light 601c may emit light (of a particular color) on status-indicator(s) 513 of a given electronic-device 107 (status-indicator 107b) of (on) the table 109 and/or of the given seat 111. In some embodiments, execution and/or completion of step 719 may cause the third-light 601c to be on, active, energized, and/or illuminated; wherein third-light 601c may emit light (of a particular color) on status-indicator(s) 513 of a given electronic-device 107 (status-indicator 107b) that may be associated with (monitoring) the given table 109 and/or of the given seat 111. In some embodiments, execution and/or completion of step 719 may cause the third-light 601c to be displayed on a screen of a mobile-computing-device 129 that may have software (mobile-app) running for monitoring the occupancy status of at least one table 109 and/or of at least one seat 111. In some embodiments, at least partial execution of step 719 may cause method 800 to transition to executing step 721. In some embodiments, if step 719 gets executed and then the given table 109 and/or a given seat 111 becomes unoccupied without being re-occupied for at least some minimum amount of time, then method 800 may progress to step 717.

Continuing discussing FIG. 8, in some embodiments, step 721 (of method 800) may be a step of generating, issuing, sending, and/or broadcasting at least one warning. In some embodiments, informational content of the at least one warning may comprise a message/notice that the person(s) 117 currently occupying the given table 109 and/or the given seat 111: needs to vacate (leave) that the given table 109 and/or the given seat 111; must vacate (leave) that the given table 109 and/or the given seat 111; or pay (more and/or again) (e.g., via POP-device 101, electronic-device 107, and/or mobile-computing-device 129) to be able to validly occupy that the given table 109 and/or the given seat 111. In some embodiments, the at least one warning may take a form of: a message or a notice. In some embodiments, the at least one warning may take a form of: a written message, a written notice, a video message, a video notice, an animated message, an animated notice, a portion thereof, combinations thereof, and/or the like. In some embodiments, the at least one warning may be configured to be: broadcast upon at least one speaker of the given accommodation premises; broadcast upon at least one speaker of electronic-device(s) 107, POP-device(s) 101, hub(s) 115, and/or computer-server(s) 125; broadcast upon at least one speaker of mobile-computing-device(s) 129; displayed upon a screen of electronic-device(s) 107, POP-device(s) 101, hub(s) 115, and/or computer-server(s) 125; displayed upon a screen of mobile-computing-device(s) 129; combinations thereof; and/or the like. In some embodiments, execution of step 721 may be optional or omitted. In some embodiments, if step 719 and/or if step 721 gets executed and then the given table 109 and/or a given seat 111 becomes unoccupied without being re-occupied for at least some minimum amount of time, then method 800 may progress to step 717.

Continuing discussing FIG. 8, in some embodiments, step 823 may be an outcome from executing step 809 when the received digital authorization was determined to be correct (valid, verified, and/or timely), but no presence is detected (determined) at the given table 109 and/or the given seat 111. In some embodiments, in executing step 823 the sensor(s) 507 of the given electronic-device 107, that may be monitoring the given table 109 and/or the given seat 111, may sense and/or may determine that no person 117 is currently present (occupying) that given table 109 and/or that given seat 111. In some embodiments, execution and/or completion of step 823 may cause an indicator light 601 to be on, active, energized, and/or illuminated; wherein that indicator light 601 may emit light (of a particular color) on status-indicator(s) 513 of a given electronic-device 107 (status-indicator 107b) that may be associated with (monitoring) the given table 109 and/or of the given seat 111. In some embodiments, execution and/or completion of step 823 coupled with an unoccupied determination for at least some minimum amount of time may cause method 800 to transition to method 717. In some embodiments, at least partial execution of step 823 may cause method 800 to transition to executing step 725.

Continuing discussing FIG. 8, in some embodiments, step 725 (of method 800) may be a step of generating, issuing, sending, and/or broadcasting at least one warning. In some embodiments, informational content of the at least one warning may comprise a message/notice that: a valid (correct, verified) digital authorization has been received; presence (occupancy) needs to be detected at a presently vacant table 109 and/or a presently vacant seat 111 (that are ready for occupancy, e.g., as indicated by the first status and/or by first-light 601a); presence (occupancy) needs to be detected at a presently vacant table 109 and/or a presently vacant seat 111 (that are ready for occupancy, e.g., as indicated by the first status and/or by first-light 601a) within (by) a certain (date and) time frame; if presence (occupancy) is not detected at a presently vacant table 109 and/or a presently vacant seat 111 (that are ready for occupancy, e.g., as indicated by the first status and/or by first-light 601a) within (by) a certain (date and) time frame, the at least one warning may comprise informational content that sending (transmission) of the digital authorization needs to be re-attempted (e.g., attempting communication 201 from FIG. 2); and/or the like. In some embodiments, the at least one warning may take a form of: a message or a notice. In some embodiments, the at least one warning may take a form of: a written message, a written notice, a video message, a video notice, an animated message, an animated notice, a portion thereof, combinations thereof, and/or the like. In some embodiments, the at least one warning may be configured to be: broadcast upon at least one speaker of the given accommodation premises; broadcast upon at least one speaker of electronic-device(s) 107, POP-device(s) 101, hub(s) 115, and/or computer-server(s) 125; broadcast upon at least one speaker of mobile-computing-device(s) 129; displayed upon a screen of electronic-device(s) 107, POP-device(s) 101, hub(s) 115, and/or computer-server(s) 125; displayed upon a screen of mobile-computing-device(s) 129; combinations thereof; and/or the like. In some embodiments, execution of step 725 may be optional or omitted. In some embodiments, if step 823 and/or if step 725 gets executed and then the given table 109 and/or a given seat 111 remains unoccupied without being re-occupied for at least some minimum amount of time, then method 800 may progress to step 717.

Continuing discussing FIG. 8, in some embodiments, step 727 (of method 800) may follow from step 715 when the step 715 timer is almost finished (completed). In some embodiments, step 727 may be a step of indicating, notifying, displaying, broadcasting, and/or sending that a presence (occupancy) status for a given table 109 and/or for a given seat 111, of a given accommodation premises, that the current timer (from step 715) is almost completed (finished). In some embodiments, when the step 715 timer is almost done (finished or completed), then step 727 may execute. In some embodiments, when a majority of the step 715 timer has run, then step 727 may execute. In some embodiments, when seventy (70) percent (%), eighty (80) percent (%), ninety (90) percent (%), ninety-five (95) percent (%), or more of the step 715 timer has run, then step 727 may execute (e.g., at least one of these may be programmed into the software). In some embodiments, when only ten (10) minutes, five (5) minutes, one (1) minute, or some other remaining amount of time that the timer of step 715 has left occurs, then step 727 may execute (e.g., at least one of these may be programmed into the software). In some embodiments, the fourth status and/or the fourth-light 601c may indicate that a given table 109 and/or a given seat 111 is properly occupied and paid for, but that its duration of paid for occupancy is nearing its termination (end) (e.g., the timer of step 715 may be nearing is completion). In some embodiments, execution of step 727 may cause the fourth-light 601c to be on, active, energized, and/or illuminated; wherein fourth-light 601c may emit light (of a particular color) on status-indicator(s) 513 of a given electronic-device 107 (status-indicator 107b) of (on) the table 109 and/or of the given seat 111. In some embodiments, execution of step 727 may cause the fourth-light 601c to be on, active, energized, and/or illuminated; wherein fourth-light 601c may emit light (of a particular color) on status-indicator(s) 513 of a given electronic-device 107 (status-indicator 107b) that may be associated with (monitoring) the given table 109 and/or of the given seat 111. In some embodiments, execution of step 727 may cause the fourth-light 601c to be displayed on a screen of a mobile-computing-device 129 that may have software (mobile-app) running for monitoring the occupancy status of at least one table 109 and/or of at least one seat 111. In some embodiments, execution or completion of step 727 may cause method 800 to transition to step 719 if the given table 109 and/or if the given seat 111 remains (improperly) occupied after the timer of the step 715 has completed and there was no repayment. In some embodiments, execution or completion of step 727 may cause method 800 to transition to step 717 if the given table 109 and/or if the given seat 111 becomes unoccupied after the timer of the step 715 has completed.

Continuing discussing FIG. 8, in some embodiments, step 829 may be an outcome from step 809 of the digital authorization not being correct, the digital authorization not being validated, the digital authorization not being verified, the digital authorization having expired, or no digital authorization is timely detected (received) by the given electronic-device 107; and wherein at least one these digital authorization problems may be coupled with person(s) 117 presence (occupancy) being detected (determined) at the given table 109 and/or at the given seat 111 (e.g., via operation of the sensor(s) 507 of that electronic-device 107 that is monitoring that given table 109 and/or at the given seat 111). In some embodiments, step 829 may correspond to a situation of improper presence (occupancy) at the given table 109 and/or at the given seat 111 (improper because no corresponding payment receipt for authorizing that presence [occupancy]). In some embodiments, at least partial execution of step 829 may cause method 800 to transition to executing step 719.

In some embodiments, another outcome from step 809 may be no digital authorization received and no presence (occupancy) detected, wherein then the occupancy status of a given table 109 and/or of a given seat 111 may remain in its default status, such as, but not limited to, the status of step 717 (e.g., of the first status and/or of emission of the first-light 601a).

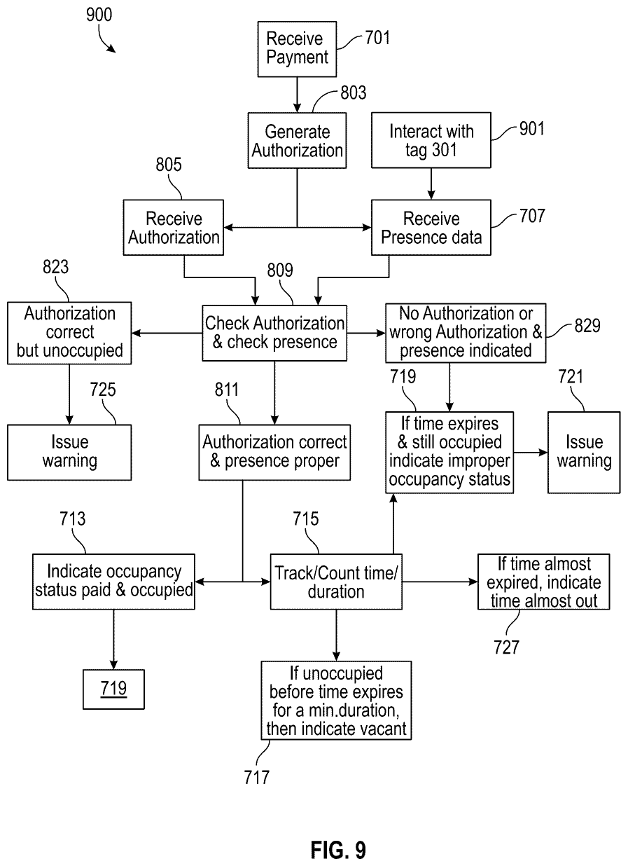

FIG. 9 may be a flow (process) diagram. FIG. 9 may show a method 900. FIG. 9 may show at least one step of method 900. FIG. 9 may show at least some steps of method 900. In some embodiments, method 900 may be a method of managing, monitoring, notifying, and/or providing (occupancy) status information of table(s) 109 and/or of seat(s) 111 (intended occupancy zone[s] 111) for a given accommodation premises (such as, but not limited to, a given coffee shop or restaurant). In some embodiments, method 900 may be a method of executing system 300 and/or of executing at least a portion of system 300. In some embodiments, method 900 may be substantially similar to method 800, except method 900 may also comprise a step 907 (for interacting with tag(s) 301). In some embodiments, method 900 may comprise at least one of the following steps: step 701, step 803, step 805, step 707, step 907, step 809, step 811, step 713, step 715, step 717, step 719, step 721, step 823, step 725, step 727, and/or step 829. In some embodiments, method 900 may comprise one or more of the following steps: step 701, step 803, step 805, step 707, step 907, step 809, step 811, step 713, step 715, step 717, step 719, step 721, step 823, step 725, step 727, and/or step 829. In some embodiments, method 900 may comprise at least some of the following steps: step 701, step 803, step 805, step 707, step 907, step 809, step 811, step 713, step 715, step 717, step 719, step 721, step 823, step 725, step 727, and/or step 829. In some embodiments, method 900 may comprise: step 701, step 803, step 805, step 707, step 907, step 809, step 811, step 713, step 715, step 717, step 719, step 721, step 823, step 725, step 727, and/or step 829. In some embodiments, with respect to method 900, at least of one of its steps may be execute out of numerical order with respect to the step reference numerals. In some embodiments, with respect to method 900, at least of one its steps may be optional and/or omitted. In some embodiments, method 900 may be applicable to system 300 (or a portion of system 300) and/or to portions of FIG. 1A and/or FIG. 1B. In some embodiments, method 900 may be applicable to FIG. 1D to FIG. 3.

Continuing discussing FIG. 9, in some embodiments, step 907 may be sub-step of step 707. In some embodiments, step 907 may feed into step 707. In some embodiments, step 907 may replace step 907. In some embodiments, step 907 may replace using sensor(s) 507 of a given electronic-device 107 to detect and/or to determine presence of a person 117 at a given table 109 and/or at a given seat 111. In some embodiments, step 907 may augment and/or may complement step 707. In some embodiments, step 907 may augment and/or may complement using sensor(s) 507 of a given electronic-device 107 to detect and/or to determine presence of a person 117 at a given table 109 and/or at a given seat 111. In some embodiments, step 907 may be a step of receiving person 117 presence/occupancy data (if present) from at least one mobile-computing-device 129 that has obtained (received) presence data (occupancy data) from a given tag 301. In some embodiments, mobile-computing-device 129 may receive this presence data (occupancy data) from the given tag 301 via (wireless) communication 303 of FIG. 3 of mobile-computing-device 129 being in sufficient proximity to at least one tag 301 of the given table 109 and/or of the given seat 111, to both energize that tag 301 and to then receive the presence data (occupancy data) from that tag 301. In some embodiments, once that mobile-computing-device 129 has received this presence data (occupancy data) from tag 301, then 129 may send (transmit and/or provide) this presence data (occupancy data) to the given electronic-device 107 (e.g., via communication 201 of FIG. 3). In some embodiments, the presence data (occupancy data) provided by tag 301 may not be true presence data (occupancy data) as it may not contain (comprise) actual presence, occupancy, and/or location information for a given person 117 at the given table 109 and/or at the given seat 111. In some embodiments, the presence data (occupancy data) provided by tag 301 may not be true presence data (occupancy data), but may be a proxy that serves as presence data (occupancy data). In some embodiments, the presence data (occupancy data) provided by tag 301 may not be true presence data (occupancy data), but may instead be data of a particular seat 111 and/or of a particular table 109 within the given accommodation premises. In some embodiments, at least partial execution of step 907 may cause method 900 to transition to executing step 707.

In some embodiments, system 100 may be for indicating occupancy status of locations 111 within a given accommodation premises. In some embodiments, system 100 may comprise: at least one point-of-purchase-device 101 (POP-device 101); at least one code-reader 107a; at least one presence-detector-device 107c; and at least one occupancy-status-indicator-device 107b. In some embodiments, the at least one point-of-purchase-device 101 may be configured to provide and/or to generate at least one code 105. In some embodiments, the at least one code-reader 107a may be configured to (receive and) read the at least one code 105. In some embodiments, the at least one presence-detector-device 107c may be configured to detect a presence of at least one person 117 at at least one intended-occupancy-location 111 (within that given accommodation premises). In some embodiments, the at least one occupancy-status-indicator-device 107b may be configured to indicate the occupancy status of the at least one intended-occupancy-location 111 based on reading (checking) of the at least one code 105 and/or based on (checking) data (presence data) from the at least one presence-detector-device 107c. In some embodiments, the at least one point-of-purchase-device 101, the at least one code-reader 107a, the at least one occupancy-status-indicator-device 107b, and/or the at least one presence-detector-device 107c may (all) be located within the given accommodation premises (although in some embodiments, the POP-device 101 may be located outside of the given accommodation premises). In some embodiments, the given accommodation premises may be selected from at least one of: a restaurant, a cafe, a coffee shop, a tea house, a tea shop, a cafeteria, a bistro, an eatery, a bar, a pub, a tavern, a grill, a diner, a mess hall, a dining hall, a brewery, a concession stand, a full service restaurant, a fine dining restaurant, a self-seating restaurant, a self-serve restaurant, a library, a bookstore, a portion thereof, combinations thereof, and/or the like. In some embodiments, the at least one intended-occupancy-location 111 may be (selected, picked, pulled, and/or found) from the locations 111 within the given accommodation premises. In some embodiments, the at least one intended-occupancy-location 111 may be selected from at least one of: a table 109, a tabletop, a countertop, a bar-top, a seat, a chair, a stool, a booth, a designated place for a person 117 to stand, combinations thereof, and/or the like. In some embodiments, the at least one point-of-purchase-device 101 (of system 100, 200, and/or 300) may be is at least one of: an electronic-device 107/500, a computing-device 500, a kiosk, a device that is configured for facilitating proximity-based purchase transactions, a device that is configured for facilitating credit card transactions, a handheld device, a register, a cash register, a mobile-computing-device 129, a hub 115, a computer-server 125, a portion thereof, combinations thereof, and/or the like. In some embodiments, the at least one point-of-purchase-device 101 may be configured for facilitating purchase transactions. In some embodiments, the at least one point-of-purchase-device 101 may be configured to provide the at least one code 105 upon completing a purchase transaction and/or upon receiving payment (even if funds may take several days to actually post to an account after a date of the given transaction). In some embodiments, the purchase transactions (that POP-device(s) 101 may be capable of facilitating) may be for at least one of: purchase of food, purchase of beverage, renting of occupancy usage of the at least one intended-occupancy-location 111 (of the given accommodation premises). In some embodiments, the at least one code 105 may be printed on paper and/or the at least one code 105 may be configured to be displayed upon a screen of at least one mobile-computing-device 129. In some embodiments, the at least one mobile-computing-device 129 may be selected from at least one of: a smartphone, a smartwatch, a laptop computer, a tablet computer, combinations thereof, and/or the like. In some embodiments, the at least one code 105 may comprise content that is selected from at least one of: a QR code, a 2D code, a bar code, an optical readable code, a machine-readable code, a numeric code, an alphanumeric code, a one-time use code, a portion thereof, combinations thereof, and/or the like. In some embodiments, upon the at least one code-reader 107a (receiving and) reading the at least one code 105, then the at least one code-reader 107a may (wirelessly) communicate with a device to verify that the at least one code 105 is valid. In some embodiments, that device (that receives the at least one code 105 from the at least one code-reader 107a) may non-transitorily store a copy (or the original) of the at least one code 105 that was provided (generated) by the at least one point-of-purchase-device 101. In some embodiments, that device (that receives the at least one code 105 from the at least one code-reader 107a) may be selected from at least one of: the at least one point-of-purchase-device 101, at least one hub 115, or at least one computer-server 125. In some embodiments, the at least one hub 115 and/or the at least one computer-server 125 may be in (wireless and/or wired) communication with the at least one point-of-purchase-device 101. In some embodiments, the at least one presence-detector-device 107c may comprise at least one sensor 507 that may be configured to detect the presence of the at least one person 117 at the at least one intended-occupancy-location 111. In some embodiments, the at least one presence-detector-device 107c may be (physically) linked to the at least one intended-occupancy-location 111 by the at least one presence-detector-device 107c being in direct physical communication with the at least one intended-occupancy-location 111; and/or by the at least one presence-detector-device 107c being oriented so that a field-of-view 411 of at least one sensor 507 of the at least one presence-detector-device 107c may be directed (oriented) to monitor the at least one intended-occupancy-location 111. In some embodiments, system 100 (and/or 200 and/or 300) may comprise at least one electronic-device 107. In some embodiments, the at least one electronic-device 107 may comprise both the at least one code-reader 107a and the at least one presence-detector-device 107c, such that the at least one code-reader 107a and the at least one presence-detector-device 107c are both part of a single (integral) device 107, namely, the at least one electronic-device 107. In some embodiments, the at least one occupancy-status-indicator-device 107b may comprises at least one status indicator 513 that may be configured to indicate the occupancy status of the at least one intended-occupancy-location 111. In some embodiments, the at least one status indicator 513 may be a different colored light for each different occupancy status of the at least one intended-occupancy-location 111 (being monitored). In some embodiments, the at least one status indicator 513 may be configured to emit a different colored light for each different occupancy status of the at least one intended-occupancy-location 111 (being monitored). In some embodiments, the at least one status indicator 513 may be configured to display a different colored light for each different occupancy status of the at least one intended-occupancy-location 111 (being monitored).

In some embodiments, the occupancy status (for a given intended-occupancy-location 111) may comprise (and/or is selectable from) at least three different statuses of a first-status, a second-status, and a third-status. In some embodiments, the first-status may indicate that the at least one intended-occupancy-location 111 is currently vacant and ready for occupancy. In some embodiments, the second-status may indicate that the at least one intended-occupancy-location 111 is currently properly occupied (and with occupancy paid for). In some embodiments, the third-status may indicate that the at least one intended-occupancy-location 111 is currently improperly occupied (e.g., because has not been paid for or not properly paid for). In some embodiments, the occupancy status may further comprise (and/or is selectable from) a fourth-status. In some embodiments, the fourth-status may indicate that the second-status is expiring soon (e.g., the timer of step 715 may almost be complete [finished]). In some embodiments, a given status (e.g., the second-status) (for a given intended-occupancy-location 111) may “expire soon” may mean that the step 715 timer may almost be complete (finished). In some embodiments, this “expire soon” threshold (trigger) may be coded (programmed) for in the software running on the given electronic-device 107 (and/or hub 115 and/or computer-server 125) that may be triggered when a certain amount of time remains on the timer or when a certain amount of time has already transpired on the timer. In some embodiments, this “expire soon” fourth-status (e.g., step 727) may be triggered when a certain amount of time remains on the timer or when a certain amount of time has already transpired on the timer. In some embodiments, this “expire soon” fourth-status (e.g., step 727) may be triggered when a certain amount of time remains on the timer such as, but not limited, to a specific amount of time (e.g., 10 minutes, or 5 minutes, or 2 minutes, or 1 minute). In some embodiments, this “expire soon” fourth-status (e.g., step 727) may be triggered when a certain amount of time remains on the timer such as, but not limited, to a specific percentage of time remains before the timer finishes (e.g., 20% remaining, or 15 % remaining, or 10% remaining, or 5% remaining, or 2% remaining, or 1% remaining). In some embodiments, this “expire soon” fourth-status (e.g., step 727) may be triggered when a certain amount of time has already transpired on the timer such as, but not limited, to a specific percentage of time already consumed (e.g., 80% of time consumed, or 85 % of time consumed, or 90% of time consumed, or 95% of time consumed, or 98% of time consumed, or 99% of time consumed). In some embodiments, this “expire soon” fourth-status (e.g., step 727) may be displayed on a screen 509 of computing-device 500 as a countdown to when the timer has completed (finished) for that given occupancy session at that given intended-occupancy-location 111. In other embodiments, other specific amounts of time or percentage of time may be used with respect to the fourth-status and/or for step 727. In some embodiments, the occupancy status may further comprise (and/or is selectable from) a fifth-status. In some embodiments, the fifth-status may indicate that the at least one intended-occupancy-location 111 is in need of cleaning or maintenance. In some embodiments, the at least one occupancy-status-indicator-device 107b may be located in a public area of the accommodation premises (e.g., for non-fine-dining establishments or for other accommodation premises that do not mind having occupancy-status-indicator-devices 107b be publicly located). In some embodiments, the at least one occupancy-status-indicator-device 107b may be viewable from a public area of the accommodation premises. “Public area” and/or “publicly” or the like in this context may be areas of the given accommodation premises where the public, customers, and/or patrons are generally expected to be. In some embodiments, the at least one occupancy-status-indicator-device 107b may be (physically) linked to the at least one intended-occupancy-location 111 by the at least one occupancy-status-indicator-device 107b in direct physical communication with the at least one intended-occupancy-location 111 or by the at least one occupancy-status-indicator-device being located in (close) proximity to the at least one intended-occupancy-location 111 such that the at least one occupancy-status-indicator-device 107b and the at least one intended-occupancy-location 111 are closer together (to each other) than as compared to other-occupancy-status-indicator-devices and to other-intended-occupancy-locations. In some embodiments, the at least one electronic-device 107 (of system 100, 200, and/or 300) may comprise at least two of the following in a single device: the at least one code-reader 107a, the at least one presence-detector-device 107c, and/or the at least one occupancy-status-indicator-device 107b. With respect to system 100, see e.g., FIG. 1A to FIG. 1E, FIG. 4A to FIG. 4C, FIG. 6A to FIG. 6B, and FIG. 7.

In some embodiments, system 200 and/or 300 (hereinafter, system 200/300) may be for indicating occupancy status of locations within a given accommodation premises. In some embodiments, system 200/300 may comprise: mobile-app-software non-transitorily stored on and executed from at least one mobile-computing-device 129 of a customer 117 of the given accommodation premises; at least one electronic-device 107; at least one presence-detector-device 107c; and/or at least one occupancy-status-indicator-device 107b. In some embodiments, execution of the mobile-app-software (running on the at least one mobile-computing-device 129 of the customer 117) may be configured to generate (and/or to provide) or to receive at least one digital authorization when that customer 117 has completed a financial transaction with that given accommodation premises. In some embodiments, the at least one electronic-device 107 may be configured to (wirelessly) receive the at least one digital authorization from the at least one mobile-computing-device 129 of the customer 117. In some embodiments, the at least one presence-detector-device 107c may be configured to detect a presence of at least one person 117 at (on and/or in) at least one intended-occupancy-location 111. In some embodiments, the at least one occupancy-status-indicator-device 107b may be configured to indicate the occupancy status of the at least one intended-occupancy-location 111 based on (checking a digital authorization from a) wireless communication between the at least one electronic-device 107 and the at least one mobile-computing-device 129 of the customer 117; and/or based on data (presence data) from the at least one at least one presence-detector-device 107c. In some embodiments, the given accommodation premises (of system 200/300) may be selected from at least one of: a restaurant, a cafe, a coffee shop, a tea house, a tea shop, a cafeteria, a bistro, an eatery, a bar, a pub, a tavern, a grill, a diner, a mess hall, a dining hall, a brewery, a concession stand, a full service restaurant, a fine dining restaurant, a self-seating restaurant, a self-serve restaurant, a library, a bookstore, a portion thereof, combinations thereof, and/or the like. In some embodiments, the at least one intended-occupancy-location 111 may be (selected) from the locations 111 of the given accommodation premises. In some embodiments, the at least one intended-occupancy-location 111 may be selected from at least one of: a table 109, a tabletop, a countertop, a bar-top, a seat, a chair, a stool, a booth, a designated place for a person 117 to stand, a portion thereof, combinations thereof, and/or the like. In some embodiments, the at least one mobile-computing-device 129 of the customer 117 may be selected from at least one of: a smartphone, a smartwatch, a laptop computer, a tablet computer, combinations thereof, and/or the like. In some embodiments, the financial transaction may be executed (at least partially) on the at least one mobile-computing-device 129 of the customer 117 and/or the financial transaction may be executed (at least partially) on at least one point-of-purchase-device 101. In some embodiments, the at least one point-of-purchase-device 101 may be at least one of: an electronic-device 107/500, a computing-device 500, a kiosk, a device that is configured for facilitating proximity-based purchase transactions, a device that is configured for facilitating credit card transactions, a handheld device, a register, a cash register, a mobile-computing-device 129, a portion thereof, combinations thereof, and/or the like. In some embodiments, the financial transaction may be for at least one of: purchase of food, purchase of beverage, renting of occupancy usage of the at least one intended-occupancy-location 111, combinations thereof, and/or the like. In some embodiments, any purchased food and/or beverage may be provided onsite at the given accommodation premises (e.g., for consumption at the given accommodation premises and/or for take-home). In some embodiments, the at least one digital authorization may be configured to be transmitted (sent) from the at least one mobile-computing-device 129 of the customer 117 to the at least one electronic-device 107. In some embodiments, the at least one digital authorization may be configured to be received at the at least one electronic-device 107 from the at least one mobile-computing-device 129 of the customer 117. In some embodiments, the at least one digital authorization may be selected from at least one of: a digital token, a digital certificate, a digital credential, a machine-readable code, a numeric code, an alphanumeric code, a one-time use code, a portion thereof, combinations thereof, and/or the like. In some embodiments, the at least one digital authorization may be encrypted. In some embodiments, upon the at least one electronic-device 107 receiving the at least one digital authorization from the at least one mobile-computing-device 129 of the customer 117, then the at least one electronic-device 107 may communicate with a device to verify that the at least one digital authorization is valid. In some embodiments, that device (that received the at least one digital authorization from the at least one electronic-device 107) may non-transitorily store the at least one digital authorization. In some embodiments, that device (that received the at least one digital authorization from the at least one electronic-device 107) may be selected from at least one of: at least one point-of-purchase-device 101, at least one hub 115, or at least one computer-server 125. In some embodiments, validation (verification) of the at least one digital authorization received may not be done directly on the at least one mobile-computing-device 129 of the customer 117. In some embodiments, the at least one hub 115 and/or the at least one computer-server 125 may be in (wireless and/or wired) communication with the at least one point-of-purchase-device 101. In some embodiments, the at least one presence-detector-device 107c may comprise at least one sensor 507 that may be configured to detect the presence of the at least one person 117 at the at least one intended-occupancy-location 111. In some embodiments, the at least one presence-detector-device 107c may be (physically) linked to the at least one intended-occupancy-location 111 by the at least one presence-detector-device 107c being in direct physical communication with the at least one intended-occupancy-location 111; and/or by the at least one presence-detector-device 107c being oriented so that a field-of-view 411 of at least one sensor 507 of the at least one presence-detector-device 107c may be (pointed) directed (oriented) to monitor the at least one intended-occupancy-location 111. In some embodiments, the at least one electronic-device 107 may comprise the at least one presence-detector-device 107c, such that the at least one electronic-device 107 and the at least one presence-detector-device 107c are a single device 107. In some embodiments, the at least one occupancy-status-indicator-device 107b may comprise at least one status indicator 513 that may be configured to indicate the occupancy status of the at least one intended-occupancy-location 111. In some embodiments, the at least one status indicator 513 may be a different colored light for each different occupancy status of the at least one intended-occupancy-location 111. In some embodiments, the at least one status indicator 513 may be configured to emit a different colored light for each different occupancy status of the at least one intended-occupancy-location 111. In some embodiments, the at least one status indicator 513 may be configured to display a different colored light for each different occupancy status of the at least one intended-occupancy-location 111. In some embodiments, the occupancy status may comprise (and/or is selectable from) at least three different statuses of a first-status, a second-status, and a third-status. In some embodiments, the first-status may indicate that the at least one intended-occupancy-location 111 is currently vacant and ready for occupancy. In some embodiments, the second-status may indicate that the at least one intended-occupancy-location 111 is currently properly occupied. In some embodiments, the third-status may indicate that the at least one intended-occupancy-location 111 is currently improperly occupied (e.g., because is not properly paid for). In some embodiments, the occupancy status may further comprise (and/or is selectable from) a fourth-status. In some embodiments, the fourth-status may indicate that the second-status may be expiring soon. In some embodiments, the occupancy status may further comprise (and/or is selectable from) a fifth-status. In some embodiments, the fifth-status may indicate that the at least one intended-occupancy-location 111 is in need of cleaning or maintenance. In some embodiments, the at least one occupancy-status-indicator-device 107b may be located in a public area of the given accommodation premises. In some embodiments, the at least one occupancy-status-indicator-device 107b may be viewable from a public area of the given accommodation premises. “Public area” and/or “publicly” or the like in this context may be areas of the given accommodation premises where the public, customers, and/or patrons are generally expected to be. In some embodiments, the at least one occupancy-status-indicator-device 107b may be (physically) linked (associated) to the at least one intended-occupancy-location 111 by the at least one occupancy-status-indicator-device 107b being in direct physical communication with the at least one intended-occupancy-location 111 or by the at least one occupancy-status-indicator-device 107b being located in (close) proximity to the at least one intended-occupancy-location 111 such that the at least one occupancy-status-indicator-device 107b and the at least one intended-occupancy-location 111 are closer together (to each other) than as compared to other-occupancy-status-indicator-devices and to other-intended-occupancy-locations. In some embodiments, the at least one electronic-device 107 may comprise at least one of the following: the at least one presence-detector-device 107c, and/or the at least one occupancy-status-indicator-device 107b. In some embodiments, with respect to system 200/300 see e.g., at least a portion of FIG. 1A; and see FIG. 1D, FIG. 1E, FIG. 2, FIG. 3, FIG. 4A to FIG. 4C, FIG. 6A to FIG. 6B, FIG. 8, and/or FIG. 9.

In some embodiments, method 700 may be a method for indicating occupancy status of locations 111 within a given accommodation premises. In some embodiments, method 700 may comprise steps of: step (a), step (b), step (c), step (d), step (e), and step (f). In some embodiments, step (a) may be a step of generating (providing) at least one code 105. In some embodiments, the at least one code 105 may be generated (provided) by a first-device. In some embodiments, step (a) of method 700 may be step 703 (or a portion thereof). In some embodiments, step (b) may be a step of receiving the at least one code 105 at at least one code-reader 107a (that may be located within the given accommodation premises). In some embodiments, step (b) of method 700 may be step 705 (or a portion thereof). In some embodiments, step (c) may be a step of receiving presence data from at least one presence-detector-device 107c that may be configured to monitor at least one intended-occupancy-location 111 of the given accommodation premises. In some embodiments, step (c) of method 700 may be step 707 (or a portion thereof). In some embodiments, step (d) may be a step of checking if the at least code 105 received in the step (b) may be valid. In some embodiments, step (d) of method 700 may be step 709 (or a portion thereof). In some embodiments, step (e) may be a step of checking if the presence data received in the step (c) indicates that at least one person 117 may be occupying the at least one intended-occupancy-location 111. In some embodiments, step (e) of method 700 may be step 709 (or a portion thereof). In some embodiments, step (f) may be a step of indicating, on (by) at least one occupancy-status-indicator-device 107b, the occupancy status of the at least one intended-occupancy-location 111 based on the at least one code 105 checked in the step (d) and/or based on the presence data checked in the step (e). In some embodiments, step (f) of method 700 may be step 713, step 717, step 719, or step 727 (or a portion of such step(s)). In some embodiments, the given accommodation premises may be selected from at least one of: a restaurant, a cafe, a coffee shop, a tea house, a tea shop, a cafeteria, a bistro, an eatery, a bar, a pub, a tavern, a grill, a diner, a mess hall, a dining hall, a brewery, a concession stand, a full service restaurant, a fine dining restaurant, a self-seating restaurant, a self-serve restaurant, a library, a bookstore, a portion thereof, combinations thereof, and/or the like. In some embodiments, the at least one intended-occupancy-location 111 may be (selected) from the locations 111 within the given accommodation premises. In some embodiments, the at least one intended-occupancy-location 111 may be selected from at least one of: a table 109, a tabletop, a countertop, a bar-top, a seat, a chair, a stool, or a booth, a designated area for a person 117 to stand, a portion thereof, combinations thereof, and/or the like. In some embodiments, a given intended-occupancy-location 111 may be four feet or less from a given table 109 or the like. In some embodiments, a given intended-occupancy-location 111 may be three feet or less from a given table 109 or the like. In some embodiments, method 700 may comprise a step 701 of receiving a payment. In some embodiments, the step 701 of receiving the payment may be executed prior to execution of the step (a) (step 703). In some embodiments, execution of step 701 may advance method 700 to the step (a). In some embodiments, the step 701 of receiving the payment may be for at least one of: purchase of food, purchase of beverage, renting of occupancy usage of the at least one intended-occupancy-location 111 within the given accommodation premises (for some finite amount of time), combinations thereof, and/or the like. In some embodiments, the step 701 of receiving the payment may be executed by at least one point-of-purchase-device 101. In some embodiments, the at least one point-of-purchase-device 101 may be further configured to (generate and/or) provide at least one code 105 upon completing a purchase transaction for that given accommodation premises. In some embodiments, the at least one point-of-purchase-device 101 may be at least one of: an electronic-device 107/500, a computing-device 500, a kiosk, a device that is configured for facilitating proximity-based purchase transactions, a device that is configured for facilitating credit card transactions, a handheld device, a register, a cash register, a mobile-computing-device 129, a portion thereof, combinations thereof, and/or the like. In some embodiments, the first-device that generated (and/or provided) the at least one code 105 in the step (a) (step 703) may be selected from at least one of: at least one point-of-purchase-device 101, at least one hub 115, or at least one computer-server 125. In some embodiments, the at least one code 105 may be printed on paper 103 and/or the at least one code 105 may be configured to be displayed upon a screen of a mobile-computing-device 129 (and/or a screen of another computing-device 500). In some embodiments, the at least one code 105 may be physically printed and/or may be digital (and/or electronic) (e.g., as in an electronic and/or a digital record [file]). In some embodiments, the mobile-computing-device 129 may be selected from at least one of: a smartphone, a smartwatch, a laptop computer, a tablet computer, a portion thereof, combinations thereof, and/or the like. Such devices manufactured by Apple (e.g., iPhones, iPads, Watch), Samsung (e.g., Android smartphones), Google, Toshiba, IBM, and/or the like may be incorporated by reference. In some embodiments, the at least one code 105 may comprise content that is selected from at least one of: a QR code, a 2D code, a bar code, an optical readable code, a machine-readable code, a numeric code, an alphanumeric code, a one-time use code, a portion thereof, combinations thereof, and/or the like. In some embodiments, the step (d) (step 709) checking if the at least code 105 received at the at least one code-reader 107a in the step (b) (step 705) is valid may be executed by the at least one code-reader 107a sending (transmitting and/or communicating) the received at least one code 105 to a second-device (for that second-device to perform the check, verification, and/or validation). In some embodiments, to perform that check, verification, and/or validation that second-device may compare the at least one code 105 received from the at least one code-reader 107a to a copy (or to an original) of the at least one code 105 that was generated in the step (a) (step 703) generated by the first-device. In some embodiments, when the code 105 may be first generated, code 105 (either as an original file and/or as a copied file) may be non-transitorily stored in storage 505 of the first-device and/or of the second-device for use as a reference in the step 709 (step (d)) check. In some embodiments, the first-device and the second-device are a same device (such as, but not limited to, both being the same POP-device 101). In some embodiments, the first-device and the second-device may be two separate and different devices (such as, but not limited to, the first-device a POP-device 101 and the second-device being a hub 115). In some embodiments, the second-device may be selected from at least one of: at least one point-of-purchase-device 101, at least one hub 115, or at least one computer-server 125. In some embodiments, when the first-device and the second-device are different devices, then the first-device and the second-device may be in (at least intermittent) communication with each other. In some embodiments, the at least one presence-detector-device 107c may comprises at least one sensor 507 that may be configured to detect a presence of the at least one person 117 at the at least one intended-occupancy-location 111. In some embodiments, the at least one presence-detector-device 107c may be (physically) linked (associated) to the at least one intended-occupancy-location 111 by the at least one presence-detector-device 107c being in direct physical communication with the at least one intended-occupancy-location 111 and/or by the at least one presence-detector-device 107c being oriented so that a field-of-view 411 of at least one sensor 507 of the at least one presence-detector-device 107c is directed (oriented/pointed) to monitor the at least one intended-occupancy-location 111. In some embodiments, the at least one occupancy-status-indicator-device 107b may comprise at least one status indicator 513 that may be configured to indicate the occupancy status of the at least one intended-occupancy-location 111. In some embodiments, the at least one status indicator 513 may be a different colored light for each different occupancy status of the at least one intended-occupancy-location 111. In some embodiments, the at least one status indicator 513 may be configured to emit a different colored light for each different occupancy status of the at least one intended-occupancy-location 111. In some embodiments, the at least one status indicator 513 may be configured to be displayed as a different colored light for each different occupancy status of the at least one intended-occupancy-location 111. In some embodiments, the occupancy status may comprise (and/or is selectable from) at least three different statuses of a first-status, a second-status, and a third-status. In some embodiments, the first-status may indicate that the at least one intended-occupancy-location 111 may be currently vacant and ready for occupancy (see e.g., step 717). In some embodiments, the second-status may indicate that the at least one intended-occupancy-location 111 may be currently properly occupied (see e.g., step 713). In some embodiments, the third-status may indicate that the at least one intended-occupancy-location 111 may be currently improperly occupied (see e.g., step 719). In some embodiments, the occupancy status may further comprise (and/or is selectable from) a fourth-status. In some embodiments, the fourth-status may indicate that the second-status is expiring soon (see e.g., step 727). In some embodiments, the occupancy status may further comprise (and/or is selectable from) a fifth-status. In some embodiments, the fifth-status may indicate that the at least one intended-occupancy-location 111 may be in current (present) need of cleaning or maintenance. In some embodiments, the at least one occupancy-status-indicator-device 107b may be located in a public area of the given accommodation premises. In some embodiments, the at least one occupancy-status-indicator-device 107b may be viewable from a public area of the given accommodation premises. “Public area” and/or “publicly” or the like in this context may be areas of the given accommodation premises where the public, customers, and/or patrons are generally expected to be. In some embodiments, the at least one occupancy-status-indicator-device 107b may be (physically) linked to (associated with) the at least one intended-occupancy-location 111 by the at least one occupancy-status-indicator-device 107b being in direct physical communication with the at least one intended-occupancy-location 111 or by the at least one occupancy-status-indicator-device 107b being located in (close) proximity to the at least one intended-occupancy-location 111 such that the at least one occupancy-status-indicator-device 107b and the at least one intended-occupancy-location 111 are closer together (to each other) than as compared to other-occupancy-status-indicator-devices and other-intended-occupancy-locations. In some embodiments, with respect to method 700 see e.g., FIG. 7 and see figures that may be at least partially applicable to system 100, such as, FIG. 1A to FIG. 1E, FIG. 4A to FIG. 4C, FIG. 6A to FIG. 6B.

In some embodiments, method 800 and/or 900 (hereinafter, method 800/900) may be a method for indicating occupancy status of locations 111 within a given accommodation premises. In some embodiments, method 800/900 may comprise steps of: step (a), step (b), step (c), step (d), step (e), and step (f). In some embodiments, step (a) may be a step of generating (and/or providing) at least one digital authorization. In some embodiments, the at least one digital authorization may be generated (and/or provided) by a first-device. In some embodiments, the step (a) may be the same as step 803 or a portion thereof. In some embodiments, step (b) may be a step of receiving the at least one digital authorization at at least one electronic-device 107 that may be located within the given accommodation premises. In some embodiments, this receiving the at least one digital authorization at the at least one electronic-device 107 may involve wireless communication and/or a digital handshake between that at least one electronic-device 107 and the first-device. In some embodiments, the step (b) may be the same as step 805 or a portion thereof. In some embodiments, step (c) may be a step of receiving presence data from at least one presence-detector-device 107c that may be configured to monitor at least one intended-occupancy-location 111 within that given accommodation premises. In some embodiments, the step (c) may be the same as step 707 (of method 800/900) or a portion thereof. In some embodiments, step (d) may be a step of checking if the at least one digital authorization received in the step (b) is valid (or the like). In some embodiments, the step (d) may be the same as step 809 or a portion thereof. In some embodiments, step (e) may be a step of checking if the presence data received in the step (c) indicates that at least one person 117 may be (properly) occupying the at least one intended-occupancy-location 111 within that given accommodation premises. In some embodiments, the step (e) may be the same as step 809 or a portion thereof. In some embodiments, step (f) may be a step of indicating on at least one occupancy-status-indicator-device 107b the occupancy status (of which there may be different occupancy statutes) of the at least one intended-occupancy-location 111 (within the given accommodation premises) based on the at least one digital authorization checked in the step (d) and/or based on the presence data checked in the step (e). In some embodiments, the step (f) may be the same as step 717 (of method 800/900), step 713 (of method 800/900), step 719 (of method 800/900), step 727 (of method 800/900), or a portion thereof. In some embodiments, the given accommodation premises may be selected from at least one of: a restaurant, a cafe, a coffee shop, a tea house, a tea shop, a cafeteria, a bistro, an eatery, a bar, a pub, a tavern, a grill, a diner, a mess hall, a dining hall, a brewery, a concession stand, a full service restaurant, a fine dining restaurant, a self-seating restaurant, a self-serve restaurant, a library, a bookstore, a portion thereof, combinations thereof, and/or the like. In some embodiments, the at least one intended-occupancy-location 111 may be (selected) from the locations 111. In some embodiments, a particular accommodation premises may have (may comprise) at least one location 111 (e.g., one seat 111); however, most accommodation premises will have (will comprise) a plurality of locations 111. In some embodiments, the at least one intended-occupancy-location 111 may merely be one particular location 111 from all the locations 111 of that given accommodation premises. For example, and without limiting the scope of the present invention, the at least one intended-occupancy-location 111 may be a location 111 that a given person 117 may be presently trying to occupy or may already be occupying or may refer to a vacant location 111. In some embodiments, the at least one intended-occupancy-location 111 may be selected from at least one of: a table 109, a tabletop, a countertop, a bar-top, a seat, a chair, a stool, a booth, a portion thereof, combinations thereof, and/or the like. In some embodiments, the method 800/900 may comprise a step 701 of receiving a payment. In some embodiments, the step 701 of receiving the payment may be executed prior to execution of the step (a) of method 800/900 (step 803). In some embodiments, execution of step 701 may advance method 800/900 to the step (a) of method 800/900. In some embodiments, the step 701 of receiving the payment may be for at least one of: purchase of food, purchase of beverage, renting of occupancy usage of the at least one intended-occupancy-location 111 of the given accommodation premises, combinations thereof, and/or the like. In some embodiments, the step 701 of receiving the payment may be executed by at least one point-of-purchase-device 101. In some embodiments, the at least one point-of-purchase-device 101 may be further configured to (generate and/or) provide the at least one digital authorization upon completing a purchase transaction at/for that given accommodation premises. In some embodiments, the at least one point-of-purchase-device 101 may be at least one of: an electronic-device 107/500, a computing-device 500, a kiosk, a device that is configured for facilitating proximity-based purchase transactions, a device that is configured for facilitating credit card transactions, a handheld device, a register, a cash register, a mobile-computing-device, a portion thereof, combinations thereof, and/or the like. In some embodiments, the first-device that generated (and/or that provided) the at least one digital authorization in the step (a) may be selected from at least one of: at least one point-of-purchase-device 101, at least one hub 115, at least one computer-server 125, or a mobile-computing-device 129. In some embodiments, if the at least one digital authorization is generated on a first-device (e.g., a POP-device 101, a hub 115, or a computer-server 125) that is not a mobile-computing-device 129 of a customer 117, then that first-device may communicate that at least one digital authorization to the mobile-computing-device 129 of the customer 117 to, so that the customer 117 mobile-computing-device 129 may then be able to communicate that at least one digital authorization to a given electronic-device 107 associated with a given table 109 and/or with a given intended-occupancy-location 111. However, in some embodiments, the software (mobile app) running on the customer 117 mobile-computing-device 129 may be configured to generate this at least one digital authorization (e.g., after completing a purchase/financial transaction at/for that given accommodation premises). In some embodiments, the at least one digital authorization may be configured to be transmitted (sent and/or communicated) from at least one mobile-computing-device 129 of a customer 117 to the at least one electronic-device 107. In some embodiments, the at least one digital authorization may be configured to be received at the at least one electronic-device 107 from the at least one mobile-computing-device 129 of a customer 117. In some embodiments, the at least one digital authorization may be selected from at least one of: a digital token, a digital certificate, a digital credential, a machine-readable code, a numeric code, an alphanumeric code, a one-time use code, a portion thereof, combinations thereof, and/or the like. In some embodiments, the at least one digital authorization may be encrypted. In some embodiments, the step (d) (step 809) checking if the at least one digital authorization received at the at least one electronic-device 107 in the step (b) (step 805) is valid may be executed by the at least one electronic-device 107 sending (transmitting and/or communicating) the at least one digital authorization of the step (b) (step 805) to a second-device. In some embodiments, the second-device may perform this step (d) (step 809) by comparing the at least one digital authorization received from the at least one electronic-device 107 to a reference copy/version of the at least one digital authorization that was generated in the step (a) generated by the first-device. In some embodiments, the first-device and the second-device are a same device. In some embodiments, when the first-device and the second-device are the same device, then the second-device (which is the first-device) may already have in its storage 505 the at least one digital authorization file (e.g., as a copy and/or as an original file) to be used in this step (d) (step 809) validation check. In some embodiments, when the first-device and the second-device are different devices, then the first-device and the second-device may be in (at least intermittent) communication with each other. In some embodiments, the second-device may be selected from at least one of: at least one point-of-purchase-device 101, at least one hub 115, or at least one computer-server 125. In some embodiments, when the first-device and the second-device are different devices, then the first-device may provide a reference copy of the original at least one digital authorization generated in the step (a) (step 803) to the second-device for use in the step (d) (step 809) validation check. In some embodiments, the at least one presence-detector-device 107c may comprise at least one sensor 507 that may be configured to detect a presence of the at least one person 117 at the at least one intended-occupancy-location 111 (within the given accommodation premises). In some embodiments, the at least one presence-detector-device 107c may be linked to (associated with) the at least one intended-occupancy-location 111 by the at least one presence-detector-device 107c being in direct physical communication with the at least one intended-occupancy-location 111 and/or by the at least one presence-detector-device 107c being oriented so that a field-of-view 411 of at least one sensor 507 of the at least one presence-detector-device 107c may be directed (oriented/pointed) to monitor the at least one intended-occupancy-location 111. In some embodiments, the at least one occupancy-status-indicator-device 107b may comprise at least one status indicator 513 that may be configured to indicate the occupancy status of the at least one intended-occupancy-location 111. In some embodiments, the at least one status indicator 513 may be a different colored light for each different occupancy status of the at least one intended-occupancy-location 111. In some embodiments, the at least one status indicator 513 may be configured to emit (shine) a different colored light for each different occupancy status of the at least one intended-occupancy-location 111. In some embodiments, the at least one status indicator 513 may be configured to be displayed as a different colored light for each different occupancy status of the at least one intended-occupancy-location 111. In some embodiments, the occupancy status may comprise (and/or is selectable from) at least three different statuses of a first-status, a second-status, and a third-status. In some embodiments, the first-status may indicate that the at least one intended-occupancy-location 111 may be currently vacant and ready for occupancy. In some embodiments, the second-status may indicate that the at least one intended-occupancy-location 111 may be currently properly occupied. In some embodiments, the third-status may indicate that the at least one intended-occupancy-location 111 may be currently improperly occupied. In some embodiments, the occupancy status further may comprise (and/or is selectable from) a fourth-status. In some embodiments, the fourth-status may indicate that the second-status may be expiring soon. In some embodiments, the occupancy status further may comprise (and/or is selectable from) a fifth-status. In some embodiments, the fifth-status may indicate that the at least one intended-occupancy-location 111 may be in need of cleaning and/or maintenance. Note, the first, second, third, fourth, fifth and the like designations may be arbitrary and/or only used herein for clarity and tracking purposes, but in implementation these designations could be different. In some embodiments, the at least one occupancy-status-indicator-device 107b may be located in a public area of the accommodation premises. In some embodiments, the at least one occupancy-status-indicator-device 107b may be viewable from a public area of the accommodation premises. “Public area” and/or “publicly” or the like in this context may be areas of the given accommodation premises where the public, customers, and/or patrons are generally expected to be. In some embodiments, the at least one occupancy-status-indicator-device 107b may be linked to (associated with) the at least one intended-occupancy-location 111 by the at least one occupancy-status-indicator-device 107b being in direct physical communication with the at least one intended-occupancy-location 111 or by the at least one occupancy-status-indicator-device 107b being located in (relatively close) proximity to the at least one intended-occupancy-location 111 such that the at least one occupancy-status-indicator-device 107b and the at least one intended-occupancy-location 111 are closer together to each other than as compared to other-occupancy-status-indicator-devices and to other-intended-occupancy-locations. In some embodiments, with respect to method 800/900 see e.g., FIG. 8 and/or FIG. 9 and see figures that may be at least partially applicable to system 200/300, such as, FIG. 1A, FIG. 1D to FIG. 1E, FIG. 2, FIG. 3, FIG. 4A to FIG. 4C, FIG. 6A to FIG. 6B.

In some embodiments, electronic-device(s) 107 shown in the accompanying drawings (figures) may be replaced with reader/scanner 107a, status-indicator 107b, and/or presence-detector-device(s) 107c.

In some embodiments, light of the visible spectrum as used herein may refer to the visible spectrum for humans (as is most commonly agreed to by the scientific and/or medical community).

No human nor any portion of a human is claimed.

Note, system 100, 200, and/or 300 (hereinafter, system 100/200/300) may never comprise a mobile-computing-device 129 that is owned and/or that is regularly operated by a customer 117 of a given accommodation premises; however, specific software (specific mobile-app) that may be non-transitorily stored on that mobile-computing-device 129 (of customer 117) and that may execute from that mobile-computing-device 129 (of customer 117) may be part of a given system 100/200/300. Note, in embodiments where a customer 117 mobile-computing-device 129 may be acting (operating) as a given POP-device 101 (because of software [mobile app] running on that customer 117 mobile-computing-device 129), then system 100/200/300 may not comprise that customer 117 mobile-computing-device 129, but system 100/200/300 may comprise that software [mobile app] running on that customer 117 mobile-computing-device 129.

However, when a given mobile-computing-device 129 may be owned and/or routinely (regularly) operated by staff (employees) of the given accommodation premises, then system 100/200/300 may comprise such a mobile-computing-device 129.

Electronic devices, computing devices, systems, and methods for indicating person occupancy statuses of intended occupancy locations within accommodation premises have been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A system for indicating occupancy status of locations within an accommodation premises, wherein the system comprises:
at least one point-of-purchase-device that is configured to provide at least one code;
at least one code-reader that is configured to read the at least one code;
at least one presence-detector-device that is configured to detect a presence of at least one person at at least one intended-occupancy-location; and
at least one occupancy-status-indicator-device that is configured to indicate the occupancy status of the at least one intended-occupancy-location based on reading of the at least one code and/or based on data from the at least one at least one presence-detector-device.

2. The system according to claim 1, wherein the accommodation premises is selected from at least one of: a restaurant, a cafe, a coffee shop, a tea house, a tea shop, a cafeteria, a bistro, an eatery, a bar, a pub, a tavern, a grill, a diner, a mess hall, a dining hall, a brewery, a concession stand, a full service restaurant, a fine dining restaurant, a self-seating restaurant, a self-serve restaurant, a library, or a bookstore.

3. The system according to claim 1, wherein the at least one intended-occupancy-location is from the locations.

4. The system according to claim 1, wherein the at least one intended-occupancy-location is selected from at least one of: a table, a tabletop, a countertop, a bar-top, a seat, a chair, a stool, or a booth.

5. The system according to claim 1, wherein the at least one point-of-purchase-device is at least one of: an electronic-device, a computing-device, a kiosk, a device that is configured for facilitating proximity-based purchase transactions, a device that is configured for facilitating credit card transactions, a handheld device, a register, a cash register, or a mobile-computing-device.

6. The system according to claim 1, wherein the at least one point-of-purchase-device is configured for facilitating purchase transactions, wherein the at least one point-of-purchase-device is further configured to provide the at least one code upon completing a purchase transaction.

7. The system according to claim 6, wherein the purchase transactions are for at least one of: purchase of food, purchase of beverage, renting of occupancy usage of the at least one intended-occupancy-location.

8. The system according to claim 1, wherein the at least one code is printed on paper and/or is configured to be displayed upon a screen of a mobile-computing-device.

9. The system according to claim 8, wherein the mobile-computing-device is selected from at least one of: a smartphone, a smartwatch, a laptop computer, or a tablet computer.

10. The system according to claim 1, wherein the at least one code comprises content that is selected from at least one of: a QR code, a 2D code, a bar code, an optical readable code, a machine-readable code, a numeric code, an alphanumeric code, and/or a one-time use code.

11. The system according to claim 1, wherein upon the at least one code-reader reading the at least one code, then the at least one code-reader communicates with a device to verify that the at least one code is valid.

12. The system according to claim 11, wherein the device non-transitorily stores a copy of the at least one code that was provided by the at least one point-of-purchase-device.

13. The system according to claim 11, wherein the device is selected from at least one of: the at least one point-of-purchase-device, at least one hub, or at least one computer-server.

14. The system according to claim 13, wherein the at least one hub and/or the at least one computer-server are in communication with the at least one point-of-purchase-device.

15. The system according to claim 1, wherein the at least one presence-detector-device comprises at least one sensor that is configured to detect the presence of the at least one person at the at least one intended-occupancy-location.

16. The system according to claim 1, wherein the at least one presence-detector-device is linked to the at least one intended-occupancy-location by the at least one presence-detector-device being in direct physical communication with the at least one intended-occupancy-location and/or by the at least one presence-detector-device being oriented so that a field-of-view of at least one sensor of the at least one presence-detector-device is directed to monitor the at least one intended-occupancy-location.

17. The system according to claim 1, wherein the system further comprises at least one electronic-device, wherein the at least one electronic-device comprises both the at least one code-reader and the at least one presence-detector-device, such that the at least one code-reader and the at least one presence-detector-device are both part of a single device, namely, the at least one electronic-device.

18. The system according to claim 1, wherein the at least one occupancy-status-indicator-device comprises at least one status indicator that is configured to indicate the occupancy status of the at least one intended-occupancy-location.

19. The system according to claim 18, wherein the at least one status indicator is a different colored light for each different occupancy status.

20. The system according to claim 1, wherein the occupancy status comprises at least three different statuses of a first-status, a second-status, and a third-status;
wherein the first-status indicates that the at least one intended-occupancy-location is currently vacant and ready for occupancy;
wherein the second-status indicates that the at least one intended-occupancy-location is currently properly occupied; and
wherein the third-status indicates that the at least one intended-occupancy-location is currently improperly occupied.

21. The system according to claim 20, wherein the occupancy status further comprises a fourth-status; wherein the fourth-status indicates that the second-status is expiring soon.

22. The system according to claim 20, wherein the occupancy status further comprises a fifth-status; wherein the fifth-status indicates that the at least one intended-occupancy-location is in need of cleaning or maintenance.

23. The system according to claim 1, wherein the at least one occupancy-status-indicator-device is located in a public area of the accommodation premises.

24. The system according to claim 1, wherein the at least one occupancy-status-indicator-device is viewable from a public area of the accommodation premises.

25. The system according to claim 1, wherein the at least one occupancy-status-indicator-device is linked to the at least one intended-occupancy-location by the at least one occupancy-status-indicator-device being in direct physical communication with the at least one intended-occupancy-location or by the at least one occupancy-status-indicator-device being located in proximity to the at least one intended-occupancy-location such that the at least one occupancy-status-indicator-device and the at least one intended-occupancy-location are closer together than other-occupancy-status-indicator-devices and other-intended-occupancy-locations.

26. The system according to claim 1, wherein the system further comprises at least one electronic-device, wherein the at least one electronic-device comprises at least two of the following in a single device: the at least one code-reader, the at least one presence-detector-device, and/or the at least one occupancy-status-indicator-device.
